(19) United States
(12) Patent Application Publication
(10) Pub. No.: US 2026/0200963 A1
(43) Pub. Date: Jul. 16, 2026

(54) NOVEL IRON-BASED COMPOUNDS, PROCESSES FOR THE PREPARATION THEREOF, AND USE THEREOF AS CATALYSTS

(71) Applicants: UNIVERSITE PARIS-SACLAY, GIF-SUR-YVETTE (FR); CENTRE NATIONAL DE LA RECHERCHE SCIENTIFIQUE, PARIS (FR)

(72) Inventors: Jérôme HANNEDOUCHE, GIF-SUR-YVETTE (FR); Sophie BEZZENINE, GIF-SUR-YVETTE (FR); Richard GIL, GIF-SUR-YVETTE (FR); Donghuang CHEN, GIF-SUR-YVETTE (FR)

(73) Assignees: UNIVERSITE PARIS-SACLAY, GIF-SUR-YVETTE (FR); CENTRE NATIONAL DE LA RECHERCHE SCIENTIFIQUE, PARIS (FR)

(21) Appl. No.: 18/874,226

(22) PCT Filed: Jun. 22, 2023
(86) PCT No.: PCT/EP2023/066952

§ 371 Date: Dec. 12, 2024

(30) Foreign Application Priority Data
Jun. 24, 2022 (FR) FR2206286

(51) Int. Cl. C07F 19/00; B01J 31/18; B01J 31/28

(52) U.S. Cl. CPC C07F 19/00; B01J 31/1805; B01J 31/28; B01J 2231/4211; B01J 2231/4266; B01J 2531/842

(57) ABSTRACT

Iron anilido-imine complexes, methods for their preparation, their use as catalysts to catalyze the formation of carbon-carbon bonds, in particular, in the Suzuki-Miyaura reaction, and compounds prepared by with the iron anilido-imine complexes. The iron anilido-imine complexes provide stable catalysts with respect to the ambient air, thereby allowing the creation of the carbon-carbon bonds.

### FIELD

The present invention relates to the synthesis of new iron-based compounds, their preparation methods and their use as catalysts.

### BACKGROUND

Iron is a cheap, abundant, readily available, and low toxicity metal (Angew. Chem. Int. Ed. 2016, 55, 12150) and tends to substitute palladium in the chemical industries. Indeed, iron offers many advantages from a sustainable development point of view. In addition, iron is one of the few base metals that has been successfully tested as a catalyst in industrial cross-coupling methods at the kilogram scale. Iron β-dicetiminate complexes have already been used to catalyze hydroamination reactions (Chem. Eur. J. 2019, 25, 835-844). The use of such iron complexes requires working in a controlled atmosphere, in the absence of humidity and ambient air, in “glove box” type equipment. (Chem. Eur. J. 2019, 25, 835-844), which represents a constraint that makes these catalysts difficult to use on an industrial scale.

Indeed, metal catalysis is a means of accelerating, or even making possible, certain reactions and of accessing a large number of compounds at production costs much lower than the conventional organic synthesis routes, which sometimes require a large number of steps. In addition, the requirements for residual metals in products intended for human use, in particular in products for pharmaceutical use, currently represent a barrier to the use of metal catalysis in the manufacture of such products.

The development of carbon-carbon bond-forming reactions by cross-coupling is one of the greatest revolutions in the field of synthetic organic chemistry. From the different types of cross-coupling, the Suzuki-Miyaura coupling (Angew. Chem., Int. Ed. 2011, 50, 6722), which is a coupling between a halogenated or pseudo-halogenated organic derivative and an organoboron, palladium-catalyzed derivative, is one of the most commonly applied strategies for the formation of carbon-carbon bonds in the pharmaceutical, agrochemical and fine chemical industries. (Adv. Synth. Catal. 2009, 351, 3027). For example, in the pharmaceutical industry, the Suzuki-Miyaura coupling is used in nearly 25% of small molecule drug syntheses and accounts for 40% of carbon-carbon bond formation reactions while other cross-coupling reactions represent less than 5%. Indeed, this coupling is mainly limited to couplings between 2 partners carrying a sp² (or even sp) hybridized carbon leading to the formation of molecules with plane geometry. Indeed, the ease of elimination of the Pd(II)-alkyl intermediates formed during the coupling reaction prevents its generalized extension to coupling partners carrying sp³ hybridized carbons. Very few molecules with more complex three-dimensional geometry are accessible by palladium catalysis and even fewer when they contain a heteroaromatic unit, which is problematic since nearly 70% of pharmaceutical molecules contain at least one heterocycle (Bioactive Heterocyclic Compound Classes: Pharmaceuticals, Wiley, Weinheim, 2012). In addition, the coupling between 2 partners carrying an sp3 hybridized carbon represents only 1% of the Suzuki-Miyaura reactions described to date despite the significant presence of C(sp³)-C(sp³) bonds in natural or biologically active molecules.

### SUMMARY

Moreover, the ligands used to stabilize these catalysts commonly used in industry are phosphorus-based ligands. Since nitrogen is more abundant than phosphorus, chemists are turning to the design of nitrogen-based ligands because it is an advantage from a sustainable development point of view. Although a few examples of iron-based catalysts for Suzuki-Miyaura coupling have been described in the state of the art, few have been reported to be effective for coupling partners carrying sp3 hybridized carbons. In addition, they often rely on the use of activated boronic derivatives (using an organolithium or organomagnesium), which represents significant limitations in terms of functional compatibility, and they use catalysts carrying phosphorus-based ligands. In addition, there are few examples of coupling with tertiary halides. The latter are generally halides that are difficult to couple because of their steric hindrance.

The purpose of the invention is to remedy the problem mentioned above and to allow the creation of C(sp³)-C(sp²) and C(sp³)-C(sp³) bonds.

An object of the present invention relates to new compounds of iron imino-anilide.

Another object of the invention is the use of iron imino-anilide complexes to catalyze the formation of carbon-carbon bonds, in particular, the Suzuki-Miyaura reaction.

The invention is also intended to provide a stable catalyst to the ambient air allowing the creation of carbon-carbon bonds.

Another object of the invention is to provide methods for preparing iron imino-anilide complexes which may be advantageous in the Suzuki-Miyaura reaction.

Another object of the invention is to provide new compounds prepared with iron imino-anilide complexes.

### DETAILED DESCRIPTION

The present invention relates to the use of at least one of the compounds of the following general formula (I):

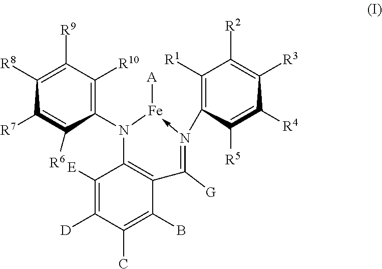

in which:
   A is chosen from:
   a —X group in which X is chosen from
      a chlorine atom
      a bromine atom
   a group

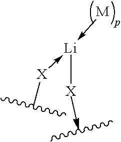

in which:
   M is a coordinating solvent
   p is chosen from 1, 2, 3, 4 or a decimal number that can vary from a value greater than 0 but less than 4
   a group

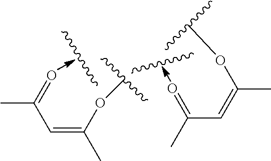

B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
G is chosen from
   a hydrogen atom
   a linear or branched alkyl group of 1 to 5 carbon atom(s)
as catalysts for coupling reactions.

It was unexpectedly found that iron imino-anilide complexes could catalyze the formation of carbon-carbon bonds.

A can represent X, this group X being chosen from a chlorine or bromine atom, X(Li—X)-(M)ₚ and (Acac)₂. In the case of steric hindrance due to the groups B, C, D, E, R₁, R₂, R₃, R₄, R₅, R₆, R₇, R₈, R₉ and R₁₀, A represents X advantageously.

When there is little or no steric hindrance due to the B, C, D, E, R₁, R₂, R₃, R₄, R₅, R₆, R₇, R₈, R₉ and R₁₀ groups, A advantageously represents X·X(Li—X)-(M)ₚ.

By “coordinating solvent” it is meant any solvent that can stabilize the electron gap of a metal cation by giving up part of its negative charge using a lone pair. The coordinating solvent is chosen from the group consisting of diethyl ether, dimethoxymethane, dimethoxyethane, dietoxymethane, tetrahydrofuran, tertbutyl methylether, tertbutyl ethyl ether, methyl tetrahydrofuran, 1,4-dioxane, tert-amyl methyl ether or anisole, preferably tetrahydrofuran. p may take values of 1, 2, 3, 4 or a decimal number that may vary from a value greater than 0 but less than 4, preferred 1.

When A represents two acetyloacetonate groups, the compounds do not degrade or lose their properties under the action of ambient air.

The term “ambient air” refers to the surrounding air that is naturally present in the atmosphere, and whose composition can vary depending on location or altitude.

By “linear” it is meant the carbon atoms in the alkyl chain, except those at the ends of the chain, are all bonded one by one through a carbon-carbon bond, such that each carbon atom has only two carbon-carbon bonds, the carbon atom at the beginning of the chain has a single carbon-carbon bond with the rest of the chain, and the carbon atom at the end of the chain includes only one carbon-carbon bond.

The term “branched” means that each carbon atom in the alkyl chain can contain 3 to 4 carbon-carbon bonds.

By “catalyst” it is meant a chemical substance that allows, directly or after transformation by another chemical substance, to activate or enable a chemical reaction.

The term “coupling reaction” refers to a carbon-carbon bonding reaction that achieves the association of two carbon units and includes at least one transmetallation step and at least one reductive elimination step. In particular, the coupling reaction also refers to a carbon-carbon bonding reaction that achieves the association of two carbon units and includes at least one monoelectronic oxidative addition step or one bioelectronic oxidative addition step, at least one transmetallation step and at least one reductive elimination step.

In a particular embodiment, the invention relates to the use, as defined above, as a catalyst for the implementation of a reaction chosen from the carbon-carbon bond-forming reactions, using an organoboron or an organomagnesium or an organozinc or an organotin, in particular for the implementation of the Suzuki-Miyaura reaction.

By “Organoboron” it is meant an organic compound comprising at least one bond between a carbon atom and a boron atom. For example, but not limited to, an organic compound with a boronic acid function or a boronic ester function can be mentioned.

By “Organomagnesium” it is meant an organic compound comprising at least one bond between a carbon atom and a magnesium atom. For example, by way of limitation, we can mention the Grignard reagent.

The term “organozinc” refers to an organic compound comprising at least one bond between a carbon atom and a zinc atom.

The term “organotin” refers to an organic compound comprising at least one bond between a carbon atom and a tin atom.

In a particular embodiment, the invention relates to the use, as defined above, for the implementation of the Suzuki-Miyaura, Kumada and Sonogashira reactions, in particular for the implementation of the Suzuki-Miyaura reaction.

In a particular embodiment, the invention relates to the use, as defined above, at least one of the compounds of the following general formula (I):

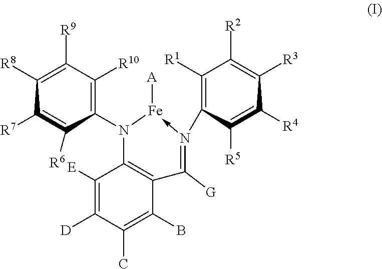

in which:
A is chosen from:
   a —X group in which X is chosen from
      a chlorine atom
      a bromine atom
   a group x

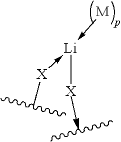

in which:
   M is a coordinating solvent
   p is chosen from 1, 2, 3, 4 or a decimal number that can vary from a value greater than 0 but less than 4

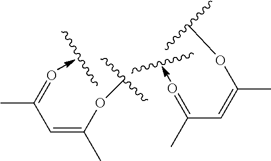

a group
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms
when A corresponds to the group

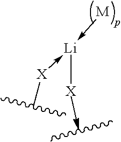

then R₁, R₅, R₆, and R₁₀, identical or different, are chosen from: a hydrogen atom, a halogen, in particular F or Cl, a trifluoromethyl group CF₃, a linear or branched alkyl group of 1 or 2 or 4 to 10 carbon atoms, a linear or branched Alcoxy group of 1 to 10 carbon atom(s) or a linear or branched dialkylamino group of 2 to 20 carbon atoms, and R₂, R₃, R₄, R₇, R₈ and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
   when A corresponds to the —X group or the group

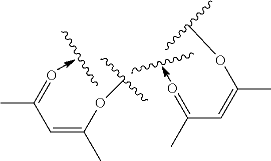

then R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
   G is chosen from
   a hydrogen atom
   a linear or branched alkyl group of 1 to 5 carbon atoms
excluding the compound of the following formula:

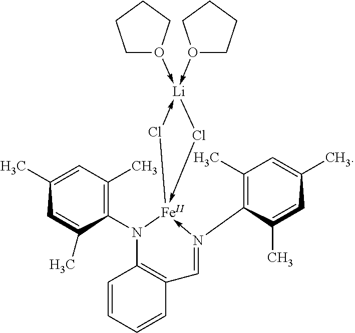

In a particular embodiment, the invention relates to the use, as defined above, at least one of the compounds of the following general formula (Ia):

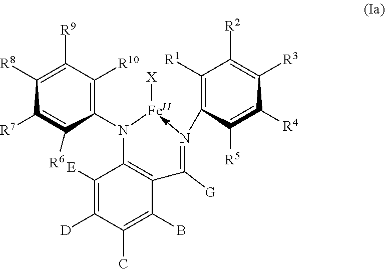

in which:
   X is chosen from
   a chlorine atom
   a bromine atom
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 10 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
   G is chosen from
   a hydrogen atom
   a linear or branched alkyl group of 1 to 5 carbon atom(s)
as catalysts for coupling reactions.

This structure corresponds to the presence of steric hindrance around the iron atom due to the B, C, D, E, R₁, R₂, R₃, R₄, R₅, R₆, R₇, R₈, R₉ and R₁₀ groups

To facilitate the understanding of the following, we arbitrarily consider 3 axes of symmetry (I), (II) and (III) as shown in the diagram below

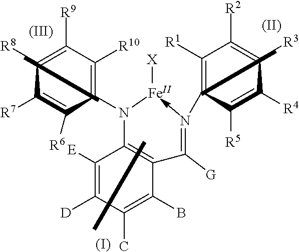

The axis (I) creates symmetry between C and D, and between B and E. Axis (II) comprises the R₃-bearing carbon and the nitrogen-carrying carbon of the same phenyl group, and creates symmetry between R₁ and R₅, and between R₂ and R₄. Axis (III) comprises the R₈-bearing carbon and the nitrogen-carrying carbon of the same phenyl group, and creates symmetry between R₆ and R₁₀, and between R₇ and R₉.

In a particular embodiment, the invention relates to the use, as defined above, at least one of the compounds of the following general formula (Ib):

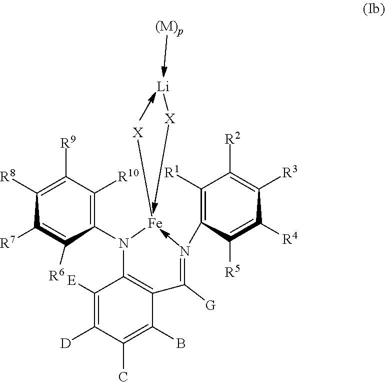

in which:
   X is chosen from
   a chlorine atom
   a bromine atom
   M is a coordinating solvent
   p is chosen from 1, 2, 3, 4 or a decimal number that can vary from a value greater than 0 but less than 4
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
   G is chosen from
   a hydrogen atom
   a linear or branched alkyl group of 1 to 5 carbon atom(s)
as catalysts for coupling reactions.

This structure corresponds to the absence of steric hindrance, or the presence of a small steric hindrance around the iron atom due to the B, C, D, E, R₁, R₂, R₃, R₄, R₅, R₆, R₇, R₈, R₉ and R₁₀ groups

Advantageously, the compound with the formula (Ib) is as follows:

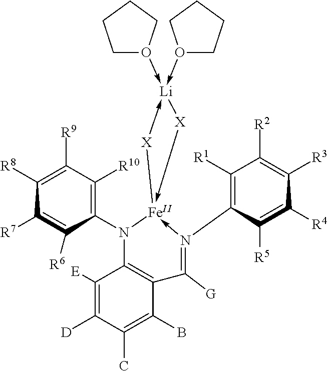

To facilitate the understanding of the following, we arbitrarily consider 3 axes of symmetry (I), (II) and (III) as shown in the diagram below

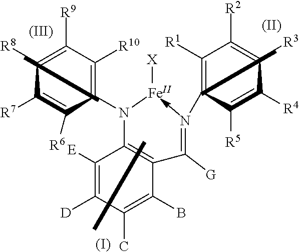

The axis (I) creates symmetry between C and D, and between B and E. Axis (II) comprises the R₃-bearing carbon and the nitrogen-carrying carbon of the same phenyl group, and creates symmetry between R₁ and R₅, and between R₂ and R₄. Axis (III) comprises the R₈-bearing carbon and the nitrogen-carrying carbon of the same phenyl group, and creates symmetry between R₆ and R₁₀, and between R₇ and R₉.

In a particular embodiment, the invention relates to the use, as defined above, of at least one of the compounds of the following general formula (Ic):

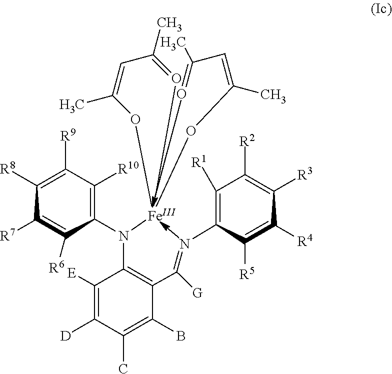

in which:
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s)
as catalysts for coupling reactions.

To facilitate the understanding of the following, we arbitrarily consider 3 axes of symmetry (I), (II) and (III) as shown in the diagram below

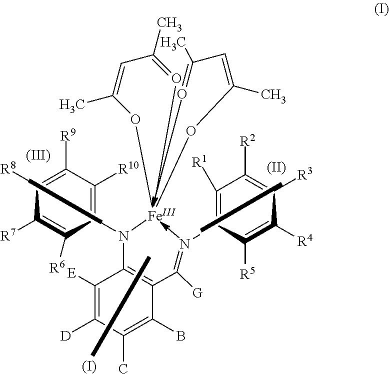

The axis (I) creates symmetry between C and D, and between B and E. Axis (II) comprises the R₃-bearing carbon and the nitrogen-carrying carbon of the same phenyl group, and creates symmetry between R₁ and R₅, and between R₂ and R₄. Axis (III) comprises the R₈-bearing carbon and the nitrogen-carrying carbon of the same phenyl group, and creates symmetry between R₆ and R₁₀, and between R₇ and R₉.

In a particular embodiment, the invention relates to the use, as defined above, of the use, of at least one of the compounds, of the following general formula (Ia):

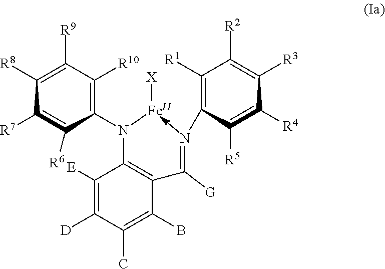

in which:
   X is chosen from
      a chlorine atom
      a bromine atom
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms or a linear or branched dialkylamino group of 2 to 20 carbon atoms, at least one of the groups B, C, D or E being different from the others.
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms, provided that:
   R₁ is different from R₅ and/or R₂ is different from R₄ and
   R₆ is different from R₁₀ and/or R₇ is different from R₉
   G is chosen from
   a hydrogen atom
   a linear or branched alkyl group of 1 to 5 carbon atom(s)
as catalysts for coupling reactions.

This particular embodiment corresponds to a lack of symmetry with respect to axis (I), axis (II) and axis (III).

In a particular embodiment, the invention relates to the use, as defined above, of the use, of at least one of the compounds, of the following general formula (Ia):

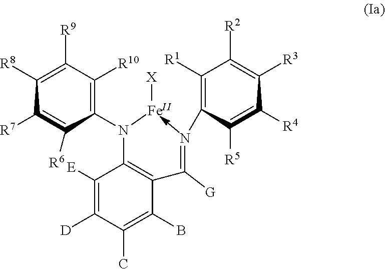

in which:
   X is chosen from
      a chlorine atom
      a bromine atom
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
   a hydrogen atom
   a linear or branched alkyl group of 1 to 5 carbon atom(s)
as catalysts for coupling reactions.

This particular embodiment corresponds to the absence of symmetry with respect to axis (I) and axis (II), and the presence of symmetry with respect to axis (III).

In a particular embodiment, the invention relates the use, as defined above, the use of at least one of the compounds, of the following general formula (Ia):

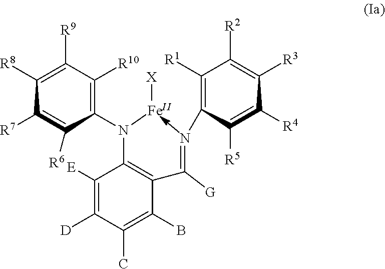

in which:
   X is chosen from
   a chlorine atom
   a bromine atom
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms, provided that:
   R₁ is identical to R₅
   R₂ is identical to R₄
   R₆ is identical to R₁₀
   R₇ is identical to R₉
   G is chosen from
   a hydrogen atom
   a linear or branched alkyl group of 1 to 5 carbon atom(s)
as catalysts for coupling reactions.

This particular embodiment corresponds to the absence of symmetry with respect to the axis (I). It also corresponds to the presence of symmetry with respect to the axis (II) and the axis (III).

In a particular embodiment, the invention relates to the use, as defined above, of the use, of at least one of the compounds, of the following general formula (Ia):

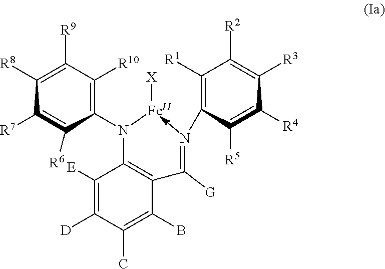

in which:
   X is chosen from
   a chlorine atom
   a bromine atom
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is different from R₁₀ and/or R₇ or different from R₉
   G is chosen from
   a hydrogen atom
   a linear or branched alkyl group of 1 to 5 carbon atom(s)
as catalysts for coupling reactions.

This particular embodiment corresponds to the presence of symmetry with respect to the (I) axis. It also corresponds to the absence of symmetry with respect to axis (II) and axis (III).

In a particular embodiment, the invention relates to the use, as defined above, of at least one of the compounds of the following general formula (Ia):

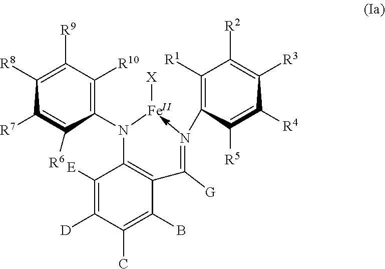

in which:
   X is chosen from
      a chlorine atom
      a bromine atom
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
   a hydrogen atom
   a linear or branched alkyl group of 1 to 5 carbon atom(s)
as catalysts for coupling reactions.

This particular embodiment corresponds to the presence of symmetry with respect to the axis (I) and the axis (III). It also corresponds to the absence of symmetry with respect to the axis (II).

In a particular embodiment, the invention relates to the use, as defined above, of the use, of at least one of the compounds, of the following general formula (Ia):

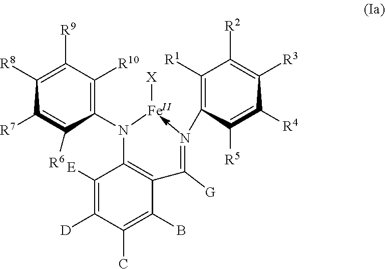

in which:
   X is chosen from
      a chlorine atom
      a bromine atom
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
      R₁ is identical to R₅
      R₂ is identical to R₄
      R₆ is identical to R₁₀
      R₇ is identical to R₉
      G is chosen from
      a hydrogen atom
      a linear or branched alkyl group of 1 to 5 carbon atom(s)
as catalysts for coupling reactions.

This particular embodiment corresponds to the presence of symmetry with respect to the axis (I), the axis (II) and the axis (III).

In a particular embodiment, the invention relates to the use, as defined above, of the use of at least one of the compounds of the following general formula (Ia):

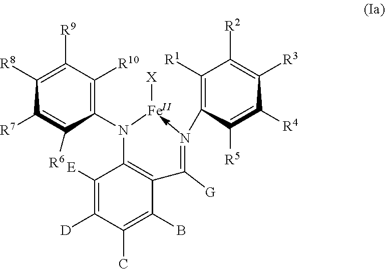

in which:
   X is chosen from
      a chlorine atom
      a bromine atom
   B, C, D, and E are fluorine atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s)
as catalysts for coupling reactions.

This particular embodiment corresponds to the presence of 4 fluorine atoms on the phenyl group carrying the B, C, D and E groups. This has the consequence of modifying the electronic properties of the iron atom of the catalyst.

In a particular embodiment, the invention relates to the use, as defined above, of the use of at least one of the compounds, of the following general formula (Ib):

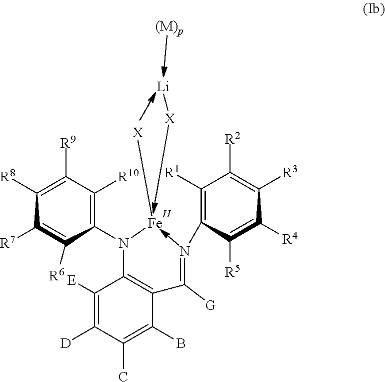

in which:
   X is chosen from
      a chlorine atom
      a bromine atom
   M is a coordinating solvent
   p is chosen from 1, 2, 3, 4 or a decimal number that can vary from a value greater than 0 but less than 4
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, at least one of the groups B, C, D or E being different from the others.
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is different from R₁₀ and/or R₇ is different from R₉
   G is chosen from
      a hydrogen atom
      a linear or branched alkyl group of 1 to 5 carbon atom(s)
as catalysts for coupling reactions.

This particular embodiment corresponds to a lack of symmetry with respect to axis (I), axis (II) and axis (III).

In a particular embodiment, the invention relates to the use, as defined above, of the use of at least one of the compounds, of the following general formula (Ib):

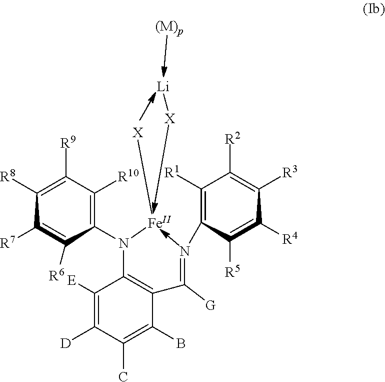

in which:
   X is chosen from
a chlorine atom
   a bromine atom
   M is a coordinating solvent
   p is chosen from 1, 2, 3, 4 or a decimal number that can vary from a value greater than 0 but less than 4
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
      a hydrogen atom
      a linear or branched alkyl group of 1 to 5 carbon atom(s)
as catalysts for coupling reactions.

This particular embodiment corresponds to the absence of symmetry with respect to axis (I) and axis (II), and the presence of symmetry with respect to axis (III).

In a particular embodiment, the invention relates to the use, as defined above, of the use of at least one of the compounds, of the following general formula (Ib):

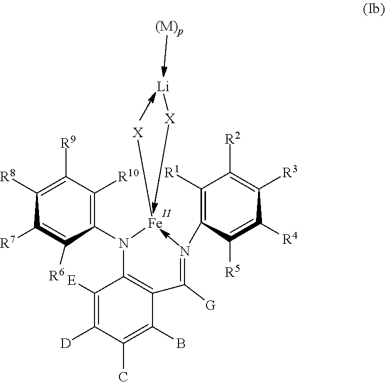

in which:
   X is chosen from
   a chlorine atom
   a bromine atom
   M is a coordinating solvent
   p is chosen from 1, 2, 3, 4 or a decimal number that can vary from a value greater than 0 but less than 4
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is identical to R₅
   R₂ is identical to R₄
   R₆ is identical to R₁₀
   R₇ is identical to R₉
   G is chosen from
   a hydrogen atom
   a linear or branched alkyl group of 1 to 5 carbon atom(s)
as catalysts for coupling reactions.

This particular embodiment corresponds to the absence of symmetry with respect to the axis (I).

It also corresponds to the presence of symmetry with respect to the axis (II) and the axis (III).

In a particular embodiment, the invention relates to the use, as defined above, of the use of at least one of the compounds, of the following general formula (Ib):

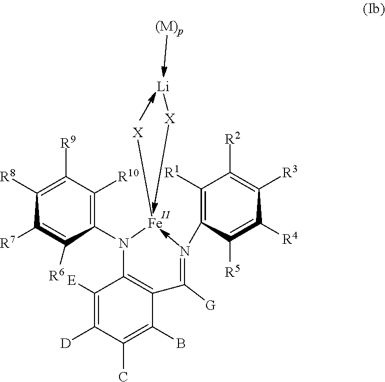

in which:
   X is chosen from
   a chlorine atom
   a bromine atom
   M is a coordinating solvent
   p is chosen from 1, 2, 3, 4 or a decimal number that can vary from a value greater than 0 but less than 4
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF3, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is different from R₁₀ and/or R₇ is different from R₉
   G is chosen from
   a hydrogen atom
   a linear or branched alkyl group of 1 to 5 carbon atom(s)
as catalysts for coupling reactions.

This particular embodiment corresponds to the presence of symmetry with respect to the (I) axis. It also corresponds to the absence of symmetry with respect to axis (II) and axis (III).

In a particular embodiment, the invention relates to the use, as defined above, of the use of at least one of the compounds of the following general formula (Ib):

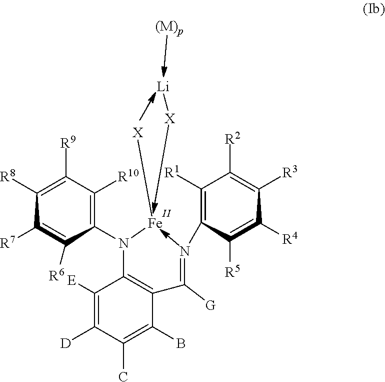

in which:
   X is chosen from
   a chlorine atom
   a bromine atom
   M is a coordinating solvent
   p is chosen from 1, 2, 3, 4 or a decimal number that can vary from a value greater than 0 but less than 4
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
   a hydrogen atom
   a linear or branched alkyl group of 1 to 5 carbon atom(s)
as catalysts for coupling reactions.

This particular embodiment corresponds to the presence of symmetry with respect to the axis (I) and the axis (III). It also corresponds to the absence of symmetry with respect to the axis (II).

In a particular embodiment, the invention relates to the use, as defined above, of the use of at least one of the compounds, of the following general formula (Ib):

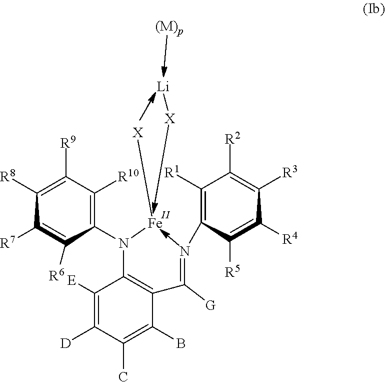

in which:
   X is chosen from
   a chlorine atom
   a bromine atom
   M is a coordinating solvent
   p is chosen from 1, 2, 3, 4 or a decimal number that can vary from a value greater than 0 but less than 4
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is identical to R₅
   R₂ is identical to R₄
   R₆ is identical to R₁₀
   R₇ is identical to R₉
   G is chosen from
   a hydrogen atom
   a linear or branched alkyl group of 1 to 5 carbon atom(s)
as catalysts for coupling reactions.

This particular embodiment corresponds to the presence of symmetry with respect to the axis (I), the axis (II) and the axis (III).

In a particular embodiment, the invention relates to the use, as defined above, of the use of at least one of the compounds of the following general formula (Ib):

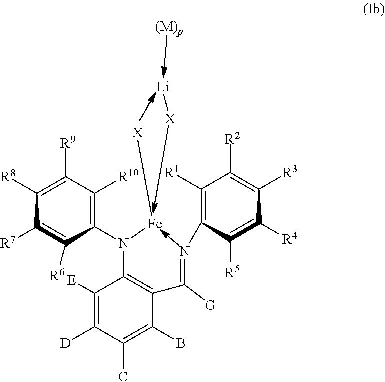

in which:
   X is chosen from
      a chlorine atom
      a bromine atom
   M is a coordinating solvent
   p is chosen from 1, 2, 3, 4 or a decimal number that can vary from a value greater than 0 but less than 4
   B, C, D, and E are fluorine atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
   a hydrogen atom
   a linear or branched alkyl group of 1 to 5 carbon atom(s)
as catalysts for coupling reactions.

This particular embodiment corresponds to the presence of 4 fluorine atoms on the phenyl group carrying the B, C, D and E groups. This has the consequence of modifying the electronic properties of the iron atom of the catalyst.

In a particular embodiment, the invention relates to the use, as defined above, of the use of at least one of the compounds, of the following general formula (Ic):

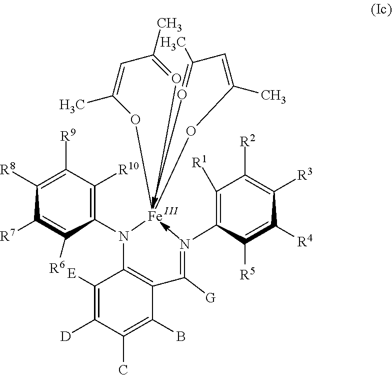

in which:
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is different from R₁₀ and/or R₇ is different from R₉
   G is chosen from
   a hydrogen atom
   a linear or branched alkyl group of 1 to 5 carbon atom(s)
as catalysts for coupling reactions.

This particular embodiment corresponds to a lack of symmetry with respect to axis (I), axis (II) and axis (III).

In a particular embodiment, the invention relates to the use, as defined above, of the use of at least one of the compounds, of the following general formula (Ic):

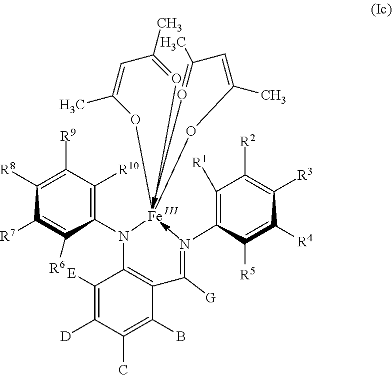

in which:
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
   a hydrogen atom
   a linear or branched alkyl group of 1 to 5 carbon atom(s)
as catalysts for coupling reactions.

This particular embodiment corresponds to the absence of symmetry with respect to axis (I) and axis (II), and the presence of symmetry with respect to axis (III).

In a particular embodiment, the invention relates to the use, as defined above, of at least one of the compounds of the following general formula (Ic):

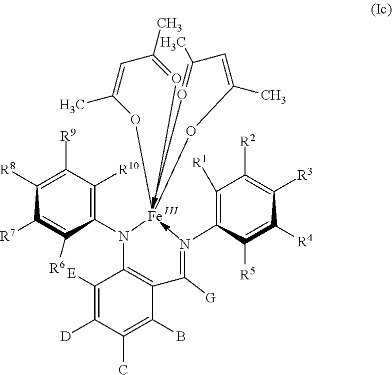

in which:
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, at least one of the groups B, C, D or E being different from the others
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is identical to R₅
   R₂ is identical to R₄
   R₆ is identical to R₁₀
   R₇ is identical to R₉
   G is chosen from
   a hydrogen atom
   a linear or branched alkyl group of 1 to 5 carbon atom(s)
as catalysts for coupling reactions.

This particular embodiment corresponds to the absence of symmetry with respect to the axis (I).

It also corresponds to the presence of symmetry with respect to the axis (II) and the axis (III).

In a particular embodiment, the invention relates to the use, as defined above, of at least one of the compounds of the following general formula (Ic):

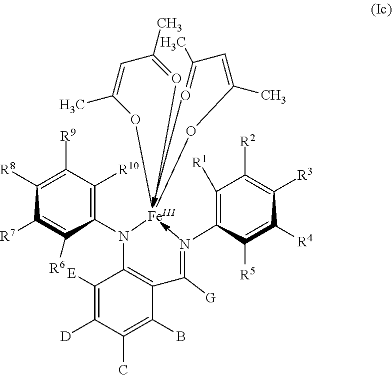

in which:
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉
   G is chosen from
      a hydrogen atom
      a linear or branched alkyl group of 1 to 5 carbon atom(s)
as catalysts for coupling reactions.

This particular embodiment corresponds to the presence of symmetry with respect to the (I) axis. It also corresponds to the absence of symmetry with respect to axis (II) and axis (III).

In a particular embodiment, the invention relates to the use, as defined above, of at least one of the compounds of the following general formula (Ic):

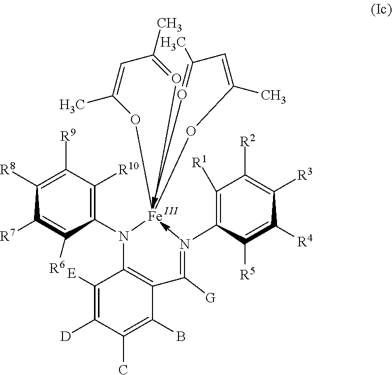

in which:
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
      a hydrogen atom
      a linear or branched alkyl group of 1 to 5 carbon atom(s)
as catalysts for coupling reactions.

This particular embodiment corresponds to the presence of symmetry with respect to the axis (I) and the axis (III). It also corresponds to the absence of symmetry with respect to the axis (II).

In a particular embodiment, the invention relates to the use, as defined above, of at least one of the compounds of the following general formula (Ic):

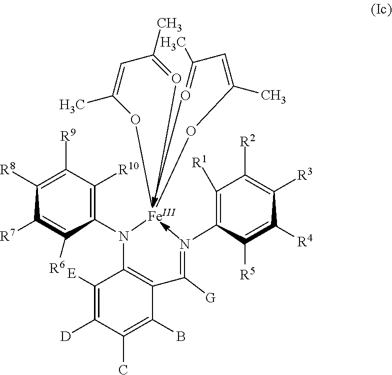

in which:
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is identical to R₅
   R₂ is identical to R₄
   R₆ is identical to R₁₀
   R₇ is identical to R₉
   G is chosen from
   a hydrogen atom
   a linear or branched alkyl group of 1 to 5 carbon atom(s)
as catalysts for coupling reactions.

This particular embodiment corresponds to the presence of symmetry with respect to the axis (I), the axis (II) and the axis (III).

In a particular embodiment, the invention relates to the use, as defined above, of at least one of the compounds of the following general formula (Ic):

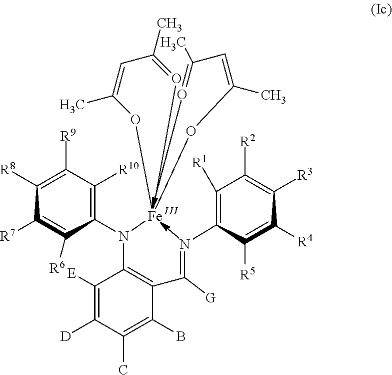

in which:
   B, C, D, and E are fluorine atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s)
as catalysts for coupling reactions.

This particular embodiment corresponds to the presence of 4 fluorine atoms on the phenyl group carrying the B, C, D and E groups. This has the consequence of modifying the electronic properties of the iron atom of the catalyst

In another embodiment, the invention relates to the use of compounds of formula (I), chosen from:

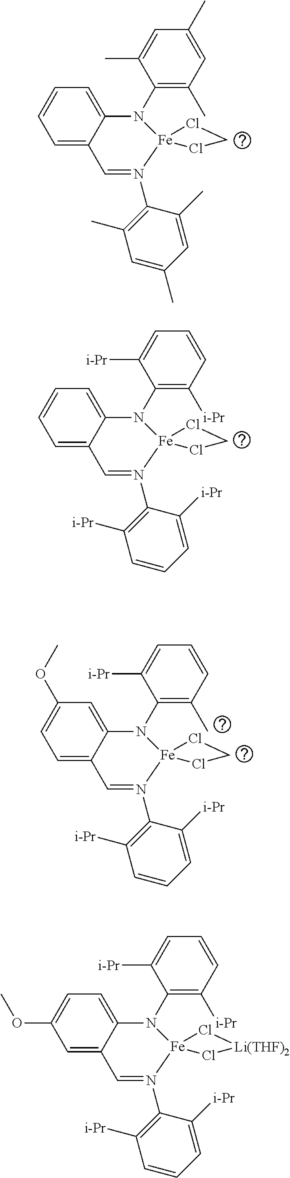

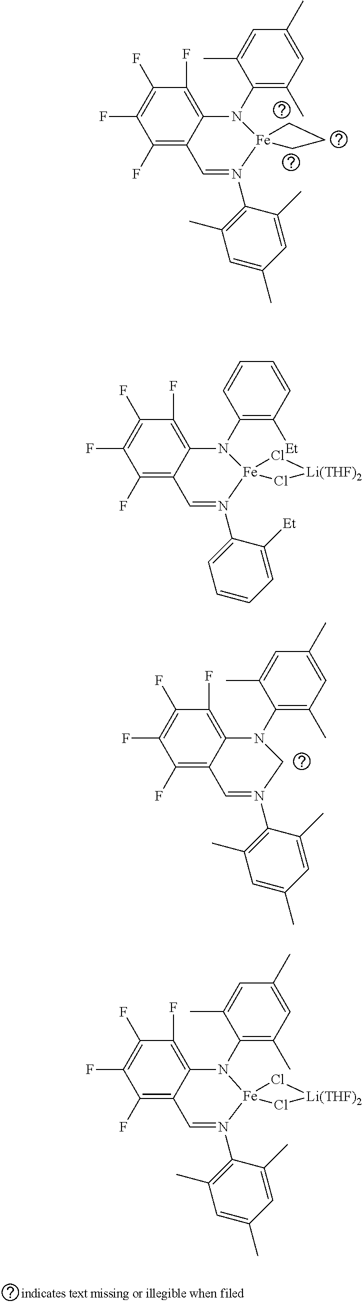

The invention has as its particular object the compound, of the following general formula (I):

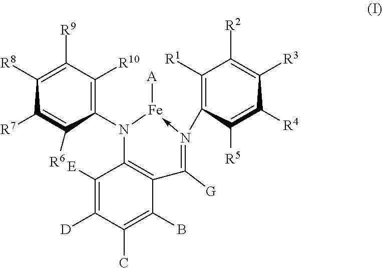

A is chosen from:
   a —X group in which X is chosen from
      a chlorine atom
      a bromine atom
   a group

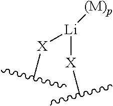

in which:
   M is a coordinating solvent
   p is chosen from 1, 2, 3, 4 or a decimal number that can vary from a value greater than 0 but less than 4
   a group

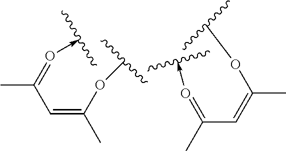

B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 with 20 carbon atoms, at least one of the groups B, C, D or E being different from a hydrogen atom
when A corresponds to the group

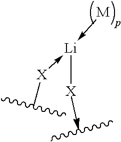

then R₁, R₅, R₆, and R₁₀, identical or different, are chosen from: a hydrogen atom, a halogen, in particular F or Cl, a trifluoromethyl group CF₃, a linear or branched alkyl group of 1 or 2 or 4 to 10 carbon atoms, a linear or branched alcoxy group of 1 to 10 carbon atom(s) or a linear or branched dialkylamino group of 2 to 20 carbon atoms, and R₂, R₃, R₄, R₇, R₈ and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   when A corresponds to the —X group or the group

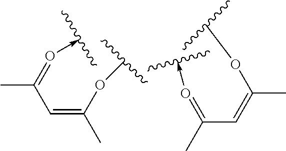

then R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atoms

In this particular embodiment, at least one of the groups B, C, D and E is different from a hydrogen atom, and there may be the presence or absence of symmetry with respect to the axis (I), the axis (II) or the axis (III).

The invention has as its particular object the compound, of the following general formula (I):

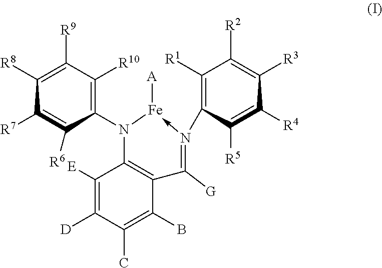

A is chosen from:
   a —X group in which X is chosen from
      a chlorine atom
      a bromine atom
   a group

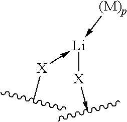

in which:
   M is a coordinating solvent
   p is chosen from 1, 2, 3, 4 or a decimal number that can vary from a value greater than 0 but less than 4
   a group

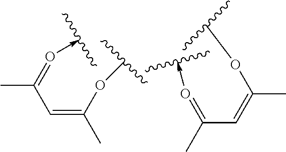

B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
R₁, R₅, R₆, and R₁₀, identical or different, are chosen from: a hydrogen atom, a halogen, in particular F or Cl, a trifluoromethyl group CF₃, a linear or branched alkyl group of 1 to 2 or 4 to 10 carbon atoms, a linear or branched alcoxy group of 1 to 10 carbon atoms, or a linear or branched dialkylamino group of 2 to 20 carbon atoms
R₂, R₃, R₄, R₆, R₇, R₈, and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
G is chosen from
   a hydrogen atom
   a linear or branched alkyl group of 1 to 5 carbon atoms
excluding the compound of the following formula:

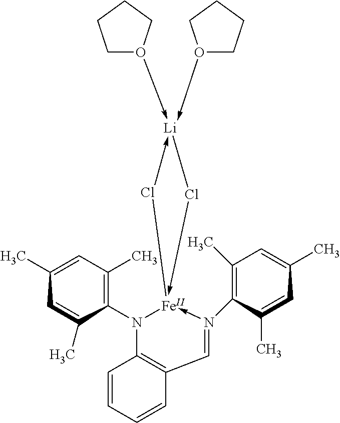

In this particular embodiment, there may be the presence or absence of symmetry with respect to axis (I), axis (II), or axis (III).

The invention has as its particular object, the compound as defined above, of the following general formula (I):

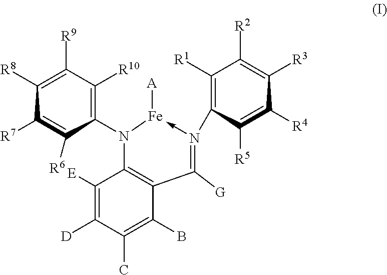

in which:
   A, X, M, p, R₁, R₂, R₃, R₄, R₅, R₆, R₇, R₈, R₉ and R₁₀ and G have the meanings defined above
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 at 20 carbon atoms and at least one of B, C, D or E is different from a hydrogen atom.

In this particular embodiment, at least one of the groups B, C, D and E is different from a hydrogen atom, and there may be the presence or absence of symmetry with respect to the axis (I), the axis (II) or the axis (III).

The invention has as its particular object, the compound as defined above, of the following general formula (I):

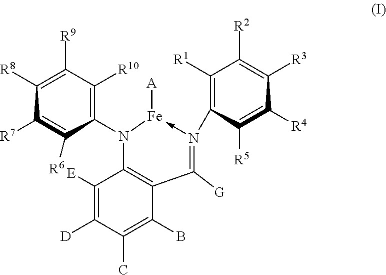

in which:
   A, X, M, p R₁, R₂, R₃, R₄, R₅, R₆, R₇, R₈, R₉ and R₁₀ and G have the meanings defined above
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 at 20 carbon atoms and at least one of B, C, D or E is a halogen, in particular F

In this particular embodiment, at least one of the B, C, D and E groups is a fluorine atom, and there may be the presence or absence of symmetry with respect to the (I) axis, the (II) axis or the (III) axis.

The invention has as its particular object, the compound as defined above, of the following general formula (I):

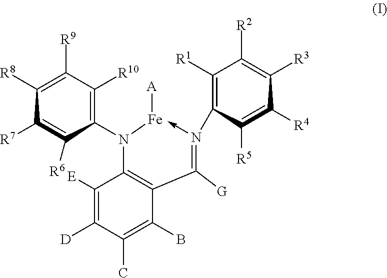

in which
   A, X, M, p, R₁, R₂, R₃, R₄, R₅, R₆, R₇, R₈, R₉ and R₁₀ and G have the meanings defined above
   B, C, D, and E are fluorine atoms

In this particular embodiment, the groups B, C, D and E are fluorine atoms. This has the consequence of modifying the electronic properties of the iron atom of the catalyst, and there is symmetry with respect to the (I) axis. There may be the presence or absence of symmetry with respect to the axis (II) or the axis (III).

The invention has as its particular object, the compound as defined above, of the following general formula (Ia):

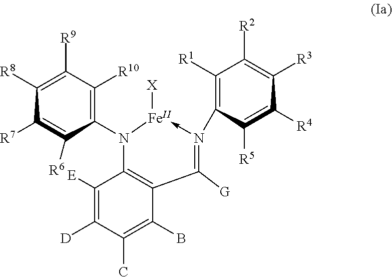

in which:
   X is chosen from
      a chlorine atom
      a bromine atom
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
   a hydrogen atom
   a linear or branched alkyl group of 1 to 5 carbon atoms

The invention has as its particular object, the compound as defined above, of the following general formula (Ta):

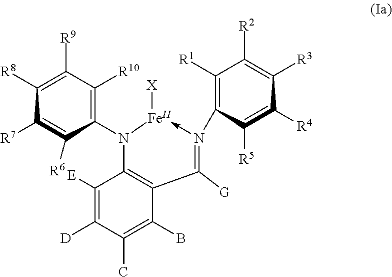

in which X and G have the meanings defined above, and
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
      R₁ is different from R₅ and/or R₂ is different from R₄
   and
      R₆ is different from R₁₀ and/or R₇ is different from R₉

In this particular embodiment, there is symmetry with respect to axis (I) and absence of symmetry with respect to axis (II) and axis (III).

The invention has as its particular object, the compound as defined above, of the following general formula (Ia):

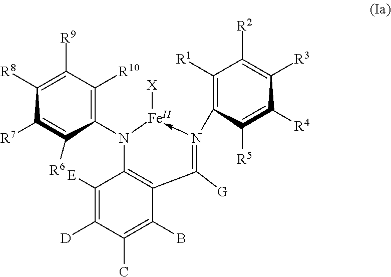

in which X and G have the meanings defined above, and
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
      R₁ is identical to R₅
      R₂ is identical to R₄
      R₆ is identical to R₁₀
      R₇ is identical to R₉

In this particular embodiment, there is symmetry with respect to axis (I), axis (II) and axis (III)

The particular object of the invention is the compound as defined above, of the following general formula (Ib):

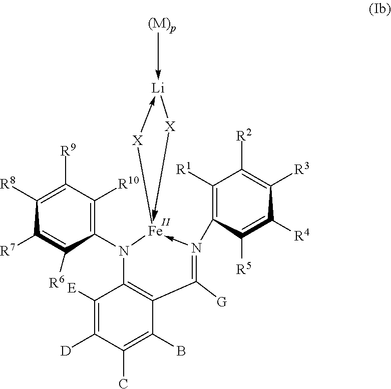

in which:
   X is chosen from
      a chlorine atom
      a bromine atom
   M is a coordinating solvent
   p is chosen from 1, 2, 3, 4 or a decimal number that can vary from a value greater than 0 but less than 4
   B, C, D and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkyl group of 1 to 10 carbon atoms, or a linear or branched dialkylamino group of 2 to 20 carbon atoms
   R₁, R₅, R₆, and R₁₀, identical or different, are chosen from: a hydrogen atom, a halogen, in particular F or Cl, a trifluoromethyl group CF₃, a linear or branched alkyl group of 1 to 2 or 4 to 10 carbon atoms, a linear or branched alcoxy group of 1 to 10 carbon atoms or a linear or branched dialkylamino group of 1 to 20 carbon atoms, and R₂, R₃, R₄, R₆, R₇, R₈, and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atoms
excluding the compound of the following formula:

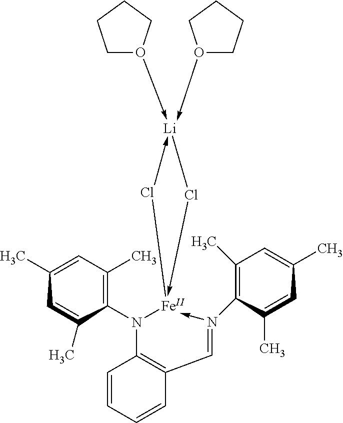

The particular object of the invention is the compound as defined above, of the following general formula (Ib):

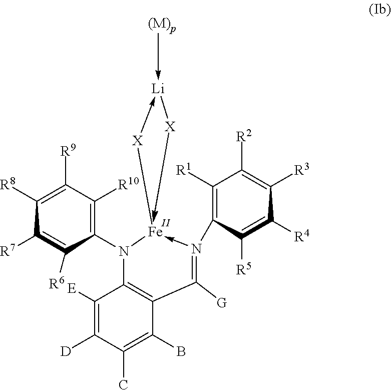

in which X, M, p, and G have the meanings defined above, and
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₅, R₆, and R₁₀ are chosen from: a hydrogen atom, a halogen, in particular F or Cl, a trifluoromethyl group CF₃, a linear or branched alkyl group of 1 to 2 or 4 to 10 carbon atoms, a linear or branched alcoxy group of 1 to 10 carbon atoms or a linear or branched dialkylamino group of 2 to 20 carbon atoms, and R₂, R₃, R₄, R₆, R₇, R₈, and R₉, are chosen from: a hydrogen atom, a halogen, in particular F or Cl, a trifluoromethyl group CF3, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms, provided that:
      R₁ is different from R₅ and/or R₂ is different from R₄
   and
      R₆ is different from R₁₀ and/or R₇ is different from R₉

In this particular embodiment, there is symmetry with respect to axis (I) and absence of symmetry with respect to axis (II) and axis (III).

The particular object of the invention is the compound as defined above, of the following general formula (Ib):

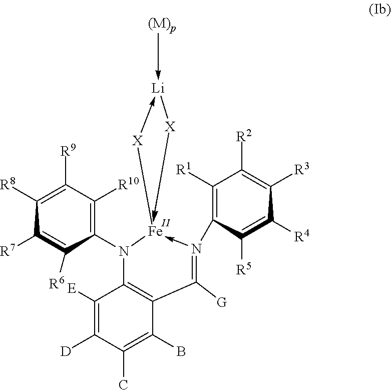

in which X, M, p, and G have the meanings defined above, and
   B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms or a linear or branched dialkylamino group of 2 to 20 carbon atoms, provided that B is identical to E and D is identical to C
   R₁, R₅, R₆, and R₁₀ are chosen from: a hydrogen atom, a halogen, in particular F or Cl, a trifluoromethyl group CF₃, a linear or branched alkyl group of 1 to 2 or 4 to 10 carbon atoms, a linear or branched alcoxy group of 1 to 10 carbon atoms or a linear or branched dialkylamino group of 2 to 20 carbon atoms, and R₂, R₃, R₄, R₆, R₇, R₈, and R₉, which are identical, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms, provided that:
   R₁ is identical to R₅
   R₂ is identical to R₄
   R₆ is identical to R₁₀
   R₇ is identical to R₉
excluding the compound of the following formula:

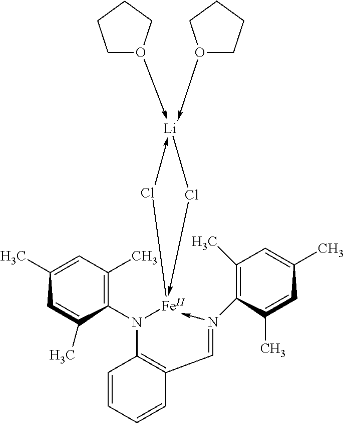

In this particular embodiment, there is symmetry with respect to axis (I), axis (II) and axis (III).
The particular object of the invention is the compound, of the following general formula (Ic):

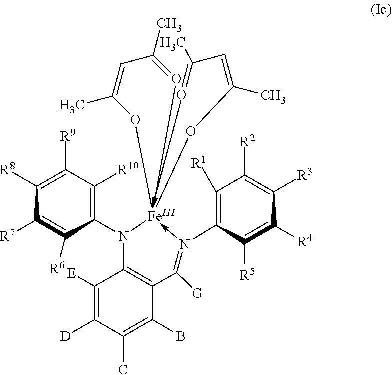

in which:
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atoms

The particular object of the invention is the compound as defined above, of the following general formula (Ic):

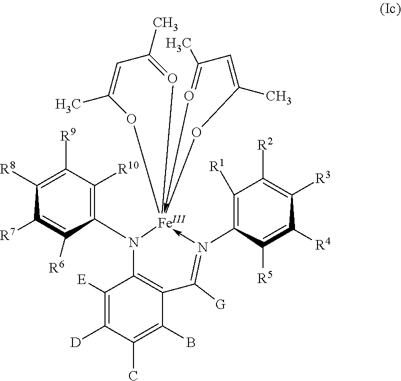

in which:
   B, C, D and E are chosen from: a hydrogen atom, a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkyl group of 1 to 10 carbon atoms, or a linear or branched dialkylamino group of 2 to 20 carbon atoms, provided that B is identical to E and D is identical to C
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is identical to R₅
   R₂ is identical to R₄
   R₆ is identical to R₁₀
   R₇ is identical to R₉
   G is chosen from
      a hydrogen atom
      a linear or branched alkyl group of 1 to 5 carbon atoms

In this particular embodiment, there is symmetry with respect to axis (I), axis (II) and axis (III).

The particular object of the invention is the compound as defined above, of the following general formula (Ic):

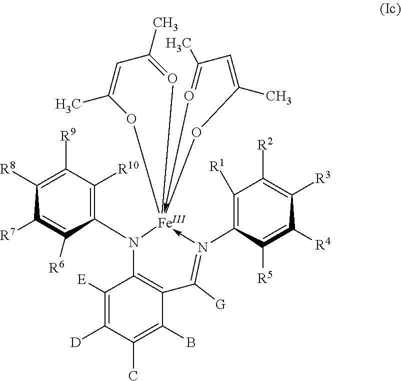

in which:
   B, C, D and E are chosen from: a hydrogen atom, a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkyl group of 1 to 10 carbon atoms, or a linear or branched dialkylamino group of 2 to 20 carbon atoms, provided that B is identical to E and D is identical to C
   R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms, provided that:
   R₁ is different from R₅ and/or R₂ is different from R₄
and
   R₆ is identical to R₁₀ and R₇ is identical to R₉
or
   R₆ is different from R₁₀ and/or R₇ is different from R₉
and
   R₁ is identical to R₅ and R₂ is identical to R₄
   G is chosen from
      a hydrogen atom
      a linear or branched alkyl group of 1 to 5 carbon atoms

In this particular embodiment, there is symmetry with respect to the (I) axis. There is also the absence of symmetry with respect to axis (II) and axis (III).

The invention has as its particular object, the compound as defined above chosen from:

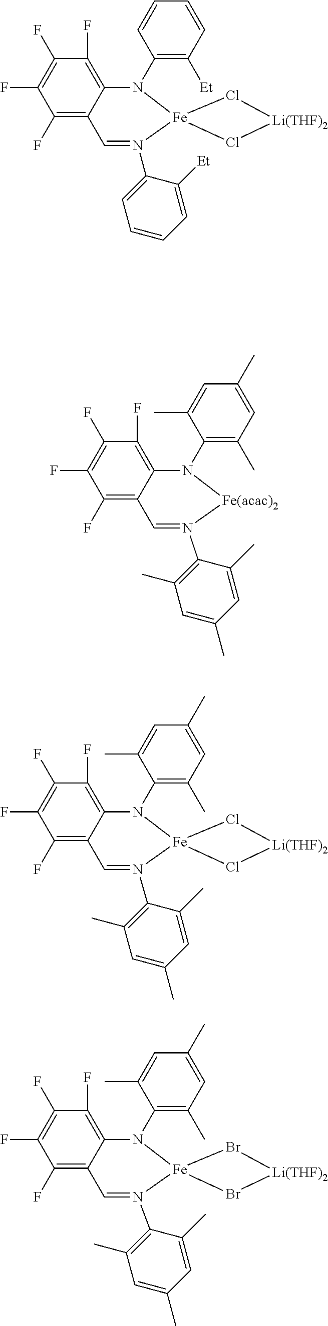

In a particular embodiment, the present invention relates to the use of at least one of the compounds of formulas (Ia), (Ib) or (Ic) as defined above as a catalyst for the implementation of a reaction, chosen from carbon-carbon bond-forming reactions such as the Suzuki-Miyaura, Kumada and Sonogashira reactions,

The term “carbon-carbon bond-forming reaction” means that in the reaction outcome, a carbon-carbon bond will have been created between two distinct molecules or intra-molecularly.

In another embodiment, the compound of formula (Ia), (Ib) or (Ic) is used, as defined above, at catalytic loads of 0.01% molar to 0.1% molar, 0.1% molar to 1% molar, 1% molar to 10% molar, 10% molar to 20% molar, and 20% molar to 30% molar, preferably 1% molar to 10% molar.

The term “catalytic load” refers to the percentage of molar equivalent at which the catalyst is introduced.

In another embodiment, the invention relates to the use of the compounds, as defined above, to implement the Suzuki-Miyaura reaction

By way of non-limiting example, the Suzuki-Miyaura reaction is carried out in the presence of a halogenated derivative, a boronic ester and a base (1/2/1.2 or 2) and the catalyst under stirring at 25° C. for 24 hours.

The use of these compounds in a Suzuki-Miyaura reaction can be in benzene, toluene, 2-methyltetrahydrofuran, methyltert-butyl ether, tert-amyl methyl ether or anisole, preferably in benzene.

These catalysts can be activated during a Suzuki-Miyaura reaction by thermal heating, by microwave, preferably by thermal heating.

The reaction medium can be heated to temperatures of 25° C. to 150° C. preferably to 25° C.

The use of these catalysts in a Suzuki-Miyaura reaction can be done in batch or continuous flow, preferably in batch.

In another embodiment, the invention relates to the use of the compounds, as defined above, in which the implementation of the Suzuki-Miyaura reaction comprises the use of a base chosen from LiNMeEt, LiNMe₂, LiNEt₂, LiNiPr₂, LiNTMS₂, LiNPhMe, in particular LiNMeEt and LiNMe₂.

In another embodiment, the invention relates to the use as defined above, for the synthesis of one of the compounds of the following formula:

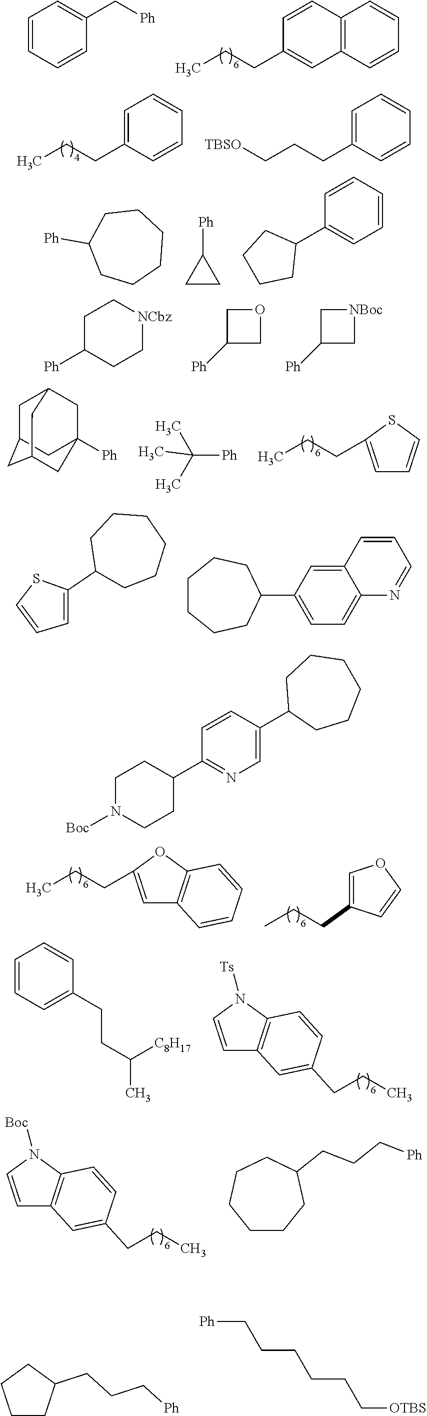

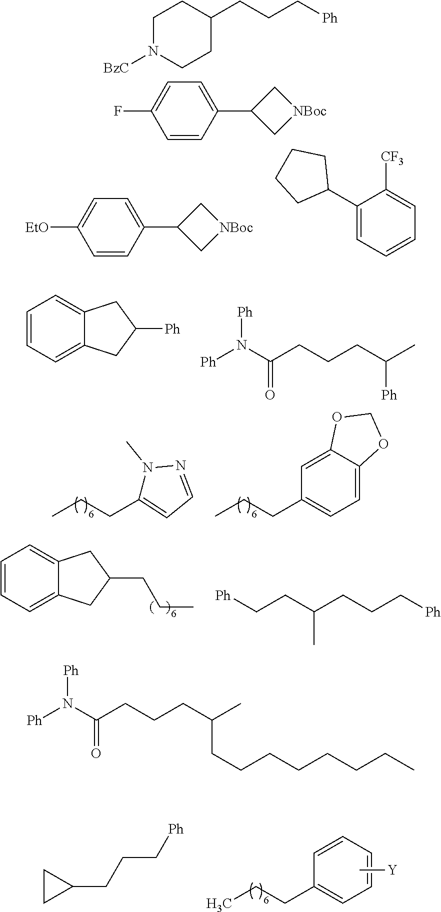

in which Y is chosen from:
   a hydrogen atom
   a linear or branched alkyl group of 1 to 10 carbon atom(s)
   a linear or branched Alcoxy group of 1 to 10 carbon atom(s)
   a —OPh group
   an alkylamino or dialkylamino group, substituted by one or two linear alkyl group(s) from 1 to 10 carbon atoms
   a halogen, in particular a fluorine atom, a chlorine atom or a bromine atom
   a nitro NO₂ group
   a trifluoromethyl group CF₃
   a group

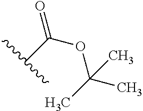 [SMILES: *C(=O)OC(C)(C)C]

The invention has as its particular object the new compound of the following formula

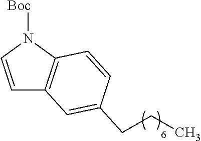

The invention has as its particular object the new compound of the following formula

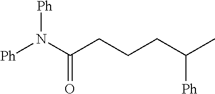 [SMILES: CC(CCCC(=O)N(c1ccccc1)c1ccccc1)c1ccccc1]

The invention has as its particular object the new compound of the following formula

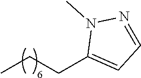

The invention has as its particular object the new compound of the following formula

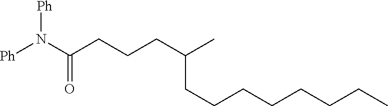 [SMILES: CCCCCCCCC(C)CCCC(=O)N(c1ccccc1)c1ccccc1]

The invention has as its particular object the new compound of the following formula
The invention has as its particular object the new compound of the following formula

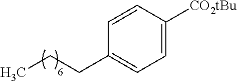

In another embodiment, the invention relates to the use as defined above of a compound of formula (Ia), (Ib) or (Ic) for the implementation of a Suzuki-Miyaura reaction from a compound of formula (S1)

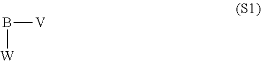

in which W is chosen from:
   a phenyl group

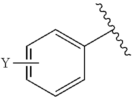

in which Y is chosen from:
   a hydrogen atom
   a linear or branched alkyl group of 1 to 10 carbon atom(s)
   a linear or branched alcoxy group of 1 to 10 carbon atom(s)
   a —OPh group
   an alkylamino or dialkylamino group, substituted by one or two linear alkyl group(s) from 1 to 10 carbon atoms
   a halogen, in particular a fluorine atom, a chlorine atom or a bromine atom
   a nitro NO₂ group
   a trifluoromethyl group CF₃
   a group

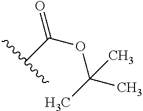 [SMILES: *C(=O)OC(C)(C)C]

a 2-thiophenyl group

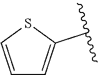 [SMILES: *c1cccs1]

a 3-furanyl group

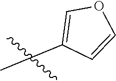 [SMILES: *c1ccoc1]

a 2-naphtyl group

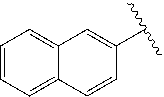 [SMILES: *c1ccc2ccccc2c1]

a 6-quinolyl group

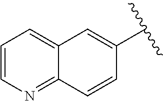 [SMILES: *c1ccc2ncccc2c1]

a group

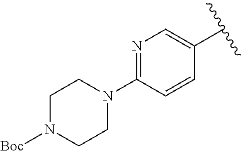 [SMILES: *c1ccc(N2CCN(C(=O)OC(C)(C)C)CC2)nc1]

a group

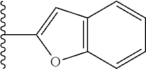 [SMILES: *c1cc2ccccc2o1]

a group

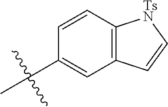 [SMILES: *c1ccc2c(ccn2S(=O)(=O)c2ccc(C)cc2)c1]

a group

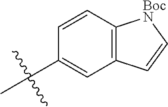 [SMILES: *c1ccc2c(ccn2C(=O)OC(C)(C)C)c1]

a group

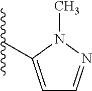 [SMILES: *c1ccnn1C]

a group

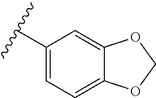 [SMILES: *c1ccc2c(c1)OCO2]

a linear or branched alkyl group of 1 to 20 carbon atom(s) or a cyclic group of 3 to 12 carbon atoms, in particular an octyl group
a group

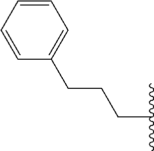 [SMILES: *CCCc1ccccc1]

and V is chosen from:
a group

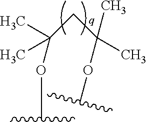

in which q is equal to 0 or 1.
a group

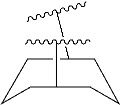 [SMILES: *C1CCCC(*)CCC1]

with a compound of formula (S2): Z-Hal
in which Z is chosen from:
a linear or branched alkyl group of 1 to 20 carbon atoms or a cyclic group of 3 to 12 carbon atoms, in particular an octyl, hexyl, cycloheptyl, cyclopentyl or cyclopropyl group
a 1-adamantyl group with the formula

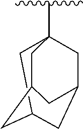 [SMILES: *C12CC3CC(CC(C3)C1)C2]

a benzyl group of formula

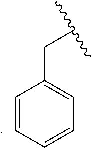 [SMILES: *Cc1ccccc1]

a group

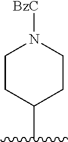

a group

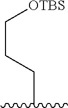 [SMILES: *CCCO[Si](C)(C)C(C)(C)C]

a group

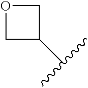 [SMILES: *C1COC1]

a group

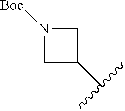 [SMILES: *C1CN(C(=O)OC(C)(C)C)C1]

a group

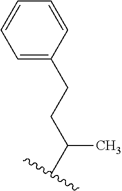 [SMILES: *C(C)CCc1ccccc1]

a group

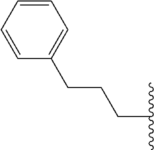 [SMILES: *CCCc1ccccc1]

a group

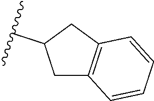 [SMILES: *C1Cc2ccccc2C1]

a group

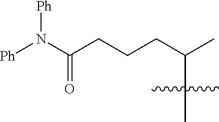 [SMILES: *C(C)CCCC(=O)N(c1ccccc1)c1ccccc1]

and Hal is chosen from:
   a chlorine atom
   a bromine atom
   an iodine atom

In an embodiment, the present invention relates to a method for preparing a compound of formula (Ia) as defined above:

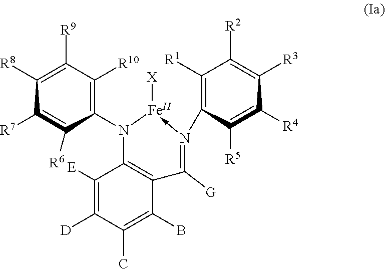

in which:
   X is chosen from
   a chlorine atom
   a bromine atom
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s)
comprising a sequential addition step of n-butyl-lithium and then iron(II) halide FeX₂ on a compound of formula (II)

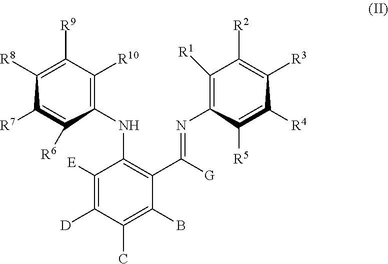

in which B, C, D, E, G, R₁, R₂, R₃, R₄, R₅, R₆, R₇, R₈, R₉ and R₁₀ have the meanings defined above.

In this embodiment, the addition reaction here consists of the deprotonation of the secondary amine function of compound (II) located between two phenyl groups in order to create the N—Fe bond.

Lithium does not cording to compound (Ia) due to steric hindrance around the iron atom due to the B, C, D, E, R₁, R₂, R₃, R₄, R₅, R₆, R₇, R₈, R₉ and R₁₀ groups. The resulting compound (Ia) is sensitive to oxygen and must be kept under inert atmospheric conditions.

In another embodiment, the present invention relates to a method for preparing, as defined above, in which the aforesaid addition step is performed in a cyclic or non-cyclic ether solvent, in particular chosen from tetrahydrofuran, diethyl ether, dimethoxymethane, dimethoxyethane, diethoxymethane, tetrahydrofuran, tert-butylmethyl ether, tert-butylethyl ether, methyl tetrahydrofuran, 1,4-dioxane, methoxycyclopentane, tert-amyl methyl ether or anisole, preferably tetrahydrofuran, from −78° C. to 25° C., preferably at −78° C., for 30 minutes, then 2 hours at 25° C., then 15 hours under stirring.

The term “ether solvent” refers to a solvent in which at least one ether function is found.

This sequential addition can be carried out either in a single solvent or in a first solvent for the addition of n-butyllithium, and then, after evaporation of this solvent, in a second solvent for the addition of FeX₂.

By way of non-limiting example, this step of sequential addition of n-butyllithium and FeX₂ (1:1) can be performed for the addition of n-butyllithium in hexane, and then for the addition of F FeX₂ in a cyclic or non-cyclic ether solvent, in particular chosen from tetrahydrofuran, diethyl ether, dimethoxymethane, dimethoxyethane, diethoxymethane, tetrahydrofuran, tert-butylmethylether, tert-butylethyl ether, methyl tetrahydrofuran, 1,4-dioxane, methoxycyclopentane, tert-amyl methyl ether or anisole.

By way of non-limiting example, this step of sequential addition of n-butyllithium and FeX₂ (1:1) can be performed for the addition of n-butyllithium in a non-coordinating non-polar solvent in particular chosen from benzene, hexane, toluene, cyclohexane, methylcyclohexane, and then for the addition of FeX₂ in tetrahydrofuran.

A “non-coordinating non-polar solvent” means a solvent whose barycenter of the sums of the electronegativity differences are confounded,

By way of non-limiting example, this step of addition of n-butyllithium and Fe2 chloride (1/1) can be performed in tetrahydrofuran at temperatures of −78° C. to 25° C., preferably −78° C. to −30° C. for 30 minutes, then 2 hours from −78° C. to 25° C., preferably from 0° C. to 25° C., then 15 hours from −78° C. to 25° C., preferably from 0° C. to 25° C. under stirring.

In another embodiment, the present invention relates to a method for preparing, as defined above, comprising a step for preparing a compound of formula (II):

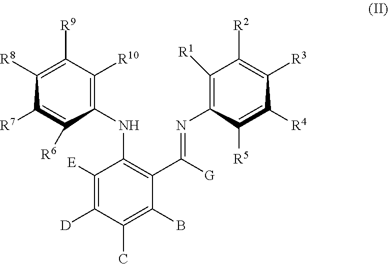

in which B, C, D, E, G, R₁, R₂, R₃, R₄, R₅, R₆, R₇, R₈, R₉ and R₁₀ have the meanings defined above, said step, comprising an aromatic nucleophilic substitution step of a compound of formula (III)

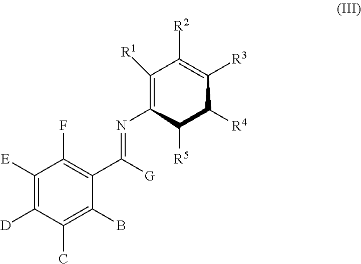

in which B, C, D, E, G, R₁, R₂, R₃, R₄ and R₅ have the meanings defined above, and F is a fluorine atom
on a compound of formula (IV):

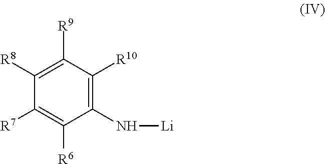

in which R₆, R₇, R₈, R₉ and R₁₀ have the meanings defined above to obtain said compound of formula (II)

Compounds of the following formula being excluded:

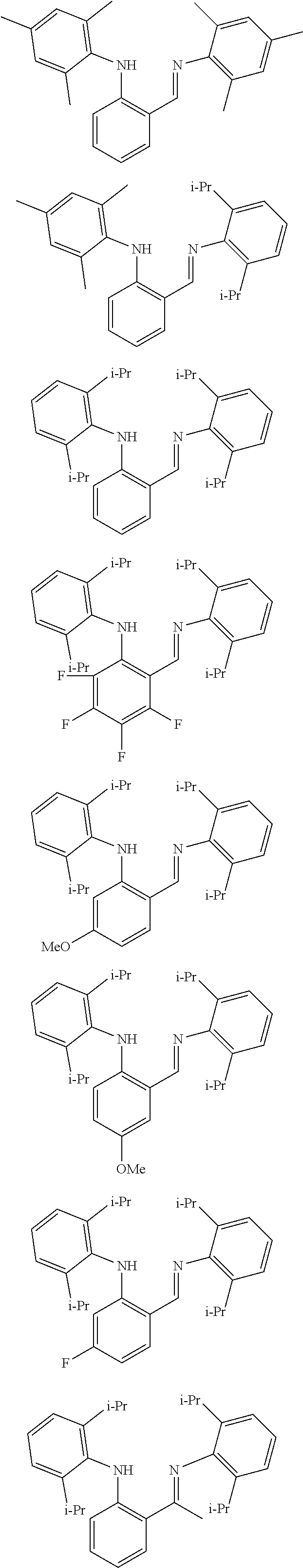

In this embodiment, the aromatic nucleophilic substitution occurs via the lithium amide of compound (IV) substitutes for the fluorine of compound (III).

In another embodiment, the present invention relates to a method for preparing, as defined above, in which the aforesaid aromatic nucleophilic substitution step is performed in a cyclic or non-cyclic ether solvent, in particular chosen from diethyl ether, dimethoxymethane, dimethoxyethane, dietoxymethane, tetrahydrofuran, tertbutylmethyl ether, tertbutyl ethyl ether, methyl tetrahydrofuran, 1,4-dioxane, methoxycyclopentane, tert-amyl methyl ether or anisole, preferably tetrahydrofuran and at a temperature of 25° C. to 125° C., preferably 25° C.

By way of non-limiting example, this aromatic nucleophilic substitution of compound (IV) over compound (III) (1/1) occurs in tetrahydrofuran at temperatures of 25° C. to 125° C., preferably 25° C. to 75° C.

In another embodiment, the present invention relates to a method for preparing, as defined above, in which the aforesaid aromatic nucleophilic substitution step is performed in a non-coordinating non-polar solvent, in particular chosen from benzene, hexane, toluene, cyclohexane, methylcyclohexane, preferably in toluene and at a temperature of 25° C. to 125° C., preferably at 25° C. or 90° C.

By way of non-limiting example, this aromatic nucleophilic substitution of compound (IV) over compound (III) (2.5/1) occurs in toluene at temperatures of 25° C. to 125° C. preferably 25° C. to 75° C.

In another embodiment, the present invention relates to a method for preparing, as defined above, comprising a step for preparing a compound of formula (III)

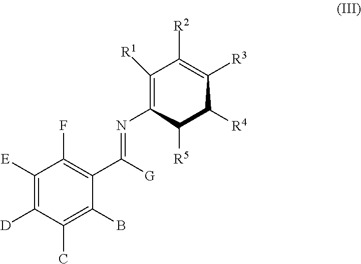

in which B, C, D, E, G, R₁, R₂, R₃, R₄ and R₅, have the meanings defined above, and F is a fluorine atom
said step comprising a condensation reaction of a compound of formula (V)

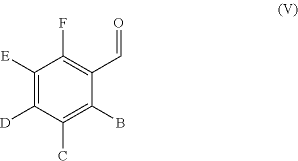

in which B, C, D, and E have the meanings defined above, and F is a fluorine atom on a compound of formula (VI):

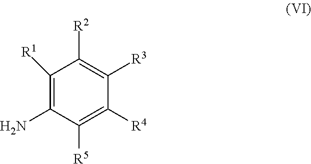

in which R₁, R₂, R₃, R₄, and R₅, have the meanings defined above to obtain said compound of formula (III)

Compounds of the following formula being excluded:

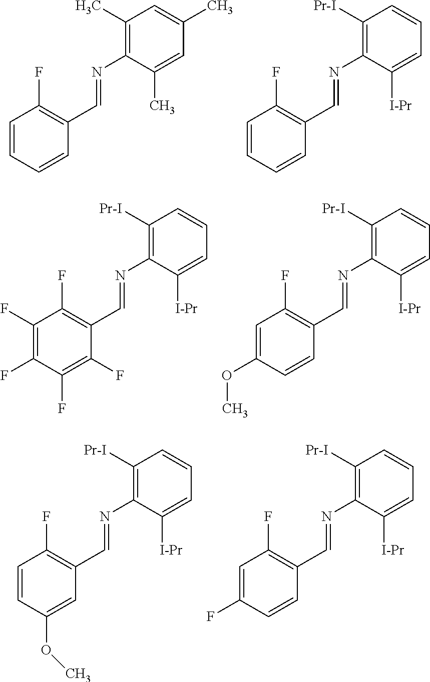

In this embodiment, the condensation step forming compound (III) is made from an aldehyde, compound (V) and an amine, compound (IV).

In another embodiment, the present invention relates to a method for preparing, as defined above, in which the aforesaid condensation step is performed, at a temperature of 0° C. to 150° C., in a non-coordinating or alcohol non-polar solvent, in particular chosen from hexane, toluene, benzene, cyclohexane, methylcyclohexane, butan-1-ol, butan-2-ol, isobutanol, tert-butanol, propan-2-ol, isopropanol, methanol, or ethanol, preferably hexane at 25° C., or preferably toluene at 150° C., or preferably ethanol at 90° C.

The term “alcohol solvent” refers to a solvent that comprises a hydroxyl function.

By way of non-limiting example, this condensation of an aldehyde and an amine (1:1) occurs in the presence of MgSO4 (0.08% molar) in hexane at temperatures of 25° C. to 75° C., preferably at 25° C.

By way of non-limiting example, this condensation of an aldehyde and an amine occurs in the presence of para-toluenesulfonic acid (1/1.1/0.01) in toluene at temperatures of 25° C. to 150° C., preferably at 150° C.

By way of non-limiting example, this condensation of an aldehyde and an amine (1:1.1) takes place in ethanol at temperatures of 25° C. to 90° C., preferably at 25° C.

In another embodiment, the present invention relates to a method for preparing, as defined above, a compound of formula (Ia)

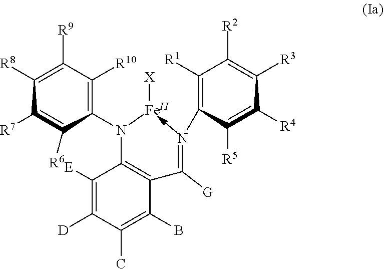

in which:
   X is chosen from
   a chlorine atom
   a bromine atom
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s) comprising: a) a condensation step of a compound of formula (V)

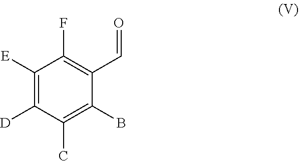

in which in which B, C, D, and E have the meanings defined above and F is a fluorine atom on a compound of formula (VI):

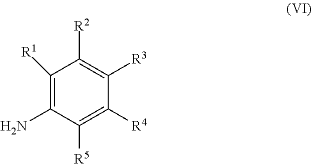

in which R₁, R₂, R₃, R₄, and R₅ have the meanings defined above to obtain the compound of formula (III)

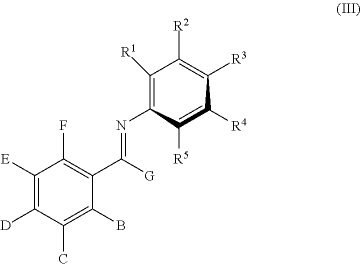

in which B, C, D, E, G, R₁, R₂, R₃, R₄, and R₅ have the meanings defined above, and F is a fluorine atom
   (b) an aromatic nucleophilic substitution step of said compound of formula (III) on a compound of formula (IV):

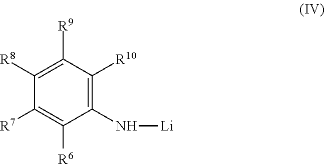

in which R₆, R₇, R₈, R₉ and R₁₀ have the meanings defined above to obtain the compound of formula (II)

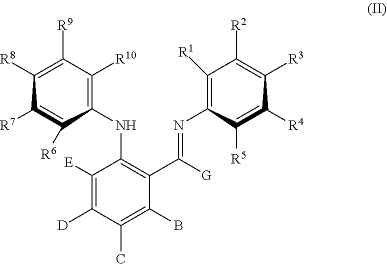

in which B, C, D, E, G, R₁, R₂, R₃, R₄, R₅, R₆, R₇, R₈, R₉ and R₁₀ have the meanings defined above
   c) a sequential addition step of n-butyl lithium and then iron(II) halide FeX₂ on said compound of formula (II) to obtain the compound of formula (Ia).

In another embodiment, the present invention relates to a method for preparing, as defined above, a compound of formula (Ib):

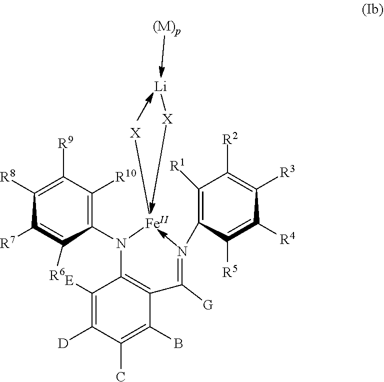

in which:
   X is chosen from
      a chlorine atom
      a bromine atom
   M is a coordinating solvent
   p is chosen from 1, 2, 3, 4 or a decimal number that can vary from a value greater than 0 but less than 4
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 1 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s)
comprising a sequential addition step of n-butyl-lithium and then iron(II) halide FeX₂ on a compound of formula (II)

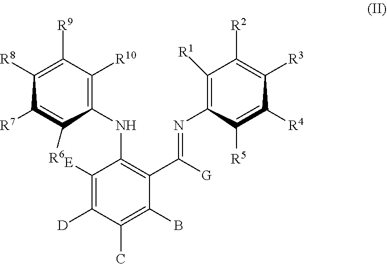

in which B, C, D, E, G, R₁, R₂, R₃, R₄, R₅, R₆, R₇, R₈, R₉ and R₁₀ have the meanings defined above.

In this embodiment, the addition reaction here consists of the deprotonation of the secondary amine function of compound (II) located between two phenyl groups in order to create the N—Fe bond. A first X-atom bound to iron coordinates with a lithium atom, which in turn is already coordinated by another X-atom. This coordination can occur in the absence or presence of a small steric hindrance around the iron atom due to the B, C, D, E, R₁, R₂, R₃, R₄, R₅, R₆, R₇, R₈, R₉ and R₁₀ groups. The resulting compound is sensitive to ambient air and must be stored under inert atmospheric conditions

In another embodiment, the present invention relates to a method for preparing, as defined above, in which the aforesaid addition step is performed in a cyclic or noncyclic ether solvent, in particular chosen from tetrahydrofuran, diethyl ether, dimethoxymethane, dimethoxyethane, diethoxymethane, tetrahydrofuran, tert-butylmethylether, tert-butylethyl ether, methyl tetrahydrofuran, 1,4-dioxane, methoxycyclopentane, tert-amyl methyl ether or anisole, preferably tetrahydrofuran, from −78° C. to 25° C., preferably at −78° C., for 30 minutes, then 2 hours at 25° C., then 15 hours at 25° C. under stirring.

This sequential addition can be carried out either in a single solvent or in a first solvent for the addition of n-butyllithium, and then, after evaporation of this solvent, in a second solvent for the addition of FeCX₂.

By way of non-limiting example, this step of sequential addition of n-butyllithium and FeX₂ (1:1) can be performed for the addition of n-butyllithium in hexane, and then for the addition of FeX₂ in a cyclic or non-cyclic ether solvent, in particular chosen from tetrahydrofuran, diethyl ether, dimethoxymethane, dimethoxyethane, diethoxymethane, tetrahydrofuran, tert-butylmethylether, tert-butylethyl ether, methyl tetrahydrofuran, 1,4-dioxane, methoxycyclopentane, tert-amyl methyl ether or anisole.

By way of non-limiting example, this step of sequential addition of n-butyllithium and FeX₂ (1:1) can be performed for the addition of n-butyllithium in a non-coordinating non-polar solvent in particular chosen from benzene, hexane, toluene, cyclohexane, methylcyclohexane, and then for the addition of FeX₂ in tetrahydrofuran.

By way of non-limiting example, this step of addition of n-butyllithium and FeCl₂ (1/1) can be performed in tetrahydrofuran at temperatures of −78° C. to 25° C., preferably −78° C. to −30° C. for 30 minutes, then 2 hours from −78° C. to 25° C., preferably from 0° C. to 25° C., then 15 hours from −78° C. to 25° C., preferably from 0° C. to 25° C. under stirring.

In another embodiment, the present invention relates to a method for preparing, as defined above, comprising a step for preparing a compound of formula (II):

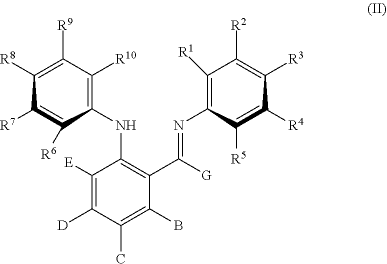

in which B, C, D, E, G, R₁, R₂, R₃, R₄, R₅, R₆, R₇, R₈, R₉ and R₁₀ have the meanings defined above, said step, comprising an aromatic nucleophilic substitution step of a compound of formula (III)

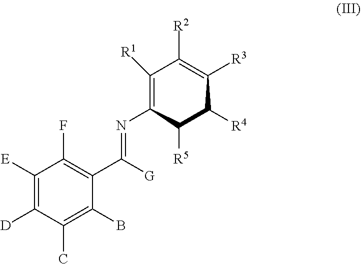

in which B, C, D, E, G, R₁, R₂, R₃, R₄, and R₅ have the meanings defined above, and F is a fluorine atom
on a compound of formula (IV):

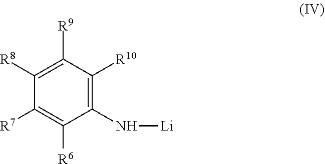

in which R₆, R₇, R₈, R₉ and R₁₀ have the meanings defined above to obtain said compound of formula (II)

Compounds of the following formula being excluded:

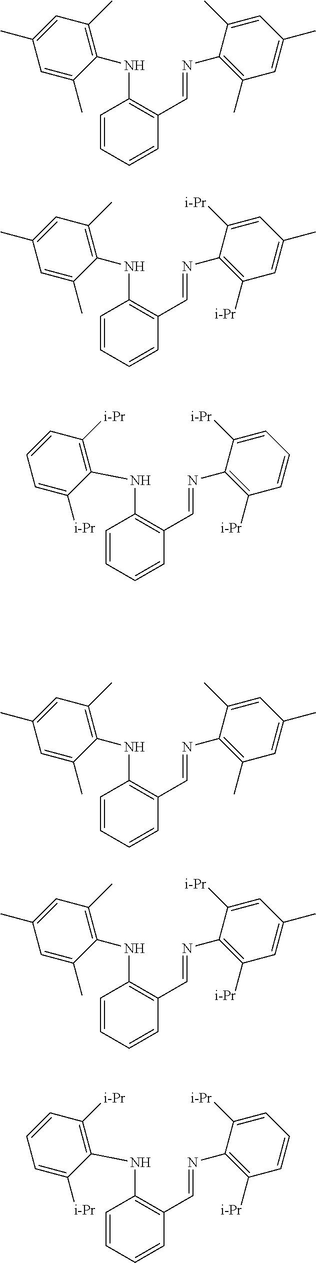

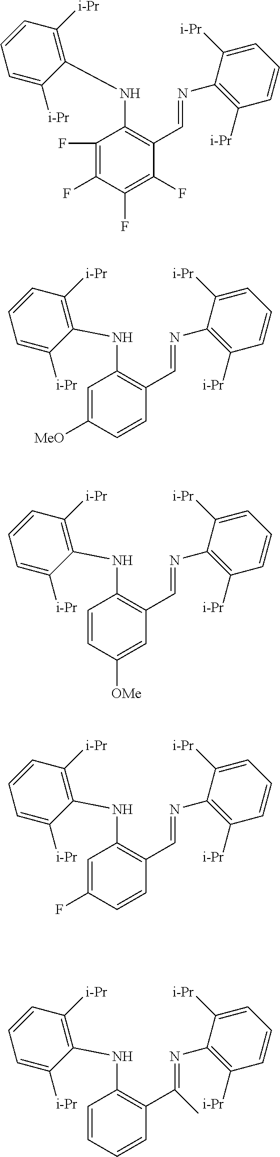 [SMILES: CC(C)c1cccc(C(C)C)c1/N=C/c1c(F)c(F)c(F)c(F)c1Nc1c(C(C)C)cccc1C(C)C ; COc1ccc(/C=N/c2c(C(C)C)cccc2C(C)C)c(Nc2c(C(C)C)cccc2C(C)C)c1 ; COc1ccc(Nc2c(C(C)C)cccc2C(C)C)c(/C=N/c2c(C(C)C)cccc2C(C)C)c1 ; CC(C)c1cccc(C(C)C)c1/N=C/c1ccc(F)cc1Nc1c(C(C)C)cccc1C(C)C ; C/C(=N\c1c(C(C)C)cccc1C(C)C)c1ccccc1Nc1c(C(C)C)cccc1C(C)C]

In this embodiment, the aromatic nucleophilic substitution occurs via the lithium amide of compound (IV) substitutes for the fluorine of compound (III).

In another embodiment, the present invention relates to a method for preparing, as defined above, in which the aforesaid aromatic nucleophilic substitution step is performed in a cyclic or non-cyclic ether solvent, in particular chosen from diethyl ether, dimethoxymethane, dimethoxyethane, dietoxymethane, tetrahydrofuran, tertbutylmethyl ether, tertbutyl ethyl ether, methyl tetrahydrofuran, 1,4-dioxane, methoxycyclopentane, tert-amyl methyl ether or anisole, preferably tetrahydrofuran and at a temperature of 25° C. to 125° C., preferably 25° C.

By way of non-limiting example, this aromatic nucleophilic substitution of compound (IV) over compound (III) (1/1) occurs in tetrahydrofuran at temperatures of 25° C. to 125° C., preferably 25° C. to 75° C.

In another embodiment, the present invention relates to a method for preparing, as defined above, in which the aforesaid aromatic nucleophilic substitution step is performed in a non-coordinating non-polar solvent, in particular chosen from benzene, hexane, toluene, cyclohexane, methylcyclohexane, preferably in toluene and at a temperature of 25° C. to 125° C., preferably at 25° C. or 90° C.

By way of non-limiting example, this aromatic nucleophilic substitution of compound (IV) over compound (III) (2.5/1) occurs in toluene at temperatures of 25° C. to 125° C. preferably 25° C. to 75° C.

In another embodiment, the present invention relates to a method for preparing, as defined above, comprising a step for preparing a compound of formula (III)

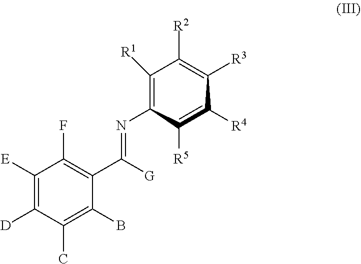

in which B, C, D, E, G, R₁, R₂, R₃, R₄, and R₅ have the meanings defined above, and F is a fluorine atom
said step comprising a condensation reaction of a compound of formula (V)

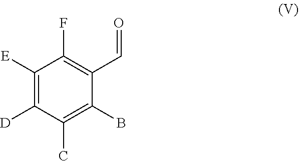

in which B, C, D, and E have the meanings defined above, and F is a fluorine atom on a compound of formula (VI):

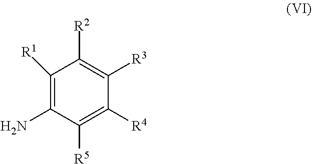

in which R₁, R₂, R₃, R₄, and R₅ have the meanings defined above to obtain said compound of formula (III)

Compounds of the following formula being excluded:

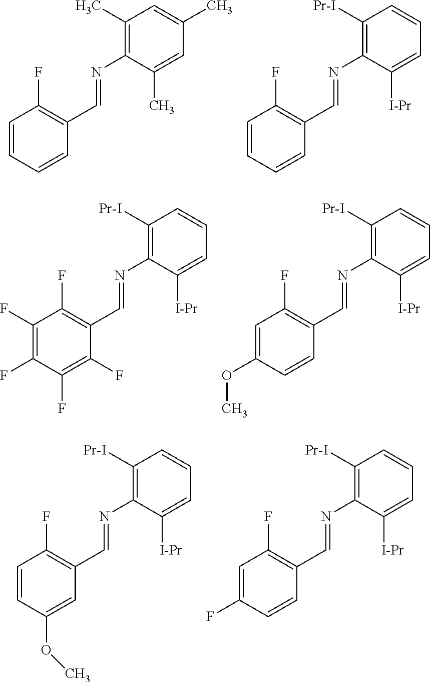

In this embodiment, the condensation step forming the imine of compound (III) is made from an aldehyde, compound (V) and an amine, compound (IV).

In another embodiment, the present invention relates to a method for preparing, as defined above, in which the aforesaid condensation step is performed, at a temperature of 0° C. to 150° C., in a non-coordinating or alcohol non-polar solvent, in particular chosen from hexane, toluene, benzene, cyclohexane, methylcyclohexane, butan-1-ol, butan-2-ol, isobutanol, tert-butanol, propan-2-ol, isopropanol, methanol, or ethanol, preferably hexane at 25° C., or preferably toluene at 150° C. or preferably ethanol at 90° C.

By way of non-limiting example, this condensation of an aldehyde and an amine (1:1) occurs in the presence of MgSO₄ (0.08% molar) in hexane at temperatures of 25° C. to 75° C., preferably at 25° C.

By way of non-limiting example, this condensation of an aldehyde and an amine occurs in the presence of para-toluenesulfonic acid (1/1.1/0.01) in toluene at temperatures of 25° C. to 150° C., preferably at 150° C.

By way of non-limiting example, this condensation of an aldehyde and an amine (1/1.1) takes place in ethanol at temperatures of 25° C. to 90° C., preferably at 25° C.

In another embodiment, the present invention relates to a method for preparing, as defined above, a compound of formula (Ib)

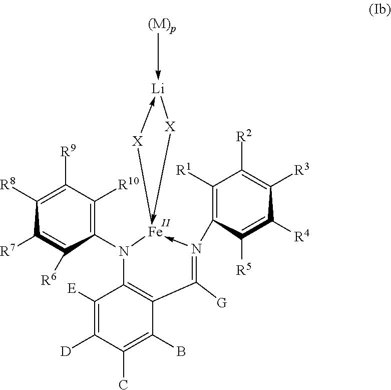

in which:
   X is chosen from
      a chlorine atom
      a bromine atom
   M is a coordinating solvent
   p is chosen from 1, 2, 3, 4 or a decimal number that can vary from a value greater than 0 but less than 4
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 10 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 1 to 4 carbon atoms, a linear or branched alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s) comprising: a) a condensation step of a compound of formula (V)

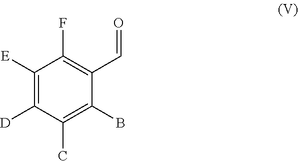

in which in which B, C, D, and E have the meanings defined above and F is a fluorine atom on a compound of formula (VI):

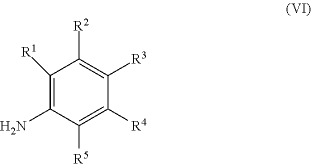

in which R₁, R₂, R₃, R₄, and R₅ have the meanings defined above to obtain the compound of formula (III)

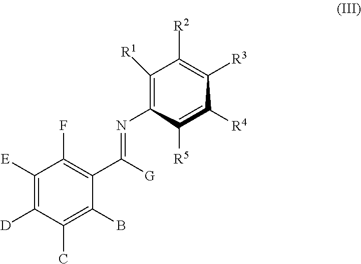

in which B, C, D, E, G, R₁, R₂, R₃, R₄, and R₅ have the meanings defined above, and F is a fluorine atom
   (b) an aromatic nucleophilic substitution step of said compound of formula (III) on a compound of formula (IV):

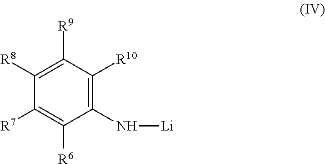

in which R₆, R₇, R₈, R₉ and R₁₀ have the meanings defined above to obtain the compound of formula (II)

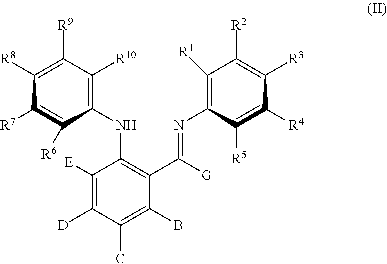

in which B, C, D, E, G, R₁, R₂, R₃, R₄, R₅, R₆, R₇, R₈, R₉ and R₁₀ have the meanings defined above
   (c) a sequential addition step of n-butyl lithium and then iron(II) halide FeX₂ on said compound of formula (II) to obtain the compound of formula (Ib).

In a particular embodiment, the present invention relates to a method for preparing, as defined above, a compound of formula (Ic):

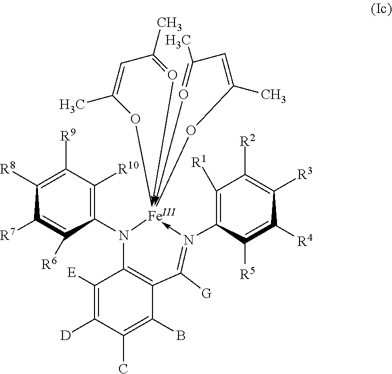

in which:
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 1 to 4 carbon atoms, a linear or branched Alcoxy group of 1 to 10 carbon atom(s) or a linear or branched dialkylamino group of 2 to 20 carbon atoms
   G is chosen from
      a hydrogen atom
      a linear or branched alkyl group of 1 to 5 carbon atom(s)
comprising a sequential addition step of n-butyl lithium, then iron(III) tris-acetylacetonate on a compound of formula (II)

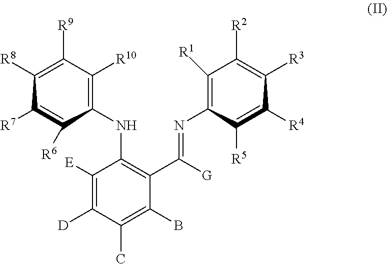

in which B, C, D, E, G, R₁, R₂, R₃, R₄, R₅, R₆, R₇, R₈, R₉ and R₁₀ have the meanings defined above
to obtain said compound of formula (Ic).

In this embodiment, the addition reaction here consists of the deprotonation of the secondary amine function of compound (II) located between two phenyl groups in order to create the N—Fe bond. The compounds with the formula (Ic) thus obtained are stable in ambient air.

In another embodiment, the present invention relates to method for preparing, as defined above, in which the aforesaid addition step is performed in a cyclic or non-cyclic ether solvent, in particular chosen from tetrahydrofuran, diethyl ether, dimethoxymethane, dimethoxyethane, diethoxymethane, tetrahydrofuran, tert-butylmethylether, tert-butylethyl ether, methyl tetrahydrofuran, 1,4-dioxane, methoxycyclopentane, tert-amyl methyl ether or anisole, preferably tetrahydrofuran, from −78° C. to 25° C., preferably at 25° C., then 16 hours at 25° C. under stirring under stirring.

This sequential addition can be carried out either in a single solvent or in a first solvent for the addition of n-butyllithium, and then, after evaporation of this solvent, in a second solvent for the addition of Fe(acac)₃.

By way of non-limiting example, this step of sequential addition of n-butyllithium and Fe(acac)₃ (1/1) can be performed for the addition of n-butyllithium in hexane, then for the addition of Fe(acac)₃ in a cyclic or non-cyclic ether solvent, in particular chosen from tetrahydrofuran, diethyl ether, dimethoxymethane, dimethoxyethane, diethoxymethane, tetrahydrofuran, tert-butylmethyl ether, tert-butylethyl ether, methyl tetrahydrofuran, 1,4-dioxane, methoxycyclopentane, tert-amyl methyl ether or anisole.

By way of non-limiting example, this step of sequential addition of n-butyllithium and Fe(acac)₃ (1/1) can be performed for the addition of n-butyllithium in a non-coordinating non-polar solvent in particular chosen from benzene, hexane, toluene, cyclohexane, methylcyclohexane, and then for the addition of Fe(acac)₃ in tetrahydrofuran.

By way of non-limiting example, this step of addition of n-butyllithium and Fe(acac)₃ (1/1) can be performed in tetrahydrofuran at temperatures of −78° C. to 25° C., preferably −78° C. to −30° C. for 30 minutes, then 2 hours from −78° C. to 25° C., preferably from 0° C. to 25° C., then 4 p.m. from −78° C. to 25° C., preferably at 25° C.

In another embodiment, the present invention relates to a method for preparing, as defined above, comprising a step for preparing a compound of formula (II):

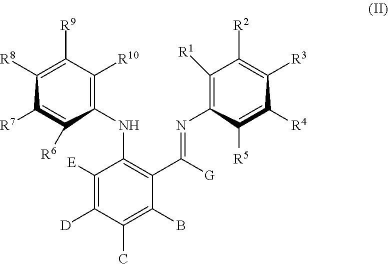

in which B, C, D, E, G, R₁, R₂, R₃, R₄, R₅, R₆, R₇, R₈, R₉ and R₁₀ have the meanings defined above, said step, comprising a nucleophilic aromatic substitution step of a compound of formula (III)

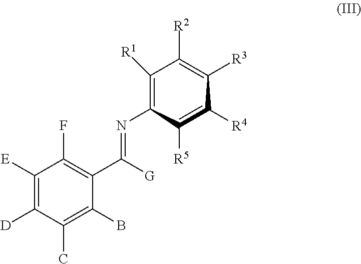

in which B, C, D, E, G, R₁, R₂, R₃, R₄ and R₅ have the meanings defined above, and F is a fluorine atom
on a compound of formula (IV):

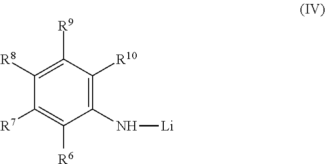

in which R₆, R₇, R₈, R₉ and R₁₀ have the meanings defined above
to obtain said compound of formula (II).

In this embodiment, the aromatic nucleophilic substitution occurs via the lithium amide of compound (IV) substitutes for the fluorine of compound (III).

In another embodiment, the present invention relates to a method for preparing, as defined above, in which the aforesaid aromatic substitution step is performed in a cyclic or non-cyclic ether solvent, in particular chosen from diethyl ether, dimethoxymethane, dimethoxyethane, dietoxymethane, tetrahydrofuran, tertbutyl methylether, tertbutyl ethyl ether, methyl tetrahydrofuran, 1,4-dioxane, methoxycyclopentane, tert-amyl methyl ether or anisole, preferably tetrahydrofuran and at a temperature of 25° C. to 125° C., preferably 25° C.

By way of non-limiting example, this aromatic nucleophilic substitution of compound (IV) over compound (III) (1/1) occurs in tetrahydrofuran at temperatures of 25° C. to 125° C., preferably 25° C. to 75° C.

In another embodiment, the present invention relates to a method for preparing, as defined above, in which the aforesaid addition step is performed in a non-coordinating non-polar solvent, in particular chosen from benzene, hexane, toluene, cyclohexane, methylcyclohexane, preferably in toluene and at a temperature of 25° C. to 125° C., preferably at 25° C. or 90° C.

As a non-limiting example, this aromatic nucleophilic substitution of compound (IV) over compound (III) (2.5/1) occurs in toluene at temperatures of 25° C. to 125° C., preferably 90° C. to 125° C.

By way of non-limiting example, this aromatic nucleophilic substitution of compound (IV) over compound (III) (2.5/1) occurs in toluene at temperatures of 25° C. to 125° C., preferably 25° C. to 75° C.

In another embodiment, the present invention relates to a method for preparing, as defined above, comprising a step for preparing a compound of formula (III)

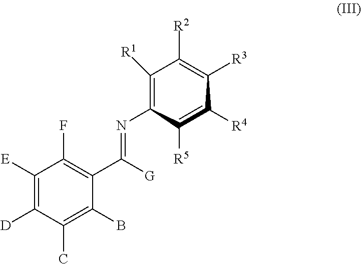

in which B, C, D, E, G, R₁, R₂, R₃, R₄ and R₅ have the meanings defined above, and F is a fluorine atom
said step, comprising a step of condensation of a compound of formula (V)

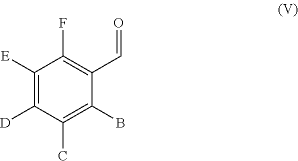

in which B, C, D, E, G, R₁, R₂, R₃, R₄ and R₅ have the meanings defined above, and F is a fluorine atom
on a compound of formula (VI):

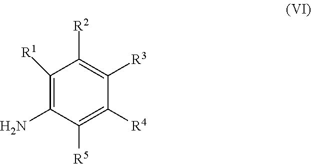

in which R₁, R₂, R₃, R₄ and R₅ have the meanings defined above, to obtain said compound of formula (III).
In this embodiment, the imine formation step of compound (III) is carried out from an aldehyde, compound (V) and an amine, compound (IV).
In another embodiment, the present invention relates to a method for preparing, as defined above, in which the aforesaid condensation step is performed, at a temperature of 0° C. to 150° C., in a non-coordinating non-polar or alcohol solvent, in particular chosen from hexane, toluene, benzene, cyclohexane, methylcyclohexane, 1-butanol, 2-butanol, isobutanol, tert-butanol, 2-propanol, isopropanol, methanol or ethanol, preferably hexane at 25° C., or preferably in toluene at 150° C. or preferably in ethanol at 90° C.
By way of non-limiting example, this condensation of an aldehyde and an amine (1:1) occurs in the presence of MgSO4 (0.08% molar) in hexane at temperatures of 25° C. to 75° C., preferably at 25° C.
By way of non-limiting example, this condensation of an aldehyde and an amine occurs in the presence of para-toluenesulfonic acid (1/1.1/0.01) in toluene at temperatures of 25° C. to 150° C., preferably at 150° C.
By way er of non-limiting example, this condensation of an aldehyde and an amine (1/1.1) takes place in ethanol at temperatures of 25° C. to 90° C., preferably at 25° C.
In another embodiment, the present invention relates to a method for preparing, as defined above, a compound of formula (Ic)

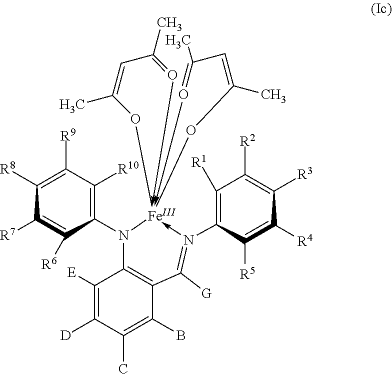

in which:
   B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alcoxy group of 1 to 10 carbon atoms, or a linear or branched dialkylamino group of 2 to 20 carbon atoms
   R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 1 to 4 carbon atoms, a linear or branched alcoxy group of 1 to 10 carbon atom(s) or a linear or branched dialkylamino group of 2 to 20 carbon atom(s)
   G is chosen from
      a hydrogen atom
      a linear or branched alkyl group of 1 to 5 carbon atom(s)
comprising: a) a condensation step of a compound of formula (V)

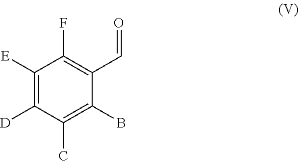

in which B, C, D, and E have the meanings defined above, and F is a fluorine atom on a compound of formula (VI):

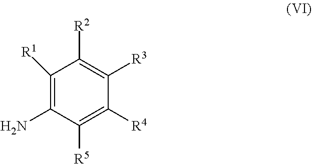

in which R₁, R₂, R₃, R₄ and R₅ have the meanings defined above to obtain the compound of formula (III)

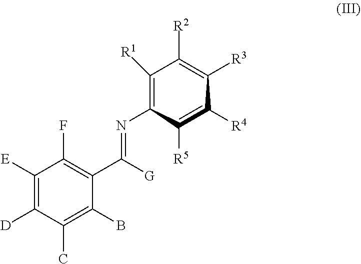

in which B, C, D, E, G, R₁, R₂, R₃, R₄ and R₅ have the meanings defined above, and F is a fluorine atom
(b) an aromatic nucleophilic substitution step of said compound of formula (III) on a compound of formula (IV):

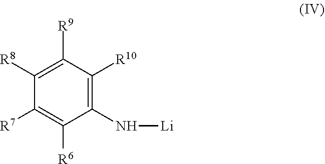

in which R₆, R₇, R₈, R₉ and R₁₀ have the meanings defined above to obtain the compound of formula (II)

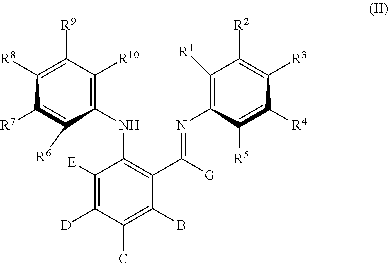

in which B, C, D, E, G, R₁, R₂, R₃, R₄, R₅, R₆, R₇, R₈, R₉ and R₁₀ have the meanings defined above,
(c) a step of sequential addition of n-butyl lithium and then iron(III) tris-acetylacetone on said compound of formula (II) to obtain said compound of formula (Ic).

### EXAMPLES

### Materials and Methods

The ¹H and ¹³C NMR spectra were made at 298 K on a Bruker AM250, AV300 or AV360 MHz Bruker spectrometer. The NMR spectra of ⁷Li and ¹⁹F were made at 295 K on a Bruker 300 and 250 spectrometer respectively. The chemical shifts of the ¹H spectra were measured using an internal reference that is residual protonated CHCl₃ in CDCl₃ (7.24 ppm) or residual protonated benzene in benzene-d6 (7.16 ppm).

Elemental analyses were performed at the Analytische Laboratorien GMBH in Lindlar, Germany.

High-resolution mass spectra were measured by electrospray ionization (ESI) with a Bruker MicrOTOFq time-of-flight mass spectrometer or an LCT Waters spectrometer using electrospray ionization-time-of-flight mass spectrometry (ESI-TOF)

The following are the general procedures for the preparation of compounds of formula (Ia), (II) and (III).

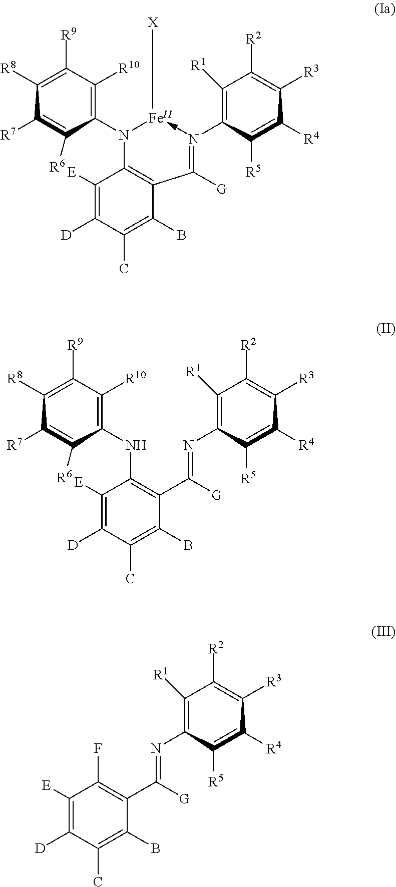

in which the groups R₂, R₄, R₇ and R₉ represent a hydrogen atom, and the groups R₁, R₃, R₅, R₆, R₈ and R₁₀ have the meanings shown in the following table [Table 1]

| | | | | | | | | | | Yield | Yield | Yield |
|---|---|---|---|---|---|---|---|---|---|---|---|---|
| | | | | | | | | | | [%] | [%] | [%] |
| B | C | D | E | G | X | R¹, R⁵ | R⁶, R¹⁰ | R⁸ | R³ | (III) | (II) | (Ia)^{[b]} |
| H | H | H | H | H | Cl | Me | Me | Me | Me | 60^{[a]} | 31^{[d]} | 75 |
| H | H | H | H | H | Cl | iPr | Me | Me | H | 66^{[a]} | 33^{[d]} | 57 |
| H | H | H | H | H | Cl | iPr | iPr | H | H | 66^{[a]} | 43^{[d]} | 78 |
| H | OMe | H | H | H | Cl | iPr | iPr | H | H | 76^{[b]} | 72^{[e]} | 87 |
| H | H | F | H | H | Cl | iPr | iPr | H | H | 61^{[a]} | 37^{[d]} | 26 |
| H | H | H | H | Me | Cl | iPr | iPr | H | H | — | 26^{[g]} | 28 |
| H | H | OMe | H | H | Cl | iPr | iPr | H | H | 80^{[b]} | 74^{[} [symbol] ^{]} | 83 |
| F | F | F | F | F | Cl | iPr | iPr | H | H | 83^{[} [symbol] ^{]} | 82^{[f]} | 66 |

^{[a]}Procedure A1.
^{[b]}Procedure A2.
^{[c]}Procedure A3.
^{[d]}Procedure B1.
^{[e]}Procedure B2, 90° C.
^{[f]}Procedure B2, 25° C.
^{[g]}Procedure B3.
^{[h]}Procedure C1. [symbol]
indicates data missing or illegible when filed

Procedure A1: The appropriate aniline derivative (1 eq) is added under stirring to a solution of the appropriate 2-fluorobenzaldehyde derivative (1 eq) and MgSO₄ in hexane (c=1.6 M) at 25° C. The solution is stirred for 2 hours at this temperature and then filtered, concentrated under reduced pressure and cooled to −20° C. to give the corresponding compound (III) in the form of yellow crystals.

Procedure A2: In a Dean-Stark apparatus, para-toluene sulfonic acid (0.01 eq) is added under stirring to a solution of the appropriate 2-fluorobenzaldehyde derivative (1 eq) and the appropriate aniline derivative (1.1 eq) in toluene (c=0.40 M). The solution is heated to 150° C. for 15 hours. Then, the solution is cooled to 25° C. before adding an aqueous solution saturated with Na₂CO₃. The aqueous phase is separated and extracted with Et₂O. The organic phases are combined, dried on MgSO₄, filtered and concentrated under reduced pressure to give a slightly yellow oil. Recrystallization in hexane at −20° C. yields the corresponding compound (III) in the form of yellow-colored crystals.

Procedure A3: 2,6-Diisopropylamine (1.1 eq) is added to a perfluorobenzaldehyde solution (1 eq) in EtOH (c=1.5 M) at 25° C. and the solution is stirred at this temperature for 2 hours. The solution is concentrated under reduced pressure and then cooled to −20° C., the corresponding compound (III) is obtained in the form of yellow crystals.

Procedure B1: A solution of n-butyllithium (n-Buli) (1 eq) is added under stirring to a solution of the appropriate aniline derivative (1 eq) in tetrahydrofuran (THF) (c=1 M) at −78° C. The solution is stirred for 15 h and then cannulated in a solution of the appropriate compound (III) (1 eq) in THF (c=1 M) at 25° C. The solution is stirred for 2 hours at this temperature and then water is added. The aqueous phase is separated and extracted with hexane. The organic phases are combined, dried on MgSO₄, filtered and concentrated under reduced pressure to give a brown oil. Recrystallization in hot ethanol or at −20° C. yields the corresponding compound (II) in the form of yellow crystals.

Procedure B2: The appropriate compound (III) (1 eq) is added to a suspension of lithium (2,6-diisopropylphenyl)amide (2.5 eq) in toluene (10 mL) at 25° C. The solution is heated to 90° C. under stirring for 72 hours or to 25° C. for 48 hours. Then, the solution is cooled to 25° C. before adding an aqueous solution saturated with Na₂CO₃. The aqueous phase is separated and extracted with Et₂O. The organic phases are combined, dried on MgSO₄, filtered and concentrated under reduced pressure to give an oil with a slightly brown color. Recrystallization in hot EtOH yields the corresponding compound (II) in the form of pale yellow crystals.

Procedure B3: TiCl₄ (0.5 eq) was added to a solution of 2,6-diisopropylaniline (3 eq) in hexane (c=1 M) under stirring at 0° C. The solution was stirred at 25° C. for 24 hours. Then the solution was heated to reflux and a solution of 2-fluoroacetophenone (1 eq) in hexane (c=2.6 M) is added. The solution is heated by reflux for 16 hours. A brown solid appears in the solution. The solution is filtered and the solid is washed with hexane. The organic phases are collected and washed with water. The aqueous phase is separated, and then extracted with hexane. The organic phases are collected and dried with MgSO₄, filtered and concentrated under vacuum until a yellow oil appears. n-BuLi (1 eq) was added to a stirring solution of 2,6-diisopropylaniline (1 eq) in THF (c=1 M) at −78° C. The solution is stirred for 18 hours, then deposited with a cannula in the solution of the yellow oil previously synthesized in THF at 25° C. The solution is stirred for 2 hours at 25° C. Then water is added to the media. The aqueous phase is separated and then extracted with Et₂O. The organic phases are gathered, dried with MgSO₄, filtered and the solvent is evaporated under vacuum to obtain a slightly brown oil. The slightly brown oil is recrystallized in ethanol when hot to obtain the corresponding compound (II) in the form of a pale white powder.

Procedure C1: N-BuLi (1.6 eq) is added under stirring to a solution of the appropriate compound (III) (1 eq) in THF (c=0.4 M) at −78° C. The cooling bath is removed 30 minutes after the addition. The solution is stirred for 2 hours at 25° C. Then, FeCl₂ (1 eq) is added. The solution is stirred for 15 hours at 25° C. and then the solvent is evaporated under reduced pressure. The residual solid is washed with hexane and then extracted with Et₂O. The dark red solution is concentrated and cooled to −20° C. to give a dark red powder of the corresponding compound (Ia).

### Example 1: Synthesis of (E)-N-mesityl-1-(perfluorophenyl)methanimine

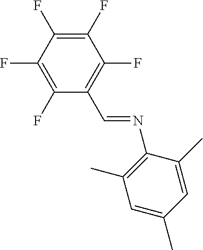 [SMILES: Cc1cc(C)c(/N=C/c2c(F)c(F)c(F)c(F)c2F)c(C)c1]

2,4,6-trimethylaniline (2.3 mL, 16.05 mmol) is added to a perfluorobenzaldehyde solution (1.8 mL, 15 mmol) in EtOH (10 mL) at 25° C. and the solution is refluxed (90° C.) for 16 hours. After evaporation of the solvent and recrystallization in Et2O at −20° C., (E)-N-mesityl-1-(perfluorophenyl)methanimine (4.4 g, 14 mmol, 94%) is obtained in the form of yellow crystals. ¹H NMR (360 MHz, CDCl₃, 25° C.) δ ppm 8.36 (s, 1H, NH), 6.91 (s, 2H, H Ar), 2.30 (s, 3H, p-W), 2.15 (s, 6H, o-W). ¹³C NMR (90 MHz, CDCl₃, 25° C.) δ 151.6, 148.4, 134.2, 129.0, 126.5, 20.8, 18.1. MS-HR (ESI) m/z calculated for C16H13F5N [M+H]⁺ 314.0963, found: 314.0957.

### Example 2: Synthesis of (E)-N-(2-ethylphenyl)-1-(pentafluorophényl)methanimine

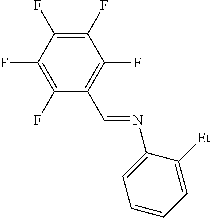 [SMILES: CCc1ccccc1/N=C/c1c(F)c(F)c(F)c(F)c1F]

2-Ethylaniline (2.0 mL, 16.5 mmol) is added to a perfluorobenzaldehyde solution (1.8 mL, 15 mmol) in EtOH (10 mL) at 25° C. and the solution is refluxed (90° C.) for 16 hours. After evaporation of the solvent and recrystallization in ether at −20° C., (E)-N-(2-ethylphenyl)-1-(pentafluorophenyl)methanimine (3.7 g, 13.3 mmol, 82%) is obtained in the form of yellow crystals. 1H NMR (360 MHz, CDCl3, 25° C.) δ ppm 8.59 (s, 1H, NH), 7.34-7.26 (m, 3H, H Ar), 7.03-6.98 (m, 1H, H Ar), 2.84 (q, 2H, J=7.5 Hz, CH₂CH₃), 1.26 (t, 3H, J=7.5 Hz, CH₂CH₃). 13C NMR (90 MHz, CDCl₃, 25° C.) δ 149.8, 147.3, 138.8, 129.0, 127.4, 126.9, 116.9, 24.8, 14.9. MS-HR (ESI) m/z calculated for C15H11F5N [M+H]⁺ 300.0806, found: 300.0799.

### Example 3: Synthesis of (E)-2,3,4,5-tetrafluoro-N-mesityl-6-((mesitylimino)methyl)aniline

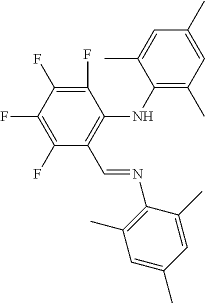 [SMILES: Cc1cc(C)c(/N=C/c2c(F)c(F)c(F)c(F)c2Nc2c(C)cc(C)cc2C)c(C)c1]

(E)-N-mesityl-1-(perfluorophenyl)methanimine (2.5 g, 8 mmol) is added to a solution of lithium (2,4,6-trimethylphenyl)amide (2.8 g, 20 mmol) in toluene (16 mL) and then stirred for 48 h at 25° C. After the addition of a saturated solution of NaHCO₃ (50 mL), the aqueous phase is extracted with EtOAc (50 mL). The organic phases are gathered, dried on MgSO4, filtered and concentrated under reduced pressure. Recrystallization in MeOH at −20° C. is performed and yields pale yellow colored crystals of the product (E)-2,3,4,5-tetrafluoro-N-mesityl-6-((mesitylimino)methyl)aniline (3.3 g, 7.7 mmol, 96%) ¹H NMR (360 MHz, CDCl₃, 25° C.) δ ppm 10.94 (s, 1H, NH), 8.66 (s, 1H, ArCHN), 6.92-6.90 (m, 4H, H Ar), 2.30 (s, 6H, p-W), 2.22 (s, 6H, o-W), 2.15 (s, 6H, o-W). ¹³C {19F}NMR (100 MHz, CDCl₃, 25° C.) δ ppm 157.8, 147.5, 137.6, 135.9, 135.8, 135.4, 135.3, 135.1, 134.1, 131.9, 129.5, 129.0, 128.5, 127.3, 102.5, 20.9, 20.7, 18.4. MS-HR (ESI) m/z calculated for C25H25F4N [M+H]⁺ 429.1948, found: 429.1934.

### Example 4: Synthesis of (E)-N-(2-ethylphenyl)-2-(((2-ethylphenyl)imino)methyl)-3,4,5,6-tetrafluoroaniline

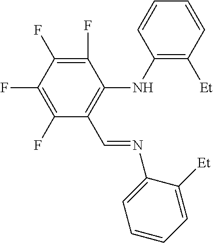 [SMILES: CCc1ccccc1/N=C/c1c(F)c(F)c(F)c(F)c1Nc1ccccc1CC]

(E)-N-(2-ethylphenyl)-1-(pentafluorophenyl)methanimine (2.4 g, 8 mmol) is added to a solution of lithium 2-(ethylphenyl)amide (2.5 mL, 20 mmol), in toluene (16 mL) and then stirred for 48 h at 25° C. After the addition of a saturated solution of NaHCO₃ (50 mL), the aqueous phase is extracted with EtOAc (50 mL). The organic phases are gathered, dried on MgSO₄, filtered and concentrated under reduced pressure. Recrystallization in MeOH at −20° C. yields pale yellow crystals of the product (E)-N-(2-ethylphenyl)-2-(((2-ethylphenyl)imino)methyl)-3,4,5,6-tetrafluoroaniline (2.7 g, 6.75 mmol, 84%). 1H NMR (360 MHz, CDCl₃, 25° C.) δ ppm 10.91 (s, 1H, NH), 8.84 (s, 1H, ArCHN), 7.32-7.23 (m, 4H, H Ar), 7.21-7.12 (m, 2H, H Ar), 7.04-7.00 (m, 2H, H Ar), 2.81-2.70 (m, 4H, CH2CH3), 1.26 (t, 3H, J=7.5 Hz, CH2CH3), 1.13 (t, 3H, J=7.5 Hz, CH2CH3). ¹³C {19F}NMR (100 MHz, CDCl₃, 25° C.) δ ppm 153.9, 149.1, 139.3, 137.7, 137.0, 133.7, 132.9, 131.3, 128.9, 128.6, 127.1, 127.0, 126.1, 124.8, 122.2, 118.2, 106.0, 24.9, 24.7, 14.8, 14.2. MS-HR (ESI) m/z calculated for C23H21F4N2 [M+H]⁺ 401.1635, found: 401.1621.

### Example 5: Synthesis of P5

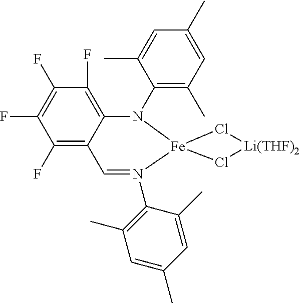

n-BuLi (2.5 M in hexane) (2 mL, 5 mmol) is stirred to a solution of (E)-2,3,4,5-tetrafluoro-N-mesityl-6-((mesitylimino)methyl)aniline (2.1 g, 5 mmol) in THF (10 mL) at −78° C. The cooling bath is removed 30 minutes after the addition. The solution is stirred for 4 hours at 25° C. Then, FeCl₂ (0.63 g, 5 mmol) is added. The solution is stirred overnight and then the solvent is evaporated under reduced pressure. The residual solid is washed with hexane or pentane (10 mL) and extracted with Et₂O (25 mL). The ethereal solution is filtered and then concentrated and replaced with hexane (20 mL). After adding a few drops of THF and cooling to −20° C., red crystals of the P5 product (2.09 g, 3.0 mmol 60%) are obtained. Calculated elemental analysis for C25H23Cl2F4FeLiN2(C4H80)₂: C, 56.19; H, 5.57; N, 3.97, found: C, 54.53; H 5.92; N 4.15. ¹H NMR (360 MHz, C6D6-50 μL THF-d8, 25° C.) δ ppm 71.05 (s, 3H, p-Me), 33.95 (s, 3H, p-Me), 25.51 (s, 2H, m-H Ar), 24.01 (br s, 6H, o-Me), 14.16 (s, 2H, m-H Ar), 4.37 (br s, 12H, THF), 2.15 (br s, 6H, o-Me), 1.69 (br s, 12H, THF). 7Li NMR (117 MHz, C6D6-50 μL THF-d8, 25° C.) δ ppm 239.6 (br s).

### Example 6: Synthesis of P6

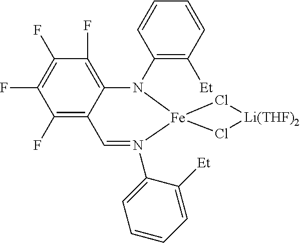

N-BuLi (2.5 M in hexane) (2 mL, 5 mmol) is stirred to a solution of (E)-N-(2-ethylphenyl)-2-(((2-ethylphenyl)imino)methyl)-3,4,5,6-tetrafluoroaniline (2 g, 5 mmol) in THF (10 mL) at −78° C. The cooling bath is removed 30 minutes after the addition. The solution is stirred for 4 hours at 25° C. Then, FeCl₂ (0.63 g, 5 mmol) is added. The solution is stirred overnight and then the solvent is evaporated under reduced pressure. The residual solid is washed with hexane or pentane (10 mL) and extracted with Et2O (25 mL). The ethereal solution is filtered and then concentrated and replaced with hexane (20 mL). After adding a few drops of THF and cooling to −20° C., red crystals of the P6 product (1.1 g, 1.6 mmol, 35%) are obtained. Elemental analysis calculated for C₂₃H₁₉Cl₂F₄FeLiN₂(C4H80)₂: C, 54.97H, 5.21; N, 4.14, found: C, 51.13; H 4.90; N 4.40. 1H NMR (250 MHz, C₆D₆-50 L THF-d8, 25° C.) δ ppm 34.58 (br s, 1H, H Ar), 26.05 (s, 1H, H Ar), 23.66 (s, 1H, H Ar), 14.94 (s, 2H, H Ar), 12.90 (s, 1H, H Ar), 4.94 (br s, 10H, THF), 1.91 (br s, 10H, THF), −7.84 (br s, 4H, CH2), −10.46 (br s, 6H, CH3), −37.60 (s, 1H, H Ar), −71.64 (s, 1H, H Ar), −87.68 (br s, 1H, ArCHN).

### Example 7: Synthesis of P7

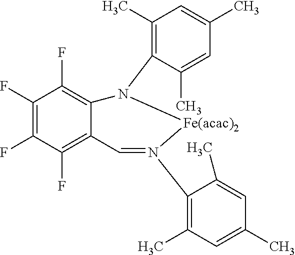

N-BuLi (2.5 M in hexane) (2.8 mL, 7 mmol) is stirred to a solution of (E)-2,3,4,5-tetrafluoro-N-mesityl-6-((mesitylimino)methyl)aniline (3 g, 7 mmol) in THF (15 mL) at −78° C. The cooling bath is removed 30 minutes after the addition. The solution is stirred for 4 hours at 25° C. and concentrated under reduced pressure to give (E)-2,3,4,5-tetrafluoro-N-mesityl-6-((mesitylimino)methyl)aniline lithium amide. To a solution of Fe(acac)₃ (2.1 g, 6 mmol) in THF (12 ml) is added under stirring the lithium amide of (E)-2,3,4,5-tetrafluoro-N-mesityl-6-((mesitylimino)methyl)aniline (2.6 g, 6 mmol) in THF (6 ml) at 25° C., then the solution is stirred for 16 hours at the same temperature. The red solution becomes dark green. After cooling to −20° C., filtration on celite is carried out as well as evaporation, the solid is washed with cold pentane to give a dark green powder of the P7 product (2 g, 2.9 mmol, 50%). Elemental analysis calculated for C35H37F4FeN2O4: C, 61.68H, 5.47; N, 4.11, found: C, 59.9; H 5.39; N 3.92. ¹H NMR (250 MHz, C₆D₆-50 μL THF-d8 25° C.) 62.91 (br s, 3H, p-Me), 50.93 (br s, 3H, p-Me), 28.92 (br s, 14H, o-Me and m-H Ar), 20.99 (br s, 14H, Me and m-H Ar), −25.10 (br s, 2H, CH) (deviations in integration values may be observed due to signal width)

### Example 8: Synthesis of P8

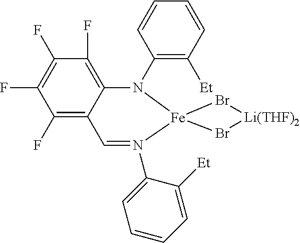

n-BuLi (2.5 M in hexane) (0.8 mL, 2.0 mmol) is stirred to a solution of (E)-N-(2-ethylphenyl)-2-(((2-ethylphenyl)imino)methyl)-3,4,5,6-tetrafluoroaniline (0.77 g, 1.8 mmol) in THF (3.6 mL) at −78° C. The cooling bath is removed 30 minutes after the addition. The solution is stirred for 4 hours at 25° C. Then, FeBr₂ (0.389 g, 1.8 mmol) is added. The solution is stirred overnight and then the solvent is evaporated under reduced pressure. The residual solid is washed with hexane or pentane and then extracted with Et2O. The ethereal solution is filtered and then concentrated and replaced with hexane. After adding a few drops of THF and cooling to −20° C., red crystals of the P8 product (0.63 g, 0.8 mmol, 44%) are obtained. ¹H NMR (250 MHz, C₆D₆-50 μL THF-d8, 25° C.) δ ppm 71.09 (s, 3H, p-Me), 33.98 (s, 3H, p-Me), 27.42 (br s, 8H, m-H Ar and o-Me), 15.91 (s, 2H, m-H Ar), 4.43 (br s, 14H, THF), 2.13 (br s, 6H, o-Me), 1.75 (br s, 14H, THF). ⁷Li NMR (117 MHz, C6D6-50 μL THF-d8, 25° C.) δ ppm 162.66 (br s).

### Example 9: Byers Synthesis of phenylcycloheptane (Reference Example)

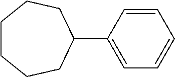 [SMILES: c1ccc(C2CCCCCC2)cc1]

The reaction is carried out in an inert atmosphere in a glove box. A solution of phenylboronic acid pinacolic ester (2 eq) in benzene (c=0.5 M) is added to EtNMeLi (1.2 eq) and the Byers catalyst (Angew. Chem., Int. Ed. 2020, 59, 5392) (10 mol %).

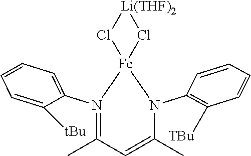

A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 5 hours and then a saturated aqueous solution of NH₄Cl is added. After extraction with EtOAc, the combined organic phases are dried on MgSO₄, filtered and evaporated under reduced pressure. Gas chromatography analysis using dodecane as an internal standard yields phenylcycloheptane with 94% yield.

### Example 10: Synthesis A of phenylcycloheptan

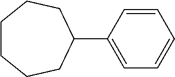 [SMILES: c1ccc(C2CCCCCC2)cc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 4 hours and then a saturated aqueous solution of NH4Cl is added. After extraction with EtOAc, the combined organic phases are dried on MgSO₄, filtered and evaporated under reduced pressure. Gas chromatography analysis using dodecane as an internal standard yields phenylcycloheptane with >99% yield. A chromatography on a silica gel column was performed and gave phenylcycloheptane with 95% yield. ¹H NMR (400 MHz, CDCl₃, 25° C.) (mixed with dodecane) δ ppm 7.30-7.14 (m, 5H), 2.70-2.65 (m, 1H), 1.95-1.92 (m, 2H), 1.83-1.60 (m, 10H). ¹³C NMR (100 MHz, CDCl₃, 25° C.) (mixture with dodecane) δ 150.0, 128.3, 126.7, 125.5, 47.0, 36.8, 28.0, 27.2.

The yield is higher than that obtained with the Byers catalyst and the reaction is faster.

### Example 11: Synthesis B of phenylcycloheptan

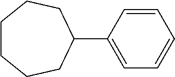 [SMILES: c1ccc(C2CCCCCC2)cc1]

The reaction is carried out in an inert atmosphere in a glove box. A solution of phenylboronic acid pinacolic ester (2 eq) in benzene (c=0.5 M) is added to the P6 catalyst (10 mol %) and EtNMeLi (1.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 24 hours (non-optimized time) and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields phenylcycloheptane with >99% yield.

### Example 12: Synthesis C of prenylcycloheptane

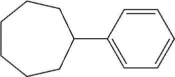 [SMILES: c1ccc(C2CCCCCC2)cc1]

The reaction is carried out in an inert atmosphere in a glove box. The P7 catalyst was previously exposed to ambient air for 2 weeks. A solution of phenylboronic acid pinacolic ester (2 eq) in benzene (c=0.5 M) is added to the catalyst P7 (10 mol %) and EtNMeLi (2.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 24 hours (non-optimized reaction time) and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields phenylcycloheptane with 89% yield.

### Example 13: Synthesis D of prenylcycloheptane

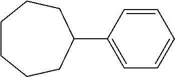 [SMILES: c1ccc(C2CCCCCC2)cc1]

The reaction is carried out in an inert atmosphere outside the glove box. The P7 catalyst was previously exposed to ambient air for 2 weeks. A solution of phenylboronic acid pinacolic ester (2 eq) in benzene (c=0.5 M) is added to the catalyst P7 (10 mol %) and EtNMeLi (2.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 24 hours and then a saturated aqueous solution of NH4Cl is added. After extraction with EtOAc, the combined organic phases are dried on MgSO₄, filtered and evaporated under reduced pressure. An analysis by ¹H NMR using 1,3,5-trimethoxybenzene as the internal standard yields phenylcycloheptane with 87% yield.

This example shows that the catalyst is not sensitive to ambient air because it retains good catalytic activities even after being exposed to it for two weeks.

### Example 14: Synthesis E of phenylcycloheptane

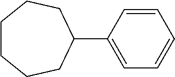 [SMILES: c1ccc(C2CCCCCC2)cc1]

The reaction is carried out in an inert atmosphere in a glove box. A solution of phenylboronic acid pinacolic ester (2 eq) in benzene (c=0.5 M) is added to the P8 catalyst (10 mol %) and EtNMeLi (1.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C., 5 hours and then a saturated aqueous solution of NH₄Cl is added. After extraction with EtOAc, the combined organic phases are dried on MgSO₄, filtered and evaporated under reduced pressure. Gas chromatography analysis using dodecane as the internal standard yields phenylcycloheptane with >99% yield.

The yield is higher than that obtained with the Byers catalyst and the reaction is faster.

### Example 15: Synthesis A of Octylbenzene

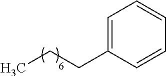

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. A chromatography on a silica gel column was performed and gave octylbenzene with a yield of 71%. ¹H NMR (400 MHz, CDCl₃, 25° C.) δ ppm 7.29 (t, J=7.4 Hz, 2H), 7.20 (d, J=7.4 Hz, 3H), 2.63 (t, J=7.8 Hz, 2H), 1.66-1.60 (m, 2H), 1.33-1.30 (m, 10H), 0.91 (t, J=6.5 Hz, 3H). ¹³C NMR (100 MHz, CDCl₃, 25° C.) δ ppm 143.0, 128.4, 128.2, 125.5, 36.0, 31.9, 31.5, 29.5, 29.4, 29.3, 22.7, 14.1.

### Example 16: Synthesis B of Octylbenzene

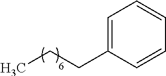

The reaction is carried out in an inert atmosphere in a glove box. A solution of phenylboronic acid pinacolic ester (2 eq) in benzene (c=0.5 M) is added to the catalyst P7 (10 mol %) and EtNMeLi (2.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 29 hours and then a saturated aqueous solution of NH₄Cl is added. After extraction with EtOAc, the combined organic phases are dried on MgSO₄, filtered and evaporated under reduced pressure. A chromatography on a silica gel column was performed and gave octylbenzene with 91% yield. ¹H NMR (400 MHz, CDCl₃, 25° C.) δ ppm 7.29 (t, J=7.4 Hz, 2H), 7.20 (d, J=7.4 Hz, 3H), 2.63 (t, J=7.8 Hz, 2H), 1.66-1.60 (m, 2H), 1.33-1.30 (m, 10H), 0.91 (t, J=6.5 Hz, 3H). ^{13C NMR (100 MHz, CDCl3}, 25° C.) δ ppm 143.0, 128.4, 128.2, 125.5, 36.0, 31.9, 31.5, 29.5, 29.4, 29.3, 22.7, 14.1.

### Example 17: Synthesis of 1-methyl-4-octylbenzene

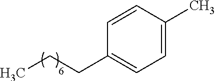

The reaction is carried out in an inert atmosphere in a glove box. A solution of 4-tolylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH4Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1-methyl-4-octylbenzene with 82% yield. A silica gel column chromatography is performed and gives 1-methyl-4-octylbenzene with 76% yield 0.1H NMR (360 MHz, CDCl3, 25° C.) δ ppm 7.15-7.10 (m, 4H), 2.61 (t, J=7.6 Hz, 2H), 2.37 (s, 3H), 1.66-1.60 (m, 2H), 1.35-1.32 (m, 10H), 0.93 (t, J=6.8 Hz, 3H). ¹³C NMR (100 MHz, CDCl₃, 25° C.) δ ppm 139.9, 134.9, 128.9, 128.3, 35.5, 31.9, 31.7, 29.5, 29.4, 29.3, 22.7, 21.0, 14.1.

### Example 18: Synthesis of 1-methoxy-4-octylbenzene

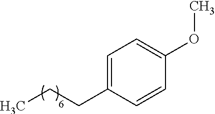

The reaction is carried out in an inert atmosphere in a glove box. A solution of 4-methoxyphenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 or 48 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1-methoxy-4-octylbenzene with 78% yield (after 24 h) and 99% yield (after 48 h). A chromatography on a silica gel column was performed and gave 1-methoxy-4-octylbenzene with a yield of 76% (after 24 h). ¹H NMR (360 MHz, CDCl₃, 25° C.) δ ppm 7.12 (d, J=8.7 Hz, 2H), 6.85 (d, J=8.7 Hz, 2H), 3.81 (s, 3H), 2.57 (t, J=7.6 Hz, 2H), 1.64-1.56 (m, 2H), 1.33-1.30 (m, 10H), 0.91 (t, J=6.8 Hz, 3H). ¹³C NMR (360 MHz, CDCl₃, 25° C.) δ ppm 157.6, 135.0, 129.2, 113.6, 55.2, 35.0, 31.9, 31.8, 29.5, 29.3, 22.7, 14.1. MS-HR (ESI) m/z calculated for C15H25O [M+H]⁺, 221.1900, found: 221.1756.

### Example 19: Synthesis of 1-phenoxy-4-octylbenzene

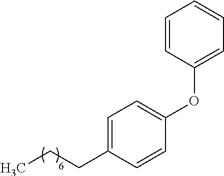

The reaction is carried out in an inert atmosphere in a glove box. A solution of 4-phenoxyphenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 48 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1-phenoxy-4-octylbenzene with >96% yield.

### Example 20: Synthesis of N,N-dimethyl-4-octylaniline

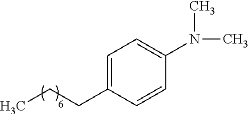

The reaction is carried out in an inert atmosphere in a glove box. A solution of 4-(dimethylamino)phenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH4Cl is added. After extraction with EtOAc, the combined organic phases are dried on MgSO4, filtered and evaporated under reduced pressure. A silica gel column chromatography was performed and gave N,N-dimethyl-4-octylaniline with 90% yield. ¹H NMR (360 MHz, CDCl₃, 25° C.) δ ppm 7.12 (d, J=8.7 Hz, 2H), 6.75 (d, J=8.7 Hz, 2H), 3.96 (s, 6H), 2.57 (t, J=7.6 Hz, 2H), 1.63 (qt, J=7.3 Hz, 2H), 1.36-1.33 (m, 10H), 0.94 (t, J=6.8 Hz, 3H). ¹³C NMR (90 MHz, CDCl₃, 25° C.) δ ppm 148.9, 131.23, 128.90, 113.0, 40.9, 34.9, 31.9, 29.5, 29.3, 22.7, 14.1. MS-HR (ESI) m/z calculated for C16H28N [M+H]⁺ 234.2216, found: 234.2213.

### Example 21: Synthesis of 1-chloro-4-octylbenzene

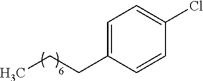

The reaction is carried out in an inert atmosphere in a glove box. A solution of 4-chlorophenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 80° C. for 48 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1-chloro-4-octylbenzene with 40% yield.

### Example 22: Synthesis of 1-nitro-4-octylbenzene

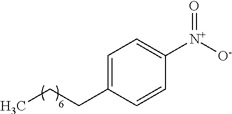

The reaction is carried out in an inert atmosphere in a glove box. A solution of 4-nitrophenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 80° C. for 48 hours and then a saturated aqueous solution of NH₄Cl is added. After extraction with EtOAc, the combined organic phases are dried on MgSO₄, filtered and evaporated under reduced pressure. An analysis by 1H NMR using 1,3,5-trimethoxybenzene as the internal standard yields 1-nitro-4-octylbenzene with 36% yield.

### Example 23: Synthesis of 1-fluoro-4-octylbenzene

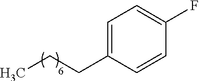

The reaction is carried out in an inert atmosphere in a glove box. A solution of 4-fluorophenylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH₄Cl is added. After extraction with EtOAc, the combined organic phases are dried on MgSO4, filtered and evaporated under reduced pressure. A silica gel column chromatography was performed and gave 1-fluoro-4-octylbenzene with 88% yield. ¹H NMR (360 MHz, CDCl₃, 25° C.) δ ppm 7.16-7.11 (m, 2H), 7.01-6.94 (m, 2H), 2.59 (t, J=7.6 Hz, 2H), 1.61 (who, J=7.4 Hz, 2H), 1.33-1.30 (m, 10H), 0.91 (t, J=6.7 Hz, 3H). ¹³C NMR (90 MHz, CDCl₃, 25° C.) δ ppm 161.1 (d, J=242.8 Hz), 138.5 (d, J=3.2 Hz), 129.6 (d, J=7.8 Hz), 114.9 (d, J=20.8 Hz), 35.1, 31.9, 31.7, 29.5, 29.3, 29.2, 22.7, 14.1.

### Example 24: Synthesis of 1-octyl-3-(trifluoromethyl)benzene

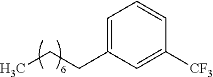

The reaction is carried out in an inert atmosphere in a glove box. A pinacolic ester solution of 3-trifluoromethylphenylboronic acid (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. A silica gel column chromatography was performed and yielded 1-octyl-3-(trifluoromethyl)benzene with 83% yield. ¹H NMR (360 MHz, CDCl₃, 25° C.) δ ppm 7.46-7.34 (m, 4H), 2.67 (t, J=7.6 Hz, 2H), 1.64 (qt, J=7.4 Hz, 2H), 1.34-1.29 (m, 10H), 0.90 (t, J=6.7 Hz, 3H). ¹³C NMR (90 MHz, CDCl₃, 25° C.) δ ppm 143.8, 131.8, 130.5 (q, J=31.8 Hz), 128.9, 125.0 (q, J=3.7 Hz), 124.3 (q, J=271.8 Hz), 122.5 (q, J=3.7 Hz), 35.8, 31.9, 31.3, 29.4, 29.2, 22.7, 14.1.

### Example 25: Synthesis of benzyl 4-phenylpiperidine-1-carboxylate

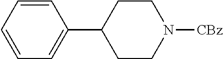

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of benzyl 4-bromopiperidine-1-carboxylate (1 eq) in benzene (c=0.25 M) is added to the solution which is then supplemented by the addition of benzene to obtain a total benzyl 4-bromopiperidine-1-carboxylate concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. A silica gel column chromatography was performed and yielded benzyl 4-phenylpiperidine-1-carboxylate with 95% yield. ¹H NMR (360 MHz, CDCl₃, 25° C.) δ ppm 7.45-7.35 (m, 7H), 7.29-7.25 (m, 3H), 5.24 (s, 2H), 4.40 (s, 2H), 2.94 (s, 2H), 2.76-2.70 (m, 1H), 1.88 (m, 2H), 1.72-1.70 (m, 2H). ¹³C NMR (90 MHz, CDCl₃, 25° C.) δ ppm 155.2, 145.4, 136.8, 128.4, 127.8, 126.6, 126.3, 67.0, 44.5, 42.5, 33.0. MS-HR (ESI) m/z calculated for C19H22NO2 [M+H]⁺ 296.1645, found: 296.1638.

### Example 26: Synthesis A of 1-phenyladamantane

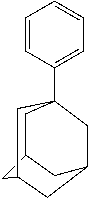 [SMILES: c1ccc(C23CC4CC(CC(C4)C2)C3)cc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of 1-bromoadamantane (1 eq) in benzene (c=0.25 M) is added to the solution, which is then supplemented by the addition of benzene to obtain a total concentration of 1-chloroadamantane of 0.08 M. The reaction mixture is stirred at 80° C. for 48 hours and then a saturated aqueous solution of NH₄Cl is added. After extraction with EtOAc, the combined organic phases are dried on MgSO4, filtered and evaporated under reduced pressure. A chromatography on a silica gel column was performed and gave 1-phenyladamantane with 98% yield. ¹H NMR (360 MHz, CDCl₃, 25° C.) δ ppm 7.41-7.32 (m, 4H), 7.23-7.18 (m, 1H), 2.13 (m, 3H), 1.96-1.95 (m, 6H), 1.85-1.75 (m, 6H). ¹³C NMR (90 MHz, CDCl₃, 25° C.) δ ppm 151.3, 128.1, 125.5, 124.8, 43.1, 36.8, 28.9.

### Example 27: Synthesis B of 1-phenyladamantane

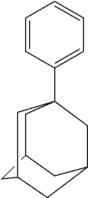 [SMILES: c1ccc(C23CC4CC(CC(C4)C2)C3)cc1]

The reaction is carried out in an inert atmosphere in a glove box. A solution of phenylboronic acid pinacolic ester (2 eq) in benzene (c=0.5 M) is added to the catalyst P7 (10 mol %) and EtNMeLi (2.2 eq). A solution of 1-bromoadamantane (1 eq) in benzene (c=0.25 M) is added to the solution, which is then supplemented by the addition of benzene to obtain a total concentration of 1-chloroadamantane of 0.08 M. The reaction mixture is stirred at 80° C. for 48 hours and then a saturated aqueous solution of NH₄Cl is added. After extraction with EtOAc, the combined organic phases are dried on MgSO₄, filtered and evaporated under reduced pressure. A silica gel column chromatography was performed and gave 1-phenyladamantane with a 79% yield. ¹H NMR (360 MHz, CDCl₃, 25° C.) δ ppm 7.41-7.32 (m, 4H), 7.23-7.18 (m, 1H), 2.13 (m, 3H), 1.96-1.95 (m, 6H), 1.85-1.75 (m, 6H). ¹³C NMR (90 MHz, CDCl₃, 25° C.) δ ppm 151.3, 128.1, 125.5, 124.8, 43.1, 36.8, 28.9.

### Example 28: Synthesis of 2-octylthiophene

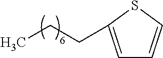

The reaction is carried out in an inert atmosphere in a glove box. A solution of pinacolic ester of 2-thienylboronic acid (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 2-octylthiophene with 78% yield.

### Example 29: Synthesis of 6-cycloheptylquinoline

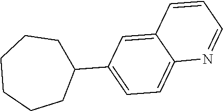 [SMILES: c1cnc2ccc(C3CCCCCC3)cc2c1]

The reaction is carried out in an inert atmosphere in a glove box. A solution of 6-quinolineboronic acid pinacolic ester (2 eq) in benzene (c=0.5 M) is added to the P5 catalyst (10 mol %) and EtNMeLi (1.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 80° C. for 48 hours and then a saturated aqueous solution of NH4Cl is added. After extraction with EtOAc, the combined organic phases are dried on MgSO₄, filtered and evaporated under reduced pressure. A silica gel column chromatography was performed and yielded 6-cycloheptylquinoline with 88% yield. ¹H NMR (400 MHz, CDCl₃, 25° C.) δ ppm 8.88 (d, J=4.2 Hz, 1H), 8.07 (d, J=8.4 Hz, 1H), 8.02 (d, J=8.6 Hz, 1H), 7.60-7.56 (m, 2H), 7.34 (dd, J=4.2 Hz, J=8.3 Hz, 1H), 2.85 (st, 1H), 2.02-1.95 (m, 2H), 1.87-1.80 (m, 2H), 1.78-1.69 (m, 4H), 1.66-1.55 (m, 4H). ¹³C NMR (100 MHz, CDCl₃, 25° C.) δ ppm 149.5, 148.1, 147.1, 135.6, 129.7, 129.3, 128.3, 124.0, 120.9, 46.8, 36.6, 27.9, 27.2. MS-HR (ESI) m/z calculated for C₁₆H₂ON [M+H]⁺ 226.1590, found: 226.1583.

### Example 30: Synthesis of 1′-methylenedibenzene

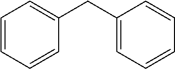 [SMILES: c1ccc(Cc2ccccc2)cc1]

The reaction is carried out in an inert atmosphere in a glove box. A solution of phenylboronic acid pinacolic ester (2 eq) in benzene (c=0.5 M) is added to the P6 catalyst (10 mol %) and EtNMeLi (1.2 eq). A benzyl bromide solution (1 eq) in benzene (c=0.25 M) is added to the solution, which is then supplemented by the addition of benzene to obtain a total benzyl bromide concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1,1′-methylenedibenzene with 30% yield.

### Example 31: Synthesis of 2-octylnaphthalene

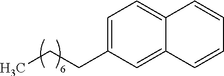

The reaction is carried out in an inert atmosphere in a glove box. A solution of napthylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 48 hours and then a saturated aqueous solution of NH₄Cl is added. After extraction with EtOAc, the combined organic phases are dried on MgSO₄, filtered and evaporated under reduced pressure. A silica gel column chromatography was performed and yielded 2-octylnaphthalene with 93% yield. ¹H NMR (400 MHz, CDCl₃, 25° C.) δ ppm 7.92-7.86 (m, 3H), 7.72 (s, 1H), 7.53 (quintet, J=15.1 Hz, 6.8 Hz, 2H), 7.44 (d, J=8.3 Hz, 1H), 2.88 (t, J=7.7 Hz, 2H), 1.86-1.79 (m, 2H), 1.47-1.41 (m, 10H), 1.03 (t, J=7.0 Hz, 3H). ₁₃C NMR (100 MHz, CDCl₃, 25° C.) δ ppm 140.4, 133.7, 132.0, 127.7, 127.6, 127.4, 127.4, 126.3, 125.8, 124.9, 36.1, 31.9, 31.4, 29.5, 29.4, 29.3, 22.7, 14.1.

### Example 32: Synthesis of Hexylbenzene

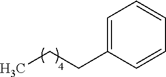

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of 1-bromohexane (1 eq) in benzene (c=0.25 M) is added to the solution which is then supplemented by the addition of benzene to obtain a total concentration of 1-bromohexane of 0.08 M. The reaction mixture is stirred at 25° C. for 24 hours and then a saturated aqueous solution of NH4C1 is added. After extraction with EtOAc, the combined organic phases are dried on MgSO4, filtered and evaporated under reduced pressure. A chromatography on a silica gel column was performed and gave hexylbenzene with 90% yield. ¹H NMR (360 MHz, CDCl₃, 25° C.) δ ppm 7.22-7.17 (m, 2H), 7.11-7.07 (m, 3H), 2.53 (t, J=7.6 Hz, 2H), 1.58-1.49 (m, 2H), 1.28-1.20 (m, 6H), 0.81 (t, J=6.8 Hz, 3H). ¹³C NMR (90 MHz, CDCl₃, 25° C.) δ ppm 143.0, 128.4, 128.2, 125.5, 36.0, 31.7, 31.5, 29.0, 22.6, 14.1.

### Example 33: Synthesis A of Cyclopropylbenzene

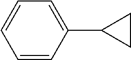

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of bromocyclopropane (1 eq) in benzene (c=0.25 M) is added to the solution, which is then supplemented by the addition of benzene to obtain a total bromocyclopropane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields cyclopropylbenzene with 45% yield.

### Example 34: Synthesis B of Cyclopropylbenzene

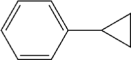

The reaction is carried out in an inert atmosphere in a glove box. A solution of phenylboronic acid pinacolic ester (2 eq) in benzene (c=0.5 M) is added to the P6 catalyst (10 mol %) and EtNMeLi (1.2 eq). A solution of bromocyclopropane (1 eq) in benzene (c=0.25 M) is added to the solution, which is then supplemented by the addition of benzene to obtain a total bromocyclopropane concentration of 0.08 M. The reaction mixture is stirred at 25° C. for 24 hours and then a saturated aqueous solution of NH4Cl is added. After extraction with EtOAc, the combined organic phases are dried on MgSO4, filtered and evaporated under reduced pressure. An analysis by ¹H NMR using 1,3,5-trimethoxybenzene as the internal standard yields cyclopropylbenzene with 26% yield.

### Example 35: Synthesis of 3-phenyloxetane

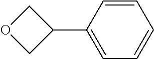

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of 3-bromooxetane (1 eq) in benzene (c=0.25 M) is added to the solution, which is then supplemented by the addition of benzene to obtain a total 3-bromooxetane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 3-phenyloxetane with 69% yield. A chromatography on a silica gel column was performed and gave 3-phenyloxetane with 58% yield. ¹H NMR (360 MHz, CDCl₃, 25° C.) δ ppm 7.44-7.30 (m, 5H), 5.11 (dd, J=8.4 Hz, J=6.0 Hz, 2H), 4.82 (t, J=6.4 Hz, 2H), 4.30-4.23 (m, 1H). ¹³C NMR (90 MHz, CDCl₃, 25° C.) δ ppm 141.5, 128.8, 127.0, 126.8, 78.9, 40.4.

### Example 36: Synthesis A of tert-butylbenzene

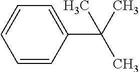

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of tert-butyl chloride (1 eq) in benzene (c=0.25 M) is added to the solution, which is then supplemented by the addition of benzene to obtain a total tert-butyl chloride concentration of 0.08 M. The reaction mixture is stirred at 25° C. for 24 hours and then a saturated aqueous solution of NH4Cl is added. After extraction with EtOAc, the combined organic phases are dried on MgSO₄, filtered and evaporated under reduced pressure. An analysis by ¹H NMR using 1,3,5-trimethoxybenzene as the internal standard gives tert-butylbenzene with 54% yield.

### Example 37: Synthesis B of tert-butylbenzene

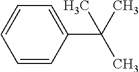

The reaction is carried out in an inert atmosphere in a glove box. A solution of phenylboronic acid pinacolic ester (2 eq) in benzene (c=0.5 M) is added to the P6 catalyst (10 mol %) and EtNMeLi (1.2 eq). A solution of tert-butyl chloride (1 eq) in benzene (c=0.25 M) is added to the solution, which is then supplemented by the addition of benzene to obtain a total tert-butyl chloride concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields tert-butylbenzene with 32% yield.

### Example 38: Synthesis of 2-cycloheptylthiophene

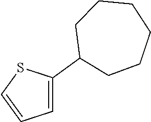 [SMILES: c1csc(C2CCCCCC2)c1]

The reaction is carried out in an inert atmosphere in a glove box. A solution of 2-thienylboronic acid pinacolic ester (2 eq) in benzene (c=0.5 M) is added to the P5 catalyst (10 mol %) and EtNMeLi (1.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 48 hours and then a saturated aqueous solution of NH₄Cl is added. After extraction with EtOAc, the combined organic phases are dried on MgSO4, filtered and evaporated under reduced pressure. An analysis by ¹H NMR using 1,3,5-trimethoxybenzene as the internal standard yields 2-cycloheptylthiophene with 86% yield. A silica gel column chromatography is performed and gives 2-cycloheptylthiophene with 78% yield. 1H NMR (250 MHz, CDCl₃, 25° C.) δ ppm 7.10 (dd, J=5.0 Hz, 1.0 Hz, 1H), 6.91 (dd, J=5.0 Hz, 3.5 Hz, 1H), 6.80 (d, J=3.1 Hz, 1H), 3.04 (septet, J=4.1 Hz, 1H), 2.11-2.05 (m, 2H), 1.79-1.55 (m, 10H). ¹³C NMR (63 MHz, CDCl₃, 25° C.) δ ppm 153.6, 126.3, 122.0, 121.7, 41.6, 37.5, 28.1, 26.3.

### Example 39: Synthesis of tert-butyl 4-(5-cycloheptylpyridin-2-yl)piperazine-1-carboxylate

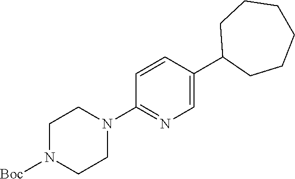 [SMILES: CC(C)(C)OC(=O)N1CCN(c2ccc(C3CCCCCC3)cn2)CC1]

The reaction is carried out in an inert atmosphere in a glove box. A solution of 1-tert-butyl-4-(pyridin-2-yl)piperazineboronic acid pinacolic ester (2 eq) in benzene (c=0.5 M) is added to the P5 catalyst (10 mol %) and EtNMeLi (1.2 eq). A solution of bromocycloheptane (1 eq) in benzene (c=0.25 M) is added to the solution, which is then supplemented by the addition of benzene to obtain a total chlorocycloheptane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. A silica gel column chromatography is performed and gives tert-butyl 4-(5-cycloheptylpyridin-2-yl)piperazine-1-carboxylate with 92% yield. ¹H NMR (360 MHz, CDCl₃, 25° C.) δ ppm 7.96 (d, J=2.3 Hz, 1H), 7.28 (dd, J=2.4 Hz, 8.7 Hz, 1H), 6.53 (d, J=8.7 Hz, 1H), 3.48-3.45 (m, 4H), 3.40-3.37 (m, 4H), 2.54-2.46 (m, 1H), 1.81-1.48 (m, 12H), 1.41 (s, 9H). ¹³C NMR (90 MHz, CDCl₃, 25° C.) δ ppm 157.8, 154.8, 145.9, 136.1, 134.9, 107.3, 79.8, 45.5, 43.4, 36.7, 28.4, 27.8, 26.9. MS-HR (ESI) m/z calculated for C21H34N3O2 [M+H]⁺ 360.2646, found: 360.2629.

### Example 40: Synthesis of tert-butyldimethyl(3-phenylpropoxy)silane

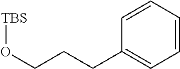

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of (4-bromobutoxy)(tert-butyl)dimethylsilane (1 eq) in benzene (c=0.25 M) is added to the solution which is then supplemented by the addition of benzene to obtain a total concentration of (4-bromobutoxy)(tert-butyl)dimethylsilane of 0.08 M. The reaction mixture is stirred at 25° C. for 24 hours and then a saturated aqueous solution of NH4C1 is added. After extraction with EtOAc, the combined organic phases are dried on MgSO4, filtered and evaporated under reduced pressure. A silica gel column chromatography was performed and gave tert-butyldimethyl(3-phenylpropoxy)silane with 78% yield. ¹H NMR (360 MHz, CDCl₃, 25° C.) δ ppm 7.33-7.29 (m, 2H), 7.24-7.19 (m, 3H), 3.67 (t, J=6.3 Hz, 2H), 2.72 (t, J=7.8 Hz, 2H), 1.92-1.84 (m, 2H), 0.95 (s, 9H), 0.09 (s, 6H). ¹³C NMR (90 MHz, CDCl3, 25° C.) δ ppm 142.3, 128.5, 128.31, 125.7, 62.4, 34.5, 32.2, 26.0, 18.4, −5.2.

### Example 41: Synthesis A of Cyclopentylbenzene

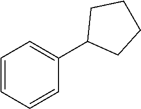 [SMILES: c1ccc(C2CCCC2)cc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of bromocyclopentane (1 eq) in benzene (c=0.25 M) is added to the solution which is then supplemented by the addition of benzene to obtain a total bromocyclopentane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields cyclopentylbenzene with 99% yield. A chromatography on a silica gel column was performed and gave cyclopentylbenzene with 70% yield. ¹H NMR (360 MHz, CDCl₃, 25° C.) δ ppm 7.21-7.14 (m, 4H), 7.09-7.05 (m, 1H), 2.94-2.85 (m, 1H), 2.01-1.94 (m, 2H), 1.77-1.66 (m, 2H), 1.64-1.45 (m, 4H). ¹³C NMR (90 MHz, CDCl₃, 25° C.) δ ppm 146.5, 128.2, 127.1, 125.6, 45.9, 34.6, 25.5.

### Example 42: Synthesis B of Cyclopentylbenzene

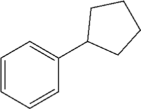 [SMILES: c1ccc(C2CCCC2)cc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of chlorocyclopentane (1 eq) in benzene (c=0.25 M) is added to the solution, which is then supplemented by the addition of benzene to obtain a total bromocyclopentane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields cyclopentylbenzene with 99% yield. 1H NMR (360 MHz, CDCl₃, 25° C.) δ ppm 7.21-7.14 (m, 4H), 7.09-7.05 (m, 1H), 2.94-2.85 (m, 1H), 2.01-1.94 (m, 2H), 1.77-1.66 (m, 2H), 1.64-1.45 (m, 4H). ¹³C NMR (90 MHz, CDCl3, 25° C.) δ ppm 146.5, 128.2, 127.1, 125.6, 45.9, 34.6, 25.5.

### Example 43: Synthesis C of Cyclopentylbenzene

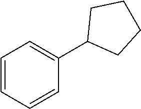 [SMILES: c1ccc(C2CCCC2)cc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of iodocyclopentane (1 eq) in benzene (c=0.25 M) is added to the solution which is then supplemented by the addition of benzene to obtain a total iodocyclopentane concentration of 0.08 M. The reaction mixture is stirred at 25° C. for 24 hours and then a saturated aqueous solution of NH₄Cl is added. After extraction with EtOAc, the combined organic phases are dried on MgSO4, filtered and evaporated under reduced pressure. An analysis by ¹H NMR using 1,3,5-trimethoxybenzene as an internal standard yields cyclopentylbenzene with 77% yield. A chromatography on a silica gel column was performed and gave cyclopentylbenzene with a 77% yield.

P5 can catalyze carbon-carbon bond formation with previously defined bromined, chlorinated or iodinated Z-Hal halogenated derivatives.

### Example 44: Synthesis of tert-butyl 3-phenylazetidine-1-carboxylate

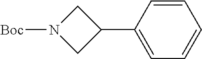 [SMILES: CC(C)(C)OC(=O)N1CC(c2ccccc2)C1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of tert-butyl 3-bromoazetidine-1-carboxylate (1 eq) in benzene (c=0.25 M) is added to the solution which is then supplemented by the addition of benzene to obtain a total tert-butyl 3-bromoazetidine-1-carboxylate concentration of 0.08 M. The reaction mixture is stirred at 25° C. for 48 hours and then a saturated aqueous solution of NH₄Cl is added. After extraction with EtOAc, the combined organic phases are dried on MgSO₄, filtered and evaporated under reduced pressure. An analysis by 1H NMR using 1,3,5-trimethoxybenzene as the internal standard yields tert-butyl 3-phenylazetidine-1-carboxylate with >99% yield. A silica gel column chromatography is performed and gives tert-butyl 3-phenylazetidine-1-carboxylate with 83% yield. ¹H NMR (360 MHz, CDCl3, 25° C.) δ ppm 7.30-7.15 (m, 5H), 4.25 (t, J=8.7 Hz, 2H), 3.90 (dd, J=8.6 Hz, J=6.1 Hz, 2H), 3.69-3.61 (m, 1H), 1.39 (s, 9H). ¹³C NMR (90 MHz, CDCl₃, 25° C.) δ ppm 156.4, 142.2, 128.7, 126.9, 126.7, 79.5, 33.5, 28.4. MS-HR (ESI) m/z calculated for C14H20NO2 [M+H]⁺ 234.1489, found: 234.1482.

### Example 45: Synthesis of 2-octyl-1-tosyl-1H-indole

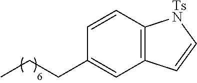

The reaction is carried out in an inert atmosphere in a glove box. A solution of boronic acid (1-tosyl-1H-indol-2-yl) pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 48 hours and then a saturated aqueous solution of NH₄Cl is added. After extraction with EtOAc, the combined organic phases are dried on MgSO₄, filtered and evaporated under reduced pressure. A silica gel column chromatography is performed and gives 2-octyl-1-tosyl-1H-indole with 69% yield. ¹H NMR (360 MHz, CDCl₃, 25° C.) δ ppm 7.90 (d, J=8.5 Hz, 1H), 7.77 (d, J=8.4 Hz, 2H), 7.53 (d, J=3.7 Hz, 1H), 7.32 (d, J=1.0 Hz, 1H), 7.20 (d, J=8.1 Hz, 2H), 7.14 (dd, J=8.5 Hz, 1.6 Hz, 1H), 6.60 (dd, J=3.6 Hz, 0.4 Hz, 1H), 2.66 (t, J=7.6 Hz, 2H), 2.32 (s, 3H), 1.62 (quint, J=7.2 Hz, 2H), 1.31-1.27 (m, 10H), 0.89 (t, J=7.0 Hz, 3H). ¹³C NMR (90 MHz, CDCl₃, 25° C.) δ ppm 144.9, 138.2, 135.6, 133.4, 131.1, 129.9, 126.9, 126.5, 125.5, 120.7, 113.3, 109.0, 35.9, 32.0, 29.6, 29.5, 29.4, 22.8, 21.6, 14.2.

### Example 46: Synthesis of Tert-butyl 2-octyl-1H-indole-1-carboxylate

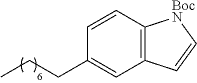

The reaction is carried out in an inert atmosphere in a glove box. A solution of boronic acid (1-(tert-butoxycarbonyl)-1H-indol-2-yl) pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 80° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields tert-butyl 2-octyl-1H-indole-1-carboxylate with 82% yield. A silica gel column chromatography is performed and gives tert-butyl 2-octyl-1H-indole-1-carboxylate with 50% yield. 1H NMR (300 MHz, CDCl₃, 25° C.) δ ppm 8.02 (d, J=8.3 Hz, 1H), 7.56 (d, J=3.6 Hz, 1H), 7.35 (d, J=1.0 Hz, 1H), 7.14 (dd, J=8.5 Hz, 1.7 Hz, 1H), 6.51 (dd, J=3.7 Hz, 0.6 Hz, 1H), 2.69 (t, J=7.5 Hz, 2H), 1.67 (s, 9H), 1.64-1.60 (m, 2H), 1.32-1.26 (m, 10H), 0.88 (t, J=6.8 Hz, 3H). ¹³C NMR (75 MHz, CDCl₃, 25° C.) δ ppm 149.9, 137.3, 133.5, 130.7, 125.9, 125.0, 120.2, 114.7, 107.1, 83.4, 35.8, 32.0, 31.9, 29.5, 29.3, 28.2, 22.7, 14.1. MS-HR (ESI) m/z calculated for C25H25F4N2 [M+H]⁺ 330.2428, found: 330.2415.

### Example 47: Synthesis of 2-octyl-1-benzofuran

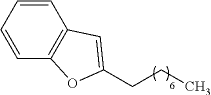

The reaction is carried out in an inert atmosphere in a glove box. A pinacolic ester solution of 2-benzofuraneboronic acid (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 80° C. for 48 hours and then a saturated aqueous solution of NH₄Cl is added. After extraction with EtOAc, the combined organic phases are dried on MgSO4, filtered and evaporated under reduced pressure. An analysis by ¹H NMR using 1,3,5-trimethoxybenzene as the internal standard yields 2-octyl-1-benzofuran with 87% yield. A chromatography on a silica gel column was performed and gave 2-octyl-1-benzofuran with 82% yield. ¹H NMR (400 MHz, CDCl₃, 25° C.) δ ppm 7.49-7.47 (m, 1H), 7.41 (d, J=7.9 Hz, 1H), 7.22-7.15 (m, 2H), 6.37 (s, 1H), 2.76 (t, J=7.6 Hz, 2H), 1.75 (who, J=7.6 Hz, 2H), 1.39-1.28 (m, 10H), 0.89 (t, J=7.1 Hz, 3H). ¹³C NMR (100 MHz, CDCl3, 25° C.) δ ppm 160.0, 154.6, 129.0, 123.0, 122.3, 120.1, 110.7, 101.7, 31.8, 29.3, 29.2, 28.5, 27.7, 22.7, 14.1

### Example 48: Synthesis of 3-octylfuran

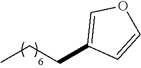

The reaction is carried out in an inert atmosphere in a glove box. A solution of 3-furaneboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 3-octylfuran with 89% yield. A chromatography on a silica gel column was performed and gave 3-octylfuran with 82% yield. ¹H NMR (300 MHz, CDCl₃, 25° C.) δ ppm 7.35 (br s, 1H), 7.21 (br s, 1H), 6.27 (br s, 1H), 2.41 (t, J=7.5 Hz, 2H), 1.58-1.53 (m, 2H), 1.31-1.29 (m, 10H), 0.90 (t, J=6.5 Hz, 3H). ¹³C NMR (75 MHz, CDCl3, 25° C.) δ ppm 142.7, 138.8, 125.5, 111.2, 32.0, 30.2, 29.6, 29.5, 29.4, 24.9, 22.8, 14.2.

### Example 49: Synthesis of (3-methylundecyl)benzene

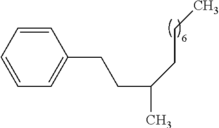

The reaction is carried out in an inert atmosphere in a glove box. A solution of 9-octyl-9-borabicyclo[3.3.1]nonane (2 eq) in benzene (c=0.5 M) is added to the catalyst P5 (20 mol %) and NMe₂Li (1.2 eq). A solution of (3-bromobutyl)benzene (1 eq) in benzene (c=0.25 M) is added to the solution which is then supplemented by the addition of benzene to obtain a total concentration of (3-bromobutyl)benzene of 0.08 M. The reaction mixture is stirred at 25° C. ° C. for 24 hours and then a saturated aqueous solution of NH₄Cl is added. After extraction with EtOAc (3×40 mL), the combined organic phases are dried on MgSO₄, filtered and evaporated under reduced pressure. A gas chromatography analysis using dodecane as the internal standard yields (3-methylundecyl)benzene with 89% yield. A chromatography on a silica gel column was performed and gave (3-methylundecyl)benzene with 60% yield. ¹H NMR (300 MHz, CDCl₃, 25° C.) δ ppm 7.34-7.29 (m, 2H), 7.23-7.21 (m, 3H), 2.74-2.64 (m, 1H), 2.63-2.55 (m, 1H), 1.71-1.61 (m, 1H), 1.50-1.46 (m, 2H), 1.30 (br s, 13H), 1.19-1.14 (m, 1H), 0.97-0.90 (m, 6H). ¹³C NMR (75 MHz, CDCl3, 25° C.) δ ppm 143.4, 128.5, 128.4, 125.6, 39.1, 37.1, 33.7, 32.7, 32.1, 30.2, 29.8, 29.5, 27.1, 22.9, 19.8, 14.3.

### Example 50: Synthesis of benzyl 4-(3-phenylpropyl)piperidine-1-carboxylate

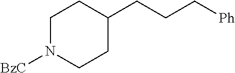

The reaction is carried out in an inert atmosphere in a glove box. A solution of 9-(2-phenylpropyl)-9-borabicyclo[3.3.1]nonane (2 eq) in benzene (c=0.5 M) is added to the catalyst P5 (20 mol %) and NMe₂Li (1.2 eq). A solution of benzyl 4-bromopiperidine-1-carboxylate (1 eq) in benzene (c=0.25 M) is added to the solution which is then supplemented by the addition of benzene to obtain a total benzyl 4-bromopiperidine-1-carboxylate concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields benzyl 4-(3-phenylpropyl)piperidine-1-carboxylate with 70% yield.

### Example 51: Synthesis of tert-butyldimethyl((6-phenylhexyl)oxy)silane

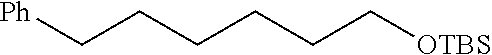 [SMILES: CC(C)(C)[Si](C)(C)OCCCCCCc1ccccc1]

The reaction is carried out in an inert atmosphere in a glove box. A solution of 9-(2-phenylpropyl)-9-borabicyclo[3.3.1]nonane (2 eq) in benzene (c=0.5 M) is added to the catalyst P5 (20 mol %) and NMe₂Li (1.2 eq). A solution of (4-bromobutoxy)(tert-butyl)dimethylsilane (1 eq) in benzene (c=0.25 M) is added to the solution which is then supplemented by the addition of benzene to obtain a total concentration of (4-bromobutoxy)(tert-butyl)dimethylsilane of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard gives tert-butyldimethyl((6-phenylhexyl)oxy)silane with 78% yield. A chromatography on a silica gel column was performed and gave tert-butyldimethyl((6-phenylhexyl)oxy)silane with 44% yield. ¹H NMR (250 MHz, CDCl3, 25° C.) δ ppm 7.34-7.29 (m, 2H), 7.23-7.18 (m, 3H), 3.63 (t, J=6.4 Hz, 2H), 2.64 (t, J=7.5 Hz, 2H), 1.69-1.50 (m, 4H), 1.42-1.36 (m, 4H), 0.93 (s, 9H), 0.08 (m, 6H). ¹³C NMR (63 MHz, CDCl3, 25° C.) δ ppm 143.0, 128.5, 128.4, 125.7, 63.4, 36.1, 33.0, 31.6, 29.3, 26.1, 25.8, 18.5, −5.1.

### Example 52: Synthesis of (3-cyclopentylpropyl)benzene

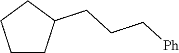 [SMILES: c1ccc(CCCC2CCCC2)cc1]

The reaction is carried out in an inert atmosphere in a glove box. A solution of 9-(2-phenylpropyl)-9-borabicyclo[3.3.1]nonane (2 eq) in benzene (c=0.5 M) is added to the catalyst P5 (20 mol %) and NMe₂Li (1.2 eq). A solution of bromocyclopentane (1 eq) in benzene (c=0.25 M) is added to the solution which is then supplemented by the addition of benzene to obtain a total bromocyclopentane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields (3-cyclopentylpropyl)benzene with 59% yield. A silica gel column chromatography was performed and yielded (3-cyclopentylpropyl)benzene with 53% yield. ¹H NMR (250 MHz, CDCl₃, 25° C.) δ ppm 7.35-7.30 (m, 2H), 7.24-7.22 (m, 3H), 2.65 (t, J=7.6 Hz, 2H), 1.83-1.78 (m, 3H), 1.71-1.57 (m, 6H), 1.44-1.38 (m, 2H), 1.12-1.11 (m, 2H). ¹³C NMR (63 MHz, CDC₃, 25° C.) δ ppm 143.1, 128.5, 128.4, 125.7, 40.2, 36.4, 36.1, 32.8, 30.8, 25.4.

### Example 53: Synthesis of (3-phenylpropyl)cycloheptane

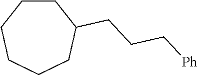 [SMILES: c1ccc(CCCC2CCCCCC2)cc1]

The reaction is carried out in an inert atmosphere in a glove box. A solution of 9-(2-phenylpropyl)-9-borabicyclo[3.3.1]nonane (2 eq) in benzene (c=0.5 M) is added to the catalyst P5 (20 mol %) and NMe₂Li (1.2 eq). A solution of bromocycloheptane (1 eq) in benzene (c=0.25 M) is added to the solution, which is then supplemented by the addition of benzene to obtain a total bromocycloheptane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard gives (3-phenylpropyl)cycloheptane with 74% yield. A silica gel column chromatography is performed and gives (3-phenylpropyl)cycloheptane with 65% yield. ¹H NMR (360 MHz, CDCl₃, 25° C.) δ ppm 7.31-7.26 (m, 2H), 7.21-7.17 (m, 3H), 2.60 (t, J=7.8 Hz, 2H), 1.73-1.57 (m, 8H), 1.50-1.37 (m, 5H), 1.32-1.27 (m, 2H), 1.18 (dtd, J=2.7 Hz, 9.9 Hz, 12.3 Hz, 2H). ¹³C NMR (63 MHz, CDCl₃, 25° C.) δ ppm 143.1, 128.5, 128.4, 125.7, 39.4, 38.1, 36.5, 34.8, 29.5, 28.7, 26.7.

### Example 54: Synthesis of 1-methyl-2-octylbenzene

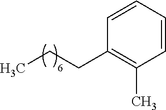

The reaction is carried out in an inert atmosphere in a glove box. A solution of 2-tolylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 40° C. for 24 hours and then a saturated aqueous solution of NH₄Cl is added. After extraction with EtOAc, the combined organic phases are dried on MgSO4, filtered and evaporated under reduced pressure. An analysis by ¹H NMR using 1,3,5-trimethoxybenzene as the internal standard yields 1-methyl-2-octylbenzene with 99% yield. A chromatography on a silica gel column was performed and gave 1-methyl-2-octylbenzene with 90% yield. ¹H NMR (360 MHz, CDCl₃, 25° C.) δ ppm 7.18-7.13 (m, 4H), 2.64 (t, J=7.6 Hz, 2H), 2.36 (s, 3H), 1.66-1.58 (m, 2H), 1.38-1.34 (m, 10H), 0.94 (t, J=6.2 Hz, 3H). ¹³C NMR (90 MHz, CDCl₃, 25° C.) δ ppm 141.3, 135.9, 130.2, 128.9, 126.0, 125.8, 33.5, 32.1, 30.5, 29.9, 29.7, 29.5, 22.8, 19.4, 14.3.

### Example 55: Synthesis of 1-methyl-3-octylbenzene

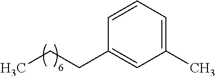

The reaction is carried out in an inert atmosphere in a glove box. A solution of 3-tolylboronic acid pinacolic ester (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1-methyl-3-octylbenzene with 99% yield. A silica gel column chromatography was performed and gave 1-methyl-3-octylbenzene with 94% yield. 1H NMR (300 MHz, CDCl3, 25° C.) δ 7.20 (dd, J=7.6 Hz, 7.6 Hz, 1H), 7.04-7.01 (m, 3H), 2.61 (t, J=7.6 Hz, 2H), 2.37 (s, 3H), 1.67-1.65 (m, 2H), 1.35-1.32 (m, 10H), 0.93 (t, J=6.5 Hz, 3H). ¹³C NMR (75 MHz, CDCl₃, 25° C.) δ ppm 143.0, 137.8, 129.4, 128.3, 126.4, 125.6, 36.1, 32.1, 31.8, 29.7, 29.6, 29.5, 22.9, 21.5, 14.3.

### Example 56: Synthesis of tert-butyl 4-octylbenzoate

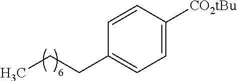

The reaction is carried out in an inert atmosphere in a glove box. A solution of pinacolic ester of phenylboronic acid, 4-(tert-butoxycarbonyl)phenylboronic acid (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 40° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields tert-butyl 4-octylbenzoate with 99% yield. A chromatography on a silica gel column was performed and gave tert-butyl 4-octylbenzoate with 82% yield. ¹H NMR (360 MHz, CDCl₃, 25° C.) δ ppm 7.91 (d, J=7.7 Hz, 2H), 7.22 (d, J=7.7 Hz, 2H), 2.65 (t, J=7.6 Hz, 2H), 1.59 (br s, 9H+2H), 1.30-1.27 (m, 10H), 0.93 (t, J=5.9 Hz, 3H). ¹³C NMR (90 MHz, CDCl3, 25° C.) δ ppm 166.0, 148.0, 129.64, 129.58, 128.4, 80.7, 36.1, 32.0, 31.3, 29.6, 29.4, 28.4, 22.8, 14.2. MS-HR (ESI) m/z calculated for C19H30NaO2 [M+Na]⁺313.2127, found: 313.2138.

### Example 57: Synthesis of tert-butyl 3-(4-fluorophenyl)azetidine-1-carboxylate

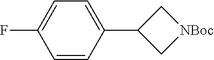 [SMILES: CC(C)(C)OC(=O)N1CC(c2ccc(F)cc2)C1]

The reaction is carried out in an inert atmosphere in a glove box. A solution of p-fluoroboronic acid pinacolic ester (2 eq) in benzene (c=0.5 M) is added to the P5 catalyst (10 mol %) and EtNMeLi (1.2 eq). A solution of tert-butyl 3-bromoazetidine-1-carboxylate (1 eq) in benzene (c=0.25 M) is added to the solution which is then supplemented by the addition of benzene to obtain a total tert-butyl 3-bromoazetidine-1-carboxylate concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields tert-butyl 3-(4-fluorophenyl)azetidine-1-carboxylate with 92% yield. A silica gel column chromatography is performed and yields 3-(4-fluorophenyl)azetidine-1-carboxylate with 83% yield. ¹H NMR (400 MHz, CDCl3, 25° C.) δ ppm 7.34-7.31 (m, 2H), 7.11-7-06 (m, 2H), 4.38 (t, J=8.7 Hz, 2H), 3.99 (dd, J=6.0 Hz, 8.7 Hz, 2H), 3.76 (tt, J=6.0 Hz, 8.7 Hz, 1H), 1.53 (s, 9H). ¹³C NMR (100 MHz, CDCl3, 25° C.) δ ppm 161.9 (d, J=245.4 Hz), 156.5, 138.1 (d, J=3.1 Hz), 128.4 (d, J=7.9 Hz), 115.6 (d, J=21.3 Hz), 79.7, 56.8, 33.0, 28.5.

### Example 58: Synthesis of tert-butyl 3-(4-ethoxyphenyl)azetidine-1-carboxylate

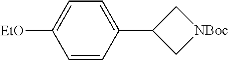 [SMILES: CCOc1ccc(C2CN(C(=O)OC(C)(C)C)C2)cc1]

The reaction is carried out in an inert atmosphere in a glove box. A pinacolic ester solution of p-ethoxyboronic acid (2 eq) in benzene (c=0.5 M) is added to the P5 catalyst (10 mol %) and EtNMeLi (1.2 eq). A solution of tert-butyl 3-bromoazetidine-1-carboxylate (1 eq) in benzene (c=0.25 M) is added to the solution which is then supplemented by the addition of benzene to obtain a total tert-butyl 3-bromoazetidine-1-carboxylate concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields tert-butyl 3-(4-ethoxyphenyl)azetidine-1-carboxylate with 87% yield. Silica gel column chromatography is performed and yields 3-(4-ethoxyphenyl)azetidine-1-carboxylate with 78% yield. ¹H NMR (300 MHz, CDCl3, 25° C.) δ ppm 7.22-7.19 (m, 2H), 6.88-6.85 (m, 2H), 4.29 (t, J=8.7 Hz, 2H), 4.02 (q, J=7.0 Hz, 2H), 3.93 (dd, J=6.0 Hz, 8.6 Hz, 2H), 3.67 (tt, J=6.0 Hz, 8.6 Hz, 1H), 1.46 (s, 9H), 1.40 (t, J=7.0 Hz, 3H). ¹³C NMR (100 MHz, CDCl₃, 25° C.) δ ppm 158.1, 156.5, 134.3, 127.9, 114.8, 79.5, 63.6, 56.9, 33.0, 28.5, 14.9.

### Example 59: Synthesis of 1-cyclopentyl-2-(trifluoromethyl)benzene

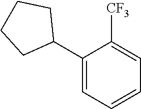 [SMILES: FC(F)(F)c1ccccc1C1CCCC1]

The reaction is carried out in an inert atmosphere in a glove box. A solution of 2-trifluoromethylboronic acid pinacolic ester (2 eq) in benzene (c=0.5 M) is added to the P5 catalyst (10 mol %) and EtNMeLi (1.2 eq). A solution of bromocyclopentane (1 eq) in benzene (c=0.25 M) is added to the solution which is then supplemented by the addition of benzene to obtain a total bromocyclopentane concentration of 0.08 M. The reaction mixture is stirred at 25° C. for 24 hours and then a saturated aqueous solution of NH4Cl is added. After extraction with EtOAc, the combined organic phases are dried on MgSO₄, filtered and evaporated under reduced pressure. An analysis by ¹H NMR using 1,3,5-trimethoxybenzene as the internal standard yields 1-cyclopentyl-2-(trifluoromethyl)benzene with 51% yield.

### Example 60: Synthesis of 2-phenyl-2,3-dihydro-1H-indene

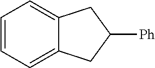 [SMILES: c1ccc(C2Cc3ccccc3C2)cc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of 2-bromo-2,3-dihydro-1H-indene (1 eq) in benzene (c=0.25 M) is added to the solution which is then supplemented by the addition of benzene to obtain a total concentration of 2-bromo-2,3-dihydro-1H-indene of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 2-phenyl-2,3-dihydro-1H-indene with >99% yield. A silica gel column chromatography was performed and yielded 2-phenyl-2,3-dihydro-1H-indene with 92% yield. ¹H NMR (400 MHz, CDCl₃, 25° C.) δ ppm 7.36-7.34 (m, 4H), 7.30-7.25 (m, 3H), 7.24-7.21 (m, 2H), 3.78-3.69 (m, 1H), 3.39 (dd, J=8.1 Hz, 15.3 Hz, 2H), 3.13 (dd, J=9.0 Hz, 15.4 Hz, 2H). ¹³C NMR (100 MHz, CDCl₃, 25° C.) δ ppm 145.6, 143.1, 128.6, 127.2, 126.6, 126.3, 124.4, 45.6, 41.0.

### Example 61: Synthesis of N,N,5-triphenylhexanamide

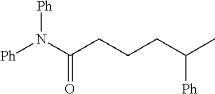 [SMILES: CC(CCCC(=O)N(c1ccccc1)c1ccccc1)c1ccccc1]

The reaction is carried out in an inert atmosphere in a glove box. A solution of phenylboronic acid pinacolic ester (2 eq) in benzene (c=0.5 M) is added to the P5 catalyst (10 mol %) and EtNMeLi (1.2 eq). A solution of 5-bromo-N,N-diphenylhexanamide (1 eq) in benzene (c=0.25 M) is added to the solution which is then supplemented by the addition of benzene to obtain a total concentration of 5-bromo-N,N-diphenylhexanamide of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by 1H NMR using 1,3,5-trimethoxybenzene as the internal standard yields N,N,5-triphenylhexanamide with 93% yield. A silica gel column chromatography was performed and yielded N,N,5-triphenylhexanamide with 84% yield. 1H NMR (300 MHz, CDCl₃, 25° C.) δ ppm 7.40-7.17 (m, 15H), 2.72-2.65 (m, 1H), 2.27 (t, J=6.6 Hz, 2H), 1.70-1.57 (m, 4H), 1.27 (d, J=7.0 Hz, 3H). 13C NMR (75 MHz, CDC₃, 25° C.) δ ppm 173.1, 147.5, 143.0, 129.4 (br), 128.4, 127.1, 126.0, 40.0, 38.0, 35.5, 23.8, 22.3. MS-HR (ESI) m/z calculated for C24H26NO [M+H]⁺ 344.2000, found: 344.2009.

### Example 62: Synthesis of 1-methyl-5-octyl-1H-pyrazole

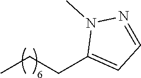

The reaction is carried out in an inert atmosphere in a glove box. A pinacolic ester solution of boronic acid (1-methyl-1H-pyrazol-5-yl)boronic acid (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 25° C. for 24 hours and then a saturated aqueous solution of NH4C1 is added. After extraction with EtOAc, the combined organic phases are dried on MgSO₄, filtered and evaporated under reduced pressure. An analysis by ¹H NMR using 1,3,5-trimethoxybenzene as the internal standard yields 1-methyl-5-octyl-1H-pyrazole with 15% yield.

### Example 63: Synthesis of 5-octylbenzo[d][1,3]dioxole

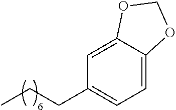

The reaction is carried out in an inert atmosphere in a glove box. A solution of pinacolic ester of benzo[d][1,3]dioxol-5-ylboronic acid (2 eq) in benzene (c=0.5 M) is added to the P5 catalyst (10 mol %) and EtNMeLi (1.2 eq). A solution of 1-bromooctane (1 eq) in benzene (c=0.25 M) is added to the solution, which is then supplemented by the addition of benzene to obtain a total 1-bromooctane concentration of 0.08 M. The reaction mixture is stirred at 80° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 5-octylbenzo[d][1,3]dioxole with >99% yield. A silica gel column chromatography was performed and gave 5-octylbenzo[d][1,3]dioxole with 91% yield. 1H NMR (400 MHz, CDCl₃, 25° C.) δ ppm 6.73 (d, J=7.9 Hz, 1H), 6.69 (d, J=1.4 Hz, 1H), 6.63 (dd, J=1.4 Hz, 7.9 Hz, 1H), 5.92 (s, 2H), 2.53 (t, J=7.6 Hz, 2H), 1.60-1.55 (m, 2H), 1.32-1.28 (m, 10H), 0.90 (t, J=7.0 Hz, 3H). ¹³C NMR (63 MHz, CDCl₃, 25° C.) δ ppm 147.6, 145.5, 137.0, 121.2, 109.0, 108.1, 100.8, 35.9, 32.0, 31.9, 29.6, 29.41, 29.36, 22.8, 14.2.

### Example 64: Synthesis of 2-octyl-2,3-dihydro-1H-indene

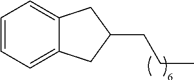

The reaction is carried out in an inert atmosphere in a glove box. A solution of 9-octyl-9-borabicyclo[3.3.1]nonane (2 eq) in benzene (c=0.5 M) is added to the catalyst P5 (20 mol %) and NMe₂Li (1.2 eq). A solution of 2-bromo-2,3-dihydro-1H-indene (1 eq) in benzene (c=0.25 M) is added to the solution, which is then supplemented by the addition of benzene to obtain a total concentration of 2-bromo-2,3-dihydro-1H-indene of 0.08 M. The reaction mixture is stirred at 25° C. for 24 hours and then a saturated aqueous solution of NH₄Cl is added. After extraction with EtOAc, the combined organic phases are dried on MgSO4, filtered and evaporated under reduced pressure. An analysis by ¹H NMR using 1,3,5-trimethoxybenzene as the internal standard yields 2-octyl-2,3-dihydro-1H-indene with 37% yield. A silica gel column chromatography was performed and yielded 2-octyl-2,3-dihydro-1H-indene with 30% yield. ¹H NMR (400 MHz, CDCl₃, 25° C.) δ ppm 7.22-7.19 (m, 2H), 7.15-7.13 (m, 2H), 3.06 (dd, J=8.0 Hz, 15.4 Hz, 2H), 2.60 (dd, J=8.2 Hz, 15.3 Hz, 2H), 2.45 (tt, J=7.3 Hz, 14.7 Hz, 22.8 Hz, 1H), 1.41-1.29 (m, 14H), 0.92 (t, J=7.0 Hz, 3H). ¹³C NMR (100 MHz, CDCl₃, 25° C.) δ ppm 143.9, 126.1, 124.5, 40.4, 39.5, 36.0, 32.1, 30.0, 29.8, 29.5, 28.6, 22.8, 14.3.

### Example 65: Synthesis of (3-methylhexane-1,6-diyl)dibenzene

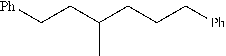 [SMILES: CC(CCCc1ccccc1)CCc1ccccc1]

The reaction is carried out in an inert atmosphere in a glove box. A solution of 9-(2-phenylpropyl)-9-borabicyclo[3.3.1]nonane (2 eq) in benzene (c=0.5 M) is added to the catalyst P5 (20 mol %) and NMe2Li (1.2 eq). A solution of (3-bromobutyl)benzene (1 eq) in benzene (c=0.25 M) is added to the solution which is then supplemented by the addition of benzene to obtain a total concentration of (3-bromobutyl)benzene of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. A silica gel column chromatography was performed and gave (3-methylhexane-1,6-diyl)dibenzene with 56% yield. ¹H NMR (400 MHz, CDCl₃, 25° C.) δ ppm 7.21-7.17 (m, 4H), 7.10-7.08 (m, 6H), 2.59-2.45 (m, 4H), 1.61-1.50 (m, 3H), 1.41-1.28 (m, 3H), 1.16-1.12 (m, 1H), 0.86 (d, J=6.4 Hz, 3H). ¹³C NMR (100 MHz, CDCl₃, 25° C.) δ ppm 143.2, 143.0, 128.54, 128.49, 128.4, 125.8, 125.7, 39.0, 36.7, 36.4, 33.6, 32.5, 29.1, 19.7.

### Example 66: Synthesis of 5-methyl-N,N-diphenyltridecanamide

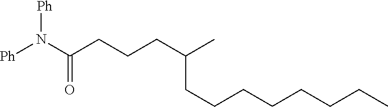 [SMILES: CCCCCCCCC(C)CCCC(=O)N(c1ccccc1)c1ccccc1]

The reaction is carried out in an inert atmosphere in a glove box. A solution of 9-octyl-9-borabicyclo[3.3.1]nonane (2 eq) in benzene (c=0.5 M) is added to the catalyst P5 (20 mol %) and NMe₂Li (1.2 eq). A solution of 5-bromo-N,N-diphenylhexanamide (1 eq) in benzene (c=0.25 M) is added to the solution which is then supplemented by the addition of benzene to obtain a total concentration of 5-bromo-N,N-diphenylhexanamide of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields 5-methyl-N,N-diphenyltridecanamide with 60% yield. A silica gel column chromatography was performed and yielded 5-methyl-N,N-diphenyltridecanamide with a yield of 36%. ¹H NMR (400 MHz, CDCl₃, 25° C.) δ ppm 7.39-7.37 (m, 4H), 7.30-7.28 (m, 6H), 2.27 (t, J=7.6 Hz, 2H), 1.74-1.62 (m, 2H), 1.33-1.29 (m, 15H), 1.12-1.07 (m, 2H), 0.91 (t, J=7.0 Hz, 3H), 0.85 (d, J=6.5 Hz, 3H). ¹³C NMR (100 MHz, CDCl₃, 25° C.) δ ppm 173.4, 143.2, 129.4, 127.2 (br s), 37.0, 36.8, 35.8, 32.8, 32.1, 30.1, 29.8, 29.5, 27.2, 23.3, 22.8, 19.7, 14.2. MS-HR (ESI) m/z calculated for C26H38NO [M+H]⁺ 380.2932, found: 380.2948.

### Example 67: Synthesis of (3-cyclopropylpropyl)benzene

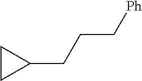 [SMILES: c1ccc(CCCC2CC2)cc1]

The reaction is carried out in an inert atmosphere in a glove box. A solution of 9-(2-phenylpropyl)-9-borabicyclo[3.3.1]nonane (2 eq) in benzene (c=0.5 M) is added to the catalyst P5 (20 mol %) and NMe₂Li (1.2 eq). A solution of bromocyclopropane (1 eq) in benzene (c=0.25 M) is added to the solution, which is then supplemented by the addition of benzene to obtain a total bromocyclopropane concentration of 0.08 M. The reaction mixture is stirred at 25° C. for 24 hours and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard gives (3-cyclopropylpropyl)benzene with 30% yield.

### Example 68: Synthesis F of phenylcycloheptane

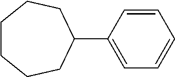 [SMILES: c1ccc(C2CCCCCC2)cc1]

The reaction is carried out in an inert atmosphere in a glove box. A solution of bromocycloheptane (1 eq) in benzene (c=0.25 M) is added to the P5 catalyst (10 mol %). A solution of phenylmagnesium bromide (1.2 eq) in benzene (c=0.5 M) is added to the solution, which is then supplemented by the addition of benzene to obtain a total bromocycloheptane concentration of 0.08 M. The reaction mixture is stirred at 25° C. for 24 hours (non-optimized time) and then a saturated aqueous solution of NH₄Cl is added. After extraction with EtOAc, the combined organic phases are dried on MgSO₄, filtered and evaporated under reduced pressure. An analysis by ¹H NMR using 1,3,5-trimethoxybenzene as the internal standard yields phenylcycloheptane with >99% yield.

1.-22. (canceled)

23. A method for the implementation of a coupling reaction with the use as catalyst of at least one compound of the following general formula (I): 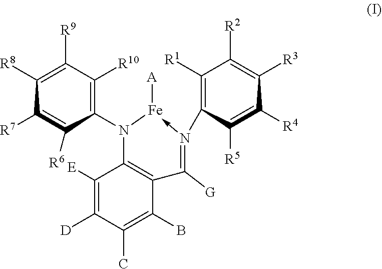
in which:
A is chosen from:
a —X group in which X is chosen from
a chlorine atom,
a bromine atom, and
a group 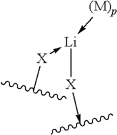
in which:
M is a coordinating solvent, and
p is chosen from 1, 2, 3, 4 or a decimal number that can vary from a value greater than 0 but less than 4,
a group 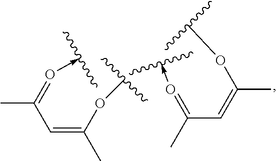
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atom(s), in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from
a hydrogen atom, and
a linear or branched alkyl group of 1 to 5 carbon atom(s).

24. The method according to claim 23, wherein the reaction is chosen from the carbon-carbon bonding reactions, using an organoboron or an organomagnesium or an organozinc or an organotin, or for the implementation of the Suzuki-Miyaura reaction, or for the implementation of the Suzuki-Miyaura, Kumada and Sonogashira reactions.

25. The method according to claim 23, wherein is used as a catalyst at least one of the compounds of the following general formula (I): 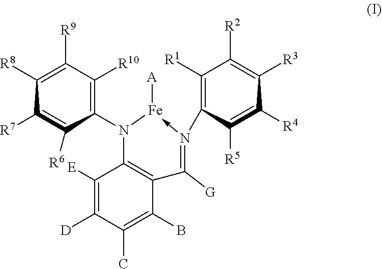
in which:
A is chosen from:
a —X group in which X is chosen from
a chlorine atom, and
a bromine atom,
a group 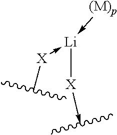
in which:
M is a coordinating solvent, and
p is chosen from 1, 2, 3, 4 or a decimal number that can vary from a value greater than 0 but less than 4,
a group 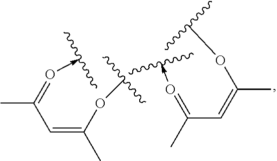
B, C, D, and E, identical or different, are chosen from: a hydrogen atom, a halogen, in particular F or Cl, a trifluoromethyl group CF₃, a linear or branched alkyl group of 1 to 10 carbon atom(s), in particular a linear or branched alkyl group of 2 to 4 carbon atoms, a linear or branched alkoxy group of 1 to 10 carbon atoms, or a linear or branched dialkylamino group of 2 to 20 carbon atoms,
when A corresponds to the group 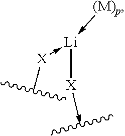
then R₁, R₅, R₆, and R₁₀, identical or different, are chosen from: a hydrogen atom, a halogen, in particular F or Cl, a trifluoromethyl group CF₃, a linear or branched alkyl group of 1 or 2 or 4 to 10 carbon atoms, a linear or branched Alkoxy group of 1 to 10 carbon atom(s) or a linear or branched dialkylamino group of 2 to 20 carbon atoms, and R₂, R₃, R₄, R₇, R₈ and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms
when A corresponds to the —X group or the group 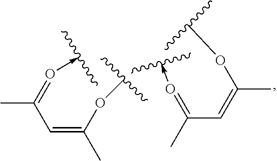
then R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms,
G is chosen from
a hydrogen atom, and
a linear or branched alkyl group of 1 to 5 carbon atoms, and
excluding the compound of the following formula:

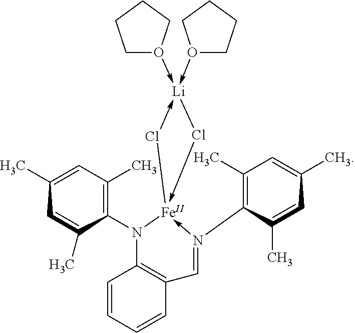

26. The method according to claim 23, wherein is used as a catalyst, at least one of the compounds of the following general formula (Ta): 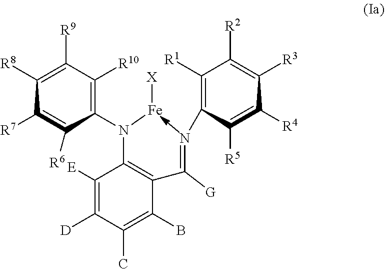
in which:
X is chosen from:
a chlorine atom, and
a bromine atom
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 10 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
or
of at least one of the compounds of the following general formula (Ib): 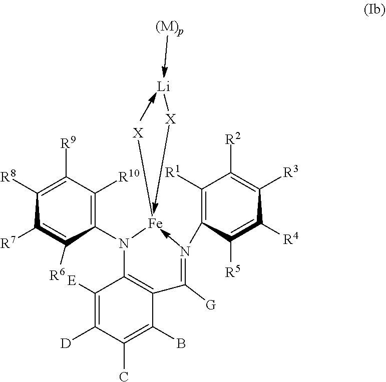
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
or
of at least one of the compounds of the following general formula (Ic): 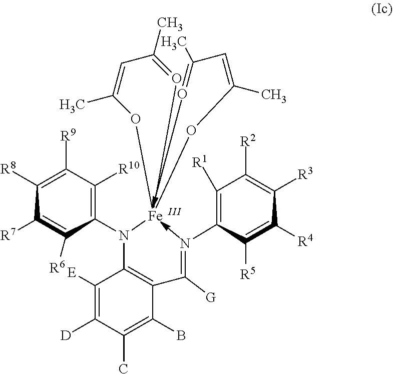
in which:
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s).

27. The method according to claim 23, wherein is used as a catalyst at least one of the compounds,
of the following general formula (Ta): 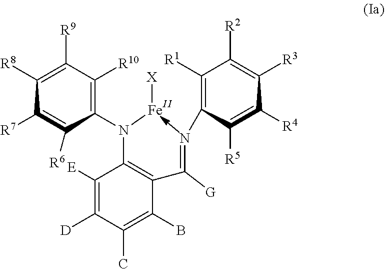
in which:
X is chosen from:
a chlorine atom, and
a bromine atom
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄,
and
R₆ is different from R₁₀ and/or R₇ is different from R₉, and
G is chosen from
a hydrogen atom
a linear or branched alkyl group of 1 to 5 carbon atom(s),
or of the following general formula (Ta): 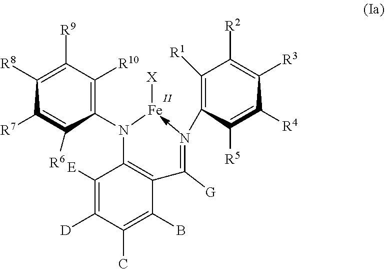
in which:
X is chosen from:
a chlorine atom, and
a bromine atom
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉
or
R₆ is different from R₁₀ and/or R₇ is different from R₉
and
R₁ is identical to R₅ and R₂ is identical to R₄, and
G is chosen from:
a hydrogen atom, and
a linear or branched alkyl group of 1 to 5 carbon atom(s),
or of the following general formula (Ta): 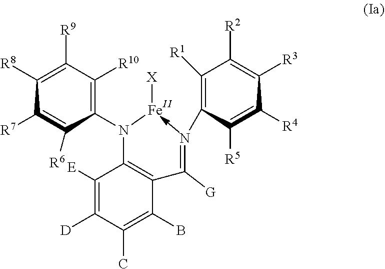
in which:
X is chosen from
a chlorine atom, and
a bromine atom,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀, and
R₇ is identical to R₉, and
G is chosen from:
a hydrogen atom, and
a linear or branched alkyl group of 1 to 5 carbon atom(s),
or of the following general formula (Ia): 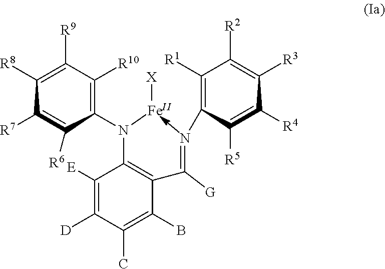
in which:
X is chosen from:
a chlorine atom, and
a bromine atom
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉, and
G is chosen from:
a hydrogen atom, and
a linear or branched alkyl group of 1 to 5 carbon atom(s),
or of the following general formula (Ia): 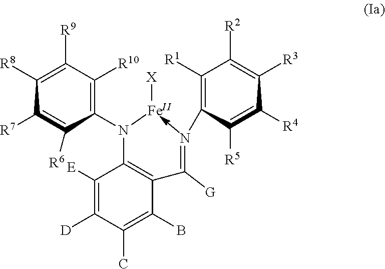
in which
X is chosen from
a chlorine atom, and
a bromine atom,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉,
or
R₆ is different from R₁₀ and/or R₇ is different from R₉
and
R₁ is identical to R₅ and R₂ is identical to R₄, and
G is chosen from
a hydrogen atom, and
a linear or branched alkyl group of 1 to 5 carbon atom(s),
or of the following general formula (Ia): 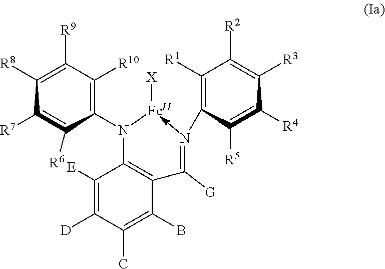
in which:
X is chosen from:
a chlorine atom, and
a bromine atom,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀, and
R₇ is identical to R₉, and
G is chosen from
a hydrogen atom, and
a linear or branched alkyl group of 1 to 5 carbon atom(s)
as catalysts for coupling reactions.

28. The method according to claim 23, wherein is used as a catalyst at least one of the compounds,
of the following general formula (Ib): 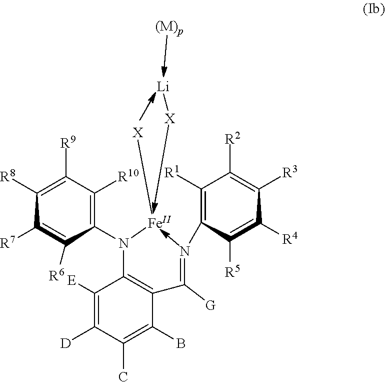
in which:
X is chosen from
a chlorine atom, and
a bromine atom,
M is a coordinating solvent
p is chosen from 1, 2, 3, 4 or a decimal number that can vary from a value greater than 0 but less than 4
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉, and
G is chosen from:
a hydrogen atom, and
a linear or branched alkyl group of 1 to 5 carbon atom(s),
or of the following general formula (Ib): 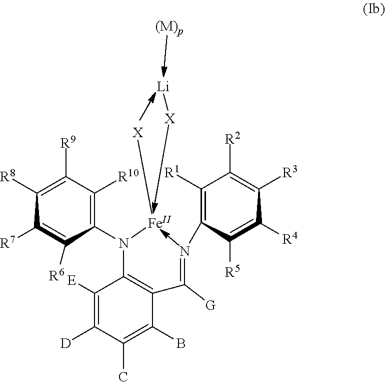
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉,
or
R₆ is different from R₁₀ and/or R₇ is different from R₉
and
R₁ is identical to R₅ and R₂ is identical to R₄, and
G is chosen from:
a hydrogen atom, and
a linear or branched alkyl group of 1 to 5 carbon atom(s),
or of the following general formula (Ib): 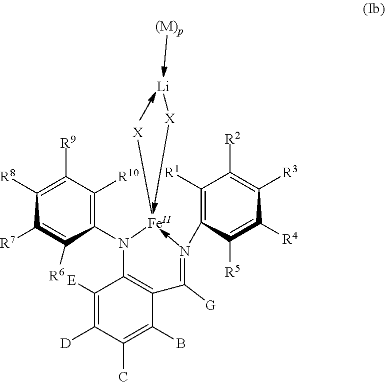
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀,
R₇ is identical to R₉, and
G is chosen from:
a hydrogen atom, and
a linear or branched alkyl group of 1 to 5 carbon atom(s),
or of the following general formula (Ib): 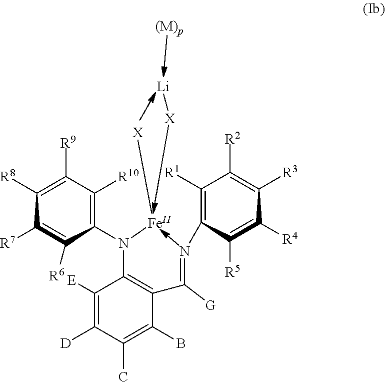
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉, and
G is chosen from:
a hydrogen atom, and
a linear or branched alkyl group of 1 to 5 carbon atom(s),
or of the following general formula (Ib): 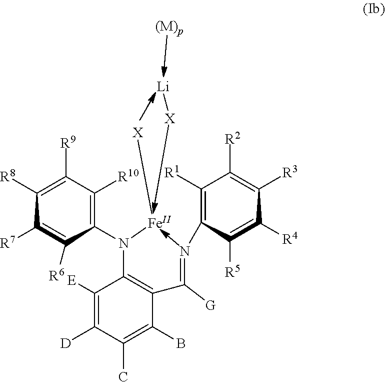
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉,
or
R₆ is different from R₁₀ and/or R₇ is different from R₉
and
R₁ is identical to R₅ and R₂ is identical to R₄, and
G is chosen from:
a hydrogen atom, and
a linear or branched alkyl group of 1 to 5 carbon atom(s),
or of the following general formula (Ib): 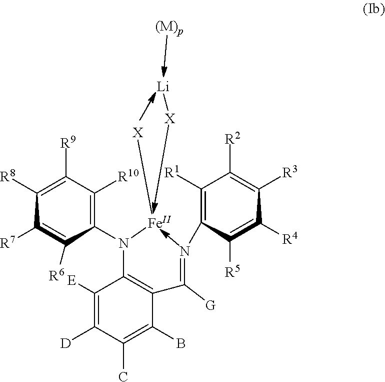
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D and E are chosen from: a hydrogen atom, a halogen, in particular F or Cl, a trifluoromethyl group CE₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CE₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀,
R₇ is identical to R₉, and
G is chosen from:
a hydrogen atom, and
a linear or branched alkyl group of 1 to 5 carbon atom(s)
as catalysts for coupling reactions.

29. The method according to claim 23, wherein is used as a catalyst at least one of the compounds
of the following general formula (Ic): 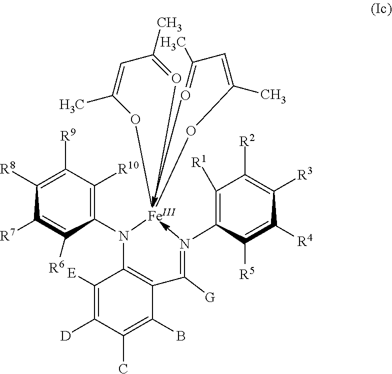
in which:
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉, and
G is chosen from
a hydrogen atom, and
a linear or branched alkyl group of 1 to 5 carbon atom(s),
or of the following general formula (Ic): 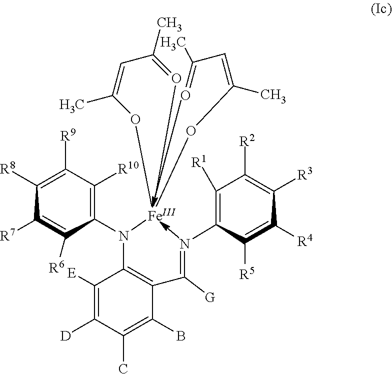
in which:
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉,
or
R₆ is different from R₁₀ and/or R₇ is different from R₉
and
R₁ is identical to R₅ and R₂ is identical to R₄, and
G is chosen from:
a hydrogen atom, and
a linear or branched alkyl group of 1 to 5 carbon atom(s),
or of the following general formula (Ic): 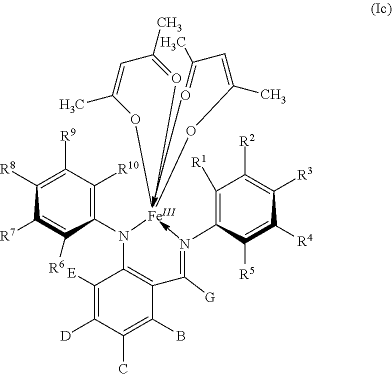
in which:
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, at least one of the groups B, C, D or E being different from the others,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀, and
R₇ is identical to R₉, and
G is chosen from:
a hydrogen atom, and
a linear or branched alkyl group of 1 to 5 carbon atom(s),
or of the following general formula (Ic): 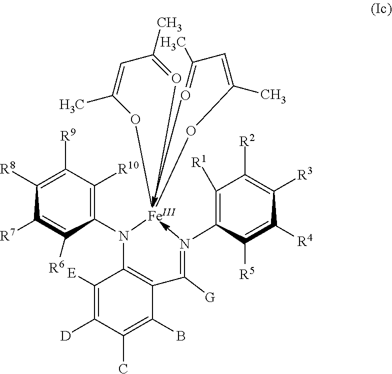
in which:
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉, and
G is chosen from:
a hydrogen atom, and
a linear or branched alkyl group of 1 to 5 carbon atom(s),
or of the following general formula (Ic): 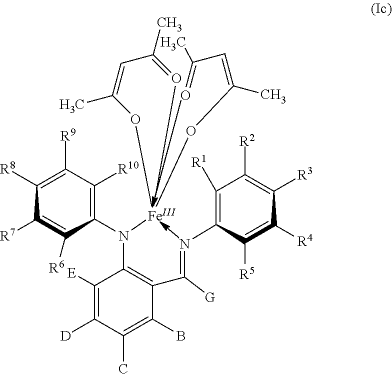
in which:
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉,
or
R₆ is different from R₁₀ and/or R₇ is different from R₉
and
R₁ is identical to R₅ and R₂ is identical to R₄, and
G is chosen from
a hydrogen atom, and
a linear or branched alkyl group of 1 to 5 carbon atom(s),
or of the following general formula (Ic): 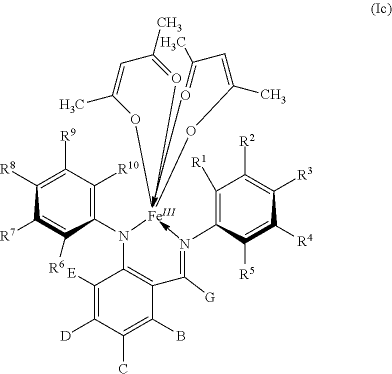
in which:
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀, and
R₇ is identical to R₉, and
G is chosen from:
a hydrogen atom, and
a linear or branched alkyl group of 1 to 5 carbon atom(s),
as catalysts for coupling reactions.

30. The method according to claim 23, wherein is used as a catalyst at least one of the compounds,
of the following general formula (Ta): 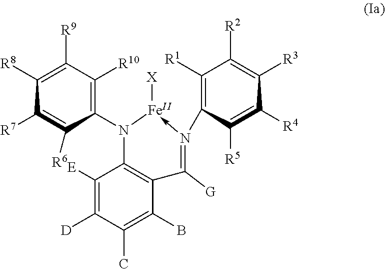
in which:
X is chosen from:
a chlorine atom, and
a bromine atom,
B, C, D, and E are fluorine atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
or of the following general formula (Ib): 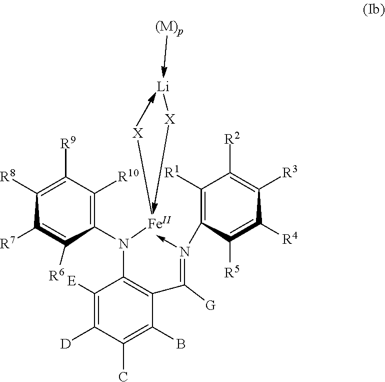
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D, and E are fluorine atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
or of the following general formula (Ic): 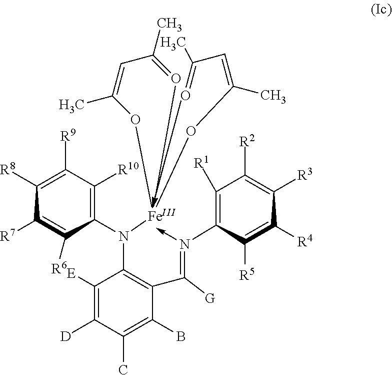
in which:
B, C, D, and E are fluorine atoms
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom,
a linear or branched alkyl group of 1 to 5 carbon atom(s),
as catalysts for coupling reactions.

31. The method according to claim 23, wherein the compound used as a catalyst, is chosen from:

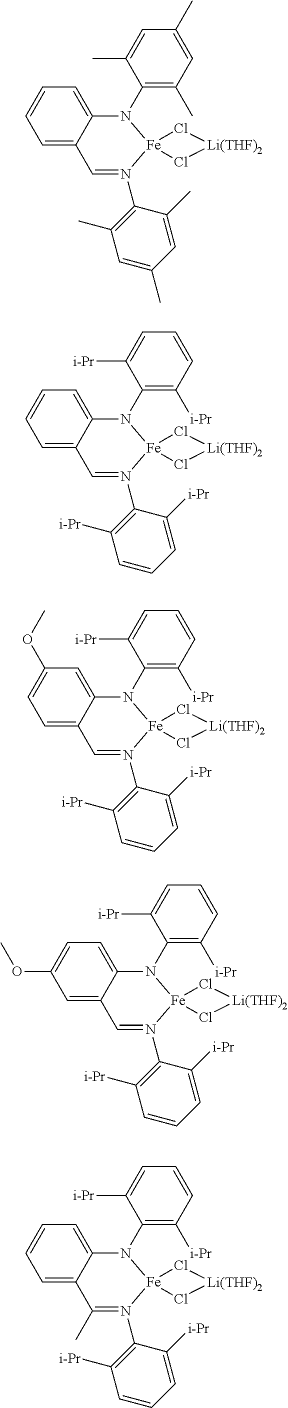

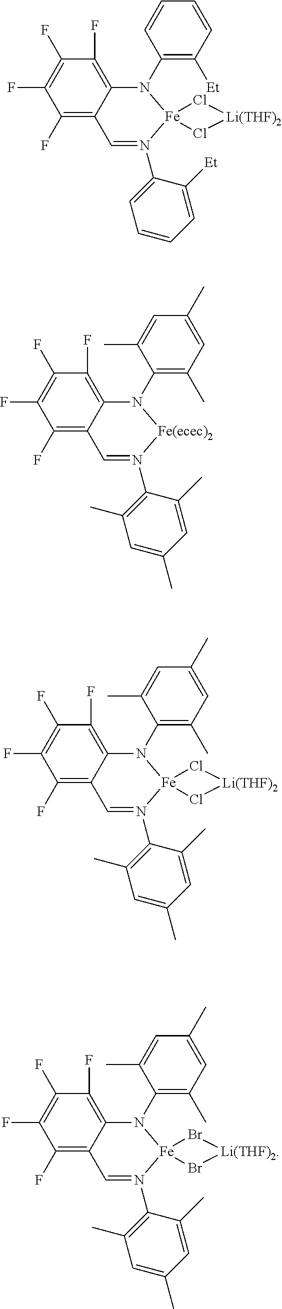

32. A compound, of the following general formula (I): 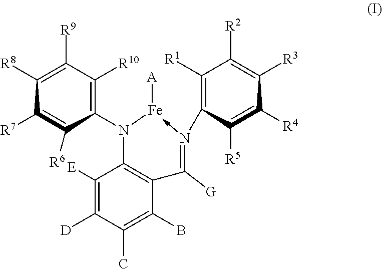
A is chosen from:
a —X group in which X is chosen from
a chlorine atom,
a bromine atom, and
a group 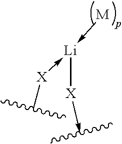
in which:
M is a coordinating solvent, and
p is chosen from 1, 2, 3, 4 or a decimal number that can vary from a value greater than 0 but less than 4,
a group 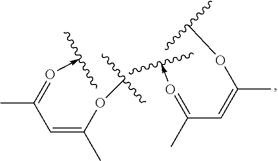
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
when A corresponds to the group 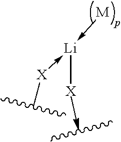
then R₁, R₅, R₆, and R₁₀, identical or different, are chosen from: a hydrogen atom, a halogen, in particular F or Cl, a trifluoromethyl group CF₃, a linear or branched alkyl group of 1 or 2 or 4 to 10 carbon atoms, a linear or branched alkoxy group of 1 to 10 carbon atom(s) or a linear or branched dialkylamino group of 2 to 20 carbon atoms, and R₂, R₃, R₄, R₇, R₈ and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms,
when A corresponds to the —X group or the group 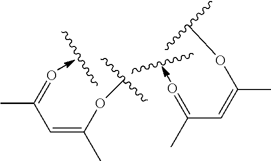
then R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atoms
excluding the compound of the following formula:

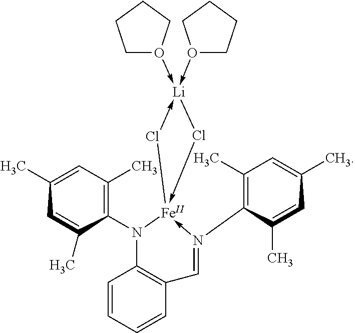

33. The compound according to claim 32, wherein the compound is:
of the following general formula (I): 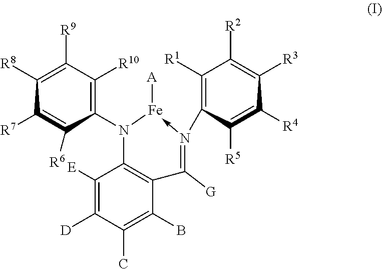
in which:
A, R₁, R₂, R₃, R₄, R₅, R₆, R₇, R₈, R₉ and R₁₀ and G have the meanings defined above,
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 at 20 carbon atoms and at least one of B, C, D or E is different from a hydrogen atom,
or of the following general formula (I): 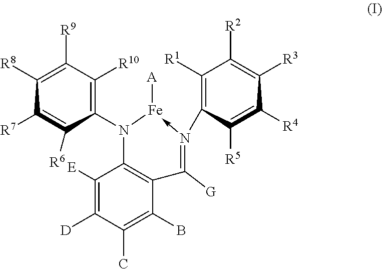
in which:
A, X, M, p, R₁, R₂, R₃, R₄, R₅, R₆, R₇, R₈, R₉ and R₁₀ and G have the meanings defined above,
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 at 20 carbon atoms and at least one of B, C, D or E is a halogen, in particular F,
or of the following general formula (I): 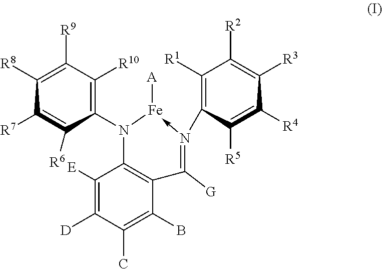
in which
A, X, M, p, R₁, R₂, R₃, R₄, R₅, R₆, R₇, R₈, R₉ and R₁₀ and G have the meanings defined above, and
B, C, D, and E are fluorine atoms

34. The compound according to claim 32, wherein the compound is of the following general formula (Ta): 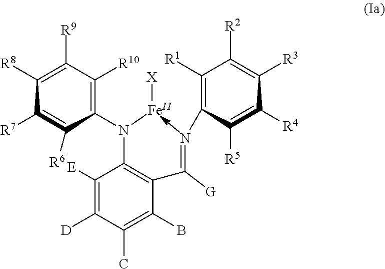
in which:
X is chosen from:
a chlorine atom, and
a bromine atom,
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atoms.

35. The compound according to claim 32, wherein the compound is of the following general formula (Ta): 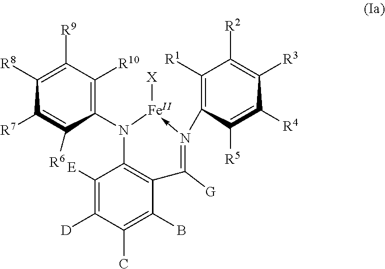
in which X and G have the meanings defined above, and
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is different from R₁₀ and/or R₇ is different from R₉.

36. The compound according to claim 32, wherein the compound is of the following general formula (Ia): 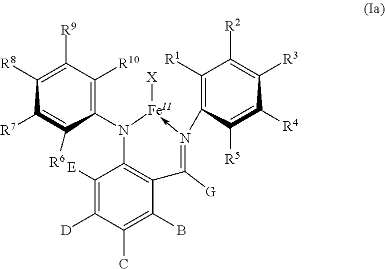
in which X and G have the meanings defined above, and
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀, and
R₇ is identical to R₉.

37. The compound according to claim 32, wherein the compound is of the following general formula (Ib): 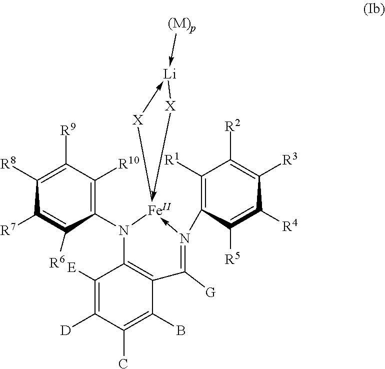
in which:
X is chosen from:
a chlorine atom, and
a bromine atom,
M is a coordinating solvent,
p is chosen from 1, 2, 3, 4 or a decimal number that can vary from a value greater than 0 but less than 4,
B, C, D and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkyl group of 1 to 10 carbon atoms, or a linear or branched dialkylamino group of 2 to 20 carbon atoms,
R₁, R₅, R₆ and R₁₀, identical or different, are chosen from: a hydrogen atom, a halogen, in particular F or Cl, a trifluoromethyl group CF₃, a linear or branched alkyl group of 1 to 2 or 4 to 10 carbon atoms, a linear or branched alkoxy group of 1 to 10 carbon atoms or a linear or branched dialkylamino group of 1 to 20 carbon atoms, and R₂, R₃, R₄, R₇, R₈, and R₉, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alkoxy group of 1 to 10 carbon atom(s) or a linear or branched dialkylamino group of 2 to 20 carbon atoms, and
G is chosen from:
a hydrogen atom,
a linear or branched alkyl group of 1 to 5 carbon atoms,
excluding the compound of the following formula:

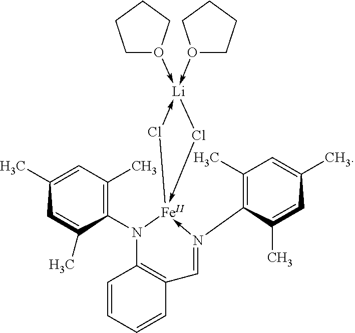

38. The compound according to claim 32, wherein the compound is of the following general formula (Ib): 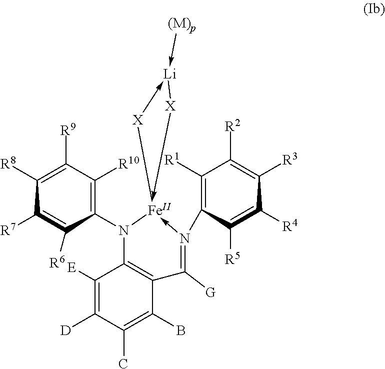
in which X, M, p, and G have the meanings defined above, and
B, C, D and E are chosen from: a hydrogen atom, a halogen, in particular F or Cl, a trifluoromethyl group CE₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₅, R₆ and R₁₀ are chosen from: a hydrogen atom, a halogen, in particular F or Cl, a trifluoromethyl group CE₃, a linear or branched alkyl group of 1 to 2 or 4 to 10 carbon atoms, a linear or branched Alkoxy group of 1 to 10 carbon atoms or a linear or branched dialkylamino group of 2 to 20 carbon atoms, and R₂, R₃, R₄, R₇, R₈, and R₉, are chosen from: a hydrogen atom, a halogen, in particular F or Cl, a trifluoromethyl group CE₃, a linear or branched alkyl group of 1 to 10 carbon atoms, in particular a linear or branched alkyl group of 2 to 4 carbon atoms, a linear or branched Alkoxy group of 1 to 10 carbon atoms, or a linear or branched dialkylamino group of 2 to 20 carbon atoms, provided that:
R₁ is different from R₅ and/or R₂ is different from R₄,
and
R₆ is different from R₁₀ and/or R₇ is different from R₉.

39. The compound according to claim 32, wherein the compound is of the following general formula (Ib): 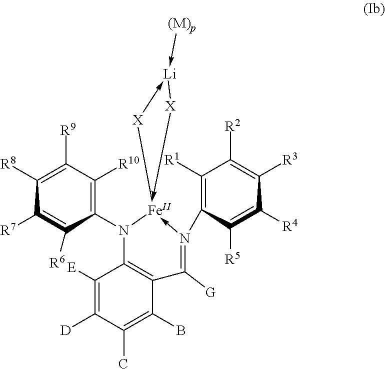
in which X, M, p, and G have the meanings defined above, and
B, C, D and E are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms or a linear or branched dialkylamino group of 2 to 20 carbon atoms, provided that B is identical to E and D is identical to C,
R₁, R₅, R₆ and R₁₀ are chosen from: a hydrogen atom, a halogen, in particular F or Cl, a trifluoromethyl group CF₃, a linear or branched alkyl group of 1 to 2 or 4 to 10 carbon atoms, a linear or branched Alkoxy group of 1 to 10 carbon atoms or a linear or branched dialkylamino group of 2 to 20 carbon atoms, and R₂, R₃, R₄, R₇, R₈, and R₉, which are identical, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms, provided that:
R₁ is identical to R₅,
R₂ is identical to R₄,
R₆ is identical to R₁₀, and
R₇ is identical to R₉,
excluding the compound of the following formula:

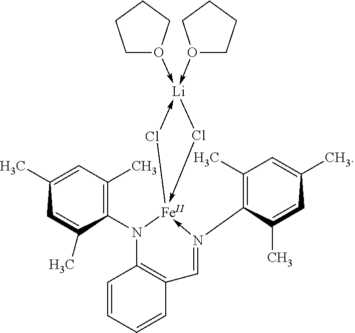

40. The compound according to claim 32, wherein the compound is of the following general formula (Ic): 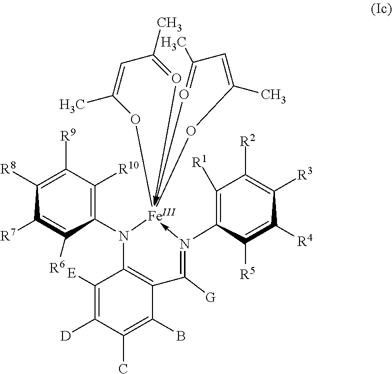
in which:
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atoms,
or of the following general formula (Ic): 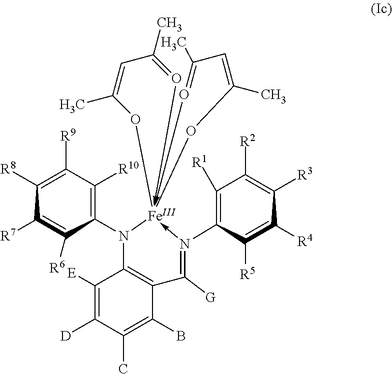
in which:
B, C, D and E are chosen from: a hydrogen atom, a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkyl group of 1 to 10 carbon atoms, or a linear or branched dialkylamino group of 2 to 20 carbon atoms, provided that B is identical to E and D is identical to C,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched Alkoxy group of 1 to 10 carbon atom(s) or a linear or branched dialkylamino group of 2 to 20 carbon atoms, provided that:
R₁ is identical to R₅,
R₂ is identical to R₄,
R₆ is identical to R₁₀, and
R₇ is identical to R₉, and
G is chosen from:
a hydrogen atom, and
a linear or branched alkyl group of 1 to 5 carbon atoms,
or of the following general formula (Ic): 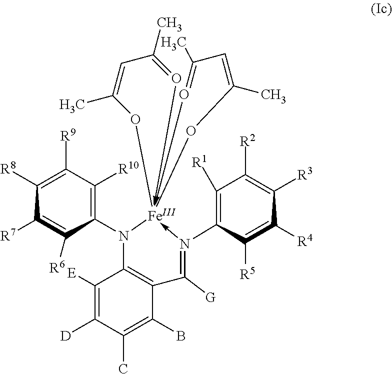
in which:
B, C, D and E are chosen from: a hydrogen atom, a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkyl group of 1 to 10 carbon atoms, or a linear or branched dialkylamino group of 2 to 20 carbon atoms, provided that B is identical to E and D is identical to C,
R₁, R₂, R₃, R₄, R₅, R₆, R₇, R₈, R₉ and R₁₀ are, chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, provided that:
R₁ is different from R₅ and/or R₂ is different from R₄
and
R₆ is identical to R₁₀ and R₇ is identical to R₉,
or
R₆ is different from R₁₀ and/or R₇ is different from R₉
and
R₁ is identical to R₅ and R₂ is identical to R₄, and
G is chosen from:
a hydrogen atom, and
a linear or branched alkyl group of 1 to 5 carbon atoms.

41. The compound according to claim 32, wherein the compound is chosen from:

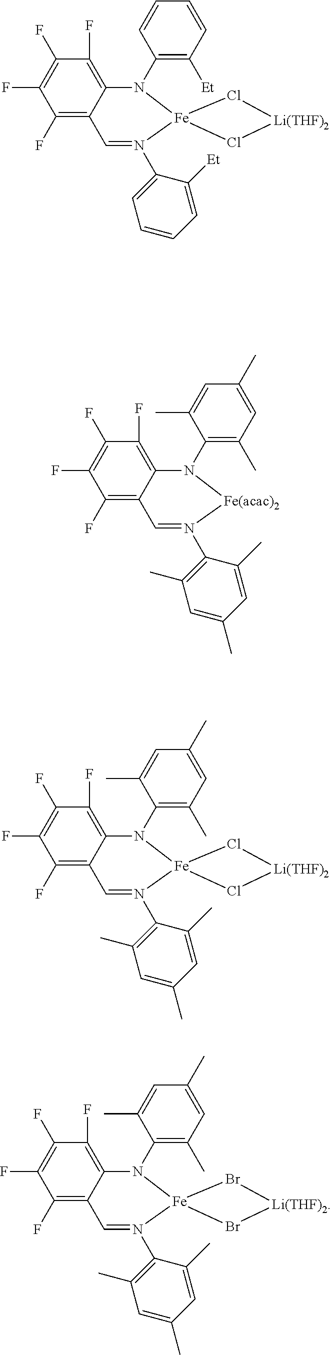

42. A process for preparing a compound of formula (I): 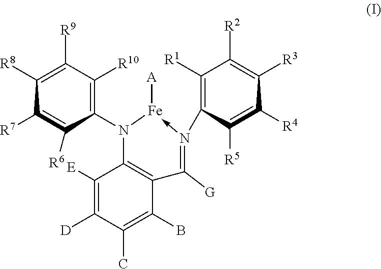
in which:
A is chosen from:
a —X group in which X is chosen from
a chlorine atom,
a bromine atom, and
a group 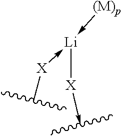
in which:
M is a coordinating solvent, and
p is chosen from 1, 2, 3, 4 or a decimal number that can vary from a value greater than 0 but less than 4,
a group 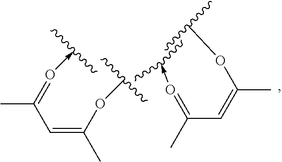
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atom(s), in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
and
in the case the compound of formula (I) is a compound of formula (Ia): 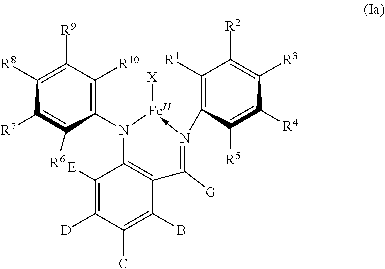
in which:
X is chosen from:
a chlorine atom, and
a bromine atom,
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
then the method comprises:
(a) a condensation step of a compound of formula (V) 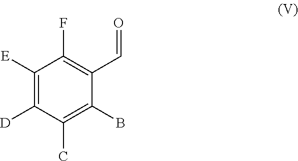
in which in which B, C, D, and E have the meanings defined above, and F is a fluorine atom,
on a compound of formula (VI): 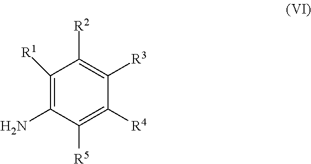
in which R₁, R₂, R₃, R₄, and R₅ have the meanings defined above,
to obtain the compound of formula (III) 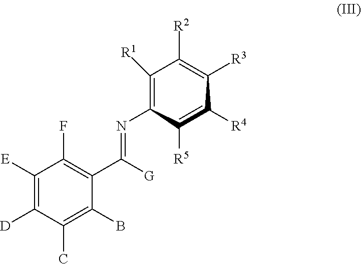
in which B, C, D, E, G, R₁, R₂, R₃, R₄, and R₅ have the meanings defined above, and F is a fluorine atom,
(b) an aromatic nucleophilic substitution step of said compound of formula (III) on a compound of formula (IV): 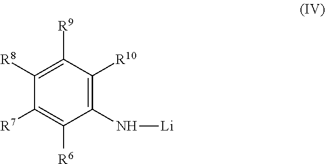
in which R₆, R₇, R₈, R₉, and R₁₀ have the meanings defined above
to obtain the compound of formula (II) 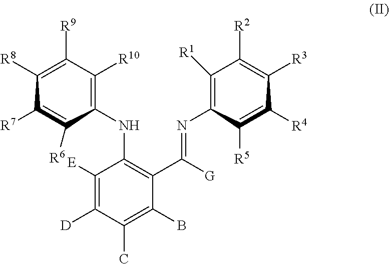
in which B, C, D, E, G, R₁, R₂, R₃, R₄, R₅, R₆, R₇, R₈, R₉ and R₁₀ have the meanings defined above,
c) a sequential addition step of n-butyl lithium and then iron (II) halide FeX₂ on said compound of formula (II) to obtain the compound of formula (Ia),
or
in the case the compound of formula (I) isa compound of formula (Ib): 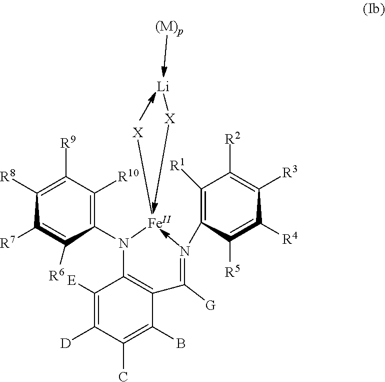
in which:
X is chosen from:
a chlorine atom, and
a bromine atom
M is a coordinating solvent,
p is chosen from 1, 2, 3, 4 or a decimal number that can vary from a value greater than 0 but less than 4,
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 10 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 1 to 4 carbon atoms, a linear or branched Alkoxy group of 1 to 10 carbon atom(s) or a linear or branched dialkylamino group of 2 to 20 carbon atoms, and
G is chosen from:
a hydrogen atom, and
a linear or branched alkyl group of 1 to 5 carbon atom(s),
then the method comprises:
a) a condensation step of a compound of formula (V) 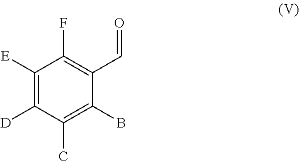
in which in which B, C, D, and E have the meanings defined above and F is a fluorine atom,
on a compound of formula (VI): 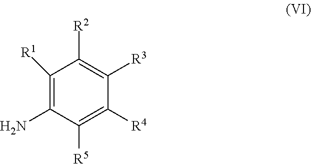
in which R₁, R₂, R₃, R₄, and R₅ have the meanings defined above,
to obtain the compound of formula (III) 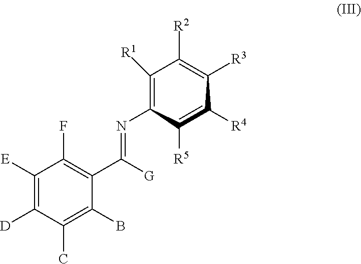
in which B, C, D, E, G, R₁, R₂, R₃, R₄, and R₅ have the meanings defined above, and F is a fluorine atom,
(b) an aromatic nucleophilic substitution step of said compound of formula (III) on a compound of formula (IV): 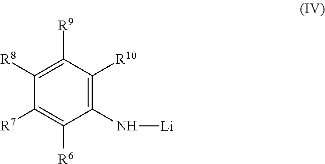
in which R₆, R₇, R₈, R₉ and R₁₀ have the meanings defined above,
to obtain the compound of formula (II) 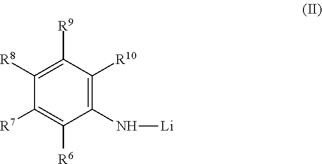
in which B, C, D, E, G, R₁, R₂, R₃, R₄, R₅, R₆, R₇, R₈, R₉ and R₁₀ have the meanings defined above,
(c) a sequential addition step of n-butyl lithium and then iron (II) halide FeX₂ on said compound of formula (II) to obtain the compound of formula (Ib), or in the case the compound of formula (I) isa compound of formula (Ic): 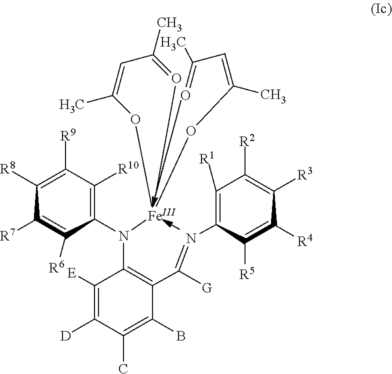
in which:
B, C, D, and E, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 2 to 4 carbon atoms, a linear or branched alkoxy group of 1 to 10 carbon atoms, or a linear or branched dialkylamino group of 2 to 20 carbon atoms,
R₁, R₂, R₃, R₄, R₅, R₆, R₇, R₈, R₉ and R₁₀, identical or different, are chosen from: a hydrogen atom, a halogen, in particular F or Cl, a trifluoromethyl group CF₃, a linear or branched alkyl group of 1 to 10 carbon atoms, in particular a linear or branched alkyl group of 1 to 4 carbon atoms, a linear or branched alkoxy group of 1 to 10 carbon atom(s) or a linear or branched dialkylamino group of 2 to 20 carbon atom(s), and
G is chosen from:
a hydrogen atom, and
a linear or branched alkyl group of 1 to 5 carbon atom(s),
then the method comprises:
a) a condensation step of a compound of formula (V) 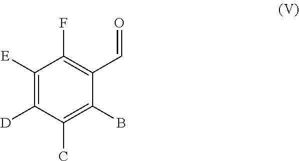
in which B, C, D, and E have the meanings defined above, and F is a fluorine atom on a compound of formula (VI): 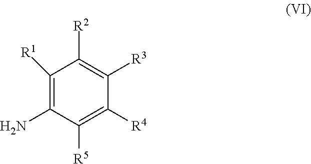
in which R₁, R₂, R₃, R₄, and R₅ have the meanings defined above to obtain the compound of formula (III) 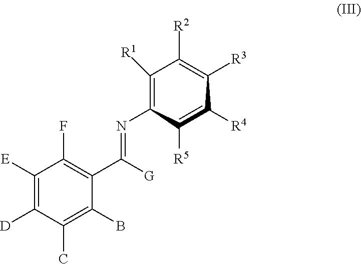
in which B, C, D, E, G, R₁, R₂, R₃, R₄, and R₅ have the meanings defined above, and F is a fluorine atom
(b) an aromatic nucleophilic substitution step of said compound of formula (III) on a compound of formula (IV): 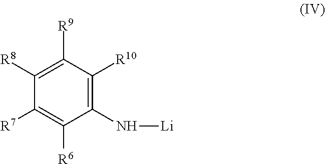
in which R₆, R₇, R₈, R₉ and R₁₀ have the meanings defined above,
to obtain the compound of formula (II) 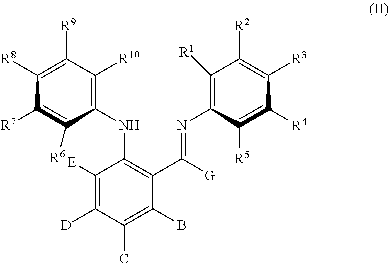
in which B, C, D, E, G, R₁, R₂, R₃, R₄, R₅, R₆, R₇, R₈, R₉ and R₁₀ have the meanings defined above, and
(c) a step of sequential addition of n-butyl lithium and then iron (III) tris-acetylacetone on said compound of formula (II) to obtain said compound of formula (Ic).
